(19) United States
(12) Patent Application Publication
(10) Pub. No.: US 2013/0220159 A1
(43) Pub. Date: Aug. 29, 2013

(54) OFFSET PRINTING BLANKET CLEANING LIQUID, METHOD OF CLEANING OFFSET PRINTING BLANKET, METHOD OF MANUFACTURING DISPLAY UNIT, METHOD OF MANUFACTURING PRINTED MATERIAL, AND INK COMPOSITION AND PRINTING METHOD USING THE SAME

(71) Applicant: SONY CORPORATION, (US)

(72) Inventors: Tatsuya Matsumi, Kanagawa (JP); Makoto Ando, Tokyo (JP)

(73) Assignee: SONY CORPORATION, Tokyo (JP)

(21) Appl. No.: 13/770,187

(22) Filed: Feb. 19, 2013

(30) Foreign Application Priority Data
Feb. 28, 2012 (JP) 2012-041591
Mar. 19, 2012 (JP) 2012-062041

(51) Int. Cl. C11D 7/50; C09D 11/02; B41F 16/00

(52) U.S. Cl. CPC C11D 7/5027; B41F 16/00; C09D 11/033
USPC 101/492; 524/1; 524/375; 524/323; 524/359; 568/648; 568/716; 568/335; 510/170

(57) ABSTRACT

An offset printing blanket cleaning liquid includes: a solvent having a dipole moment of about 1.7 or more but less than about 4.1 and having a π covalent bond in a molecular skeleton thereof. Moreover, an ink composition includes: an organic material; and a solvent having a dipole moment of about 1.3 to about 3.0 both inclusive and having a π covalent bond in a molecular skeleton thereof.

### CROSS REFERENCES TO RELATED APPLICATIONS

The present application claims priority to Japanese Priority Patent Application JP 2012-041591 filed in the Japan Patent Office on Feb. 28, 2012, and 2012-062041 filed in the Japan Patent Office on Mar. 19, 2012, the entire content of which is hereby incorporated by reference.

### BACKGROUND

The present disclosure relates to an offset printing blanket cleaning liquid used to from, for example, an organic layer of an organic EL (electroluminescence) display unit, and a method of cleaning an offset printing blanket, a method of manufacturing a display unit, and a method of manufacturing a printed material which each use the offset printing blanket cleaning liquid, an ink composition, and a printing method and a method of manufacturing a display unit which each use the ink composition.

High-performance display devices are desired along with acceleration of development of information and communication industry. For example, organic EL devices are self-luminous type display devices, and are superior in viewing angle width, contrast, and response speed.

In an organic EL display unit including organic EL devices as pixels, an organic layer configuring a light-emitting layer or the like is formed by a dry process such as a vacuum deposition method or a wet process such as coating with a solution. Examples of the wet process include discharge printing methods such as spin coating, inkjet printing, and nozzle-jet printing and plate printing methods such as flexographic printing, screen printing, gravure printing, and reverse offset printing.

In a reverse offset printing method as one plate printing method, first, an ink coating is formed on an intermediate transfer member called “blanket”, and the blanket is brought into contact with an engraved plate, and then a pattern remaining on the blanket is brought into contact with a printing substrate to be transferred from the blanket to the printing substrate. As such a reverse offset printing method, there are proposed a method using a roll-like blanket (for example, refer to Japanese Unexamined Patent Application Publication No. 2004-327067) and a method using a flat plate-like blanket (for example, refer to Japanese Unexamined Patent Application Publication No. 2010-158799).

It is desirable that a blanket used in offset printing have high releasability from an ink coating formed thereon. More specifically, when the blanket on which the ink coating is formed is brought into contact with the printing substrate, it is necessary to completely transfer, to the printing substrate, the ink coating in a region in contact with the printing substrate. A typically used blanket material with such high releasability is silicone rubber containing polydimethylsiloxane as a base (a main component).

Materials used for the organic layer such as the light-emitting layer of the organic EL device is broadly classified into a low-molecular material and a polymer material. When the organic EL display unit including the organic EL devices as pixels is fabricated, a dry process such as a vacuum deposition method is used as a method of forming the organic layer in the case where the low-molecular material is used for the organic layer. On the other hand, in the case where the polymer material is used for the organic layer, a discharge printing method such as spin coating, inkjet printing, or nozzle-jet printing or a plate printing method such as flexographic printing, screen printing, gravure printing, or reverse offset printing is used.

### SUMMARY

However, a blanket made of silicone rubber absorbs a solvent extremely easily, thereby being easily brought into a swollen state. Therefore, there is an issue that, once the blanket absorbs a solvent, it takes significant time to dry the blanket until the blanket becomes usable again. To solve this issue, a process of heating the blanket or a process of vacuum-drying the blanket is used; however, releasability of the blanket is pronouncedly degraded after the process to thereby cause an issue that it is difficult to reuse the blanket. Moreover, in offset printing, a process of immersing the blanket in a cleaning liquid to remove a pattern for dummy printing before actual printing or to clean a surface of the blanket is performed, and as in the case of cleaning after printing, it is necessary to leave the blanket for several days after the process to completely dry the blanket.

Moreover, since a soft material such as silicone rubber used for the surface of the blanket easily absorbs an ink solvent, an ink coating applied to the blanket is easily dried. Accordingly, so-called cobwebbing is caused at an edge of a pattern, or the ink coating is formed into a film, and then the entire ink coating is transferred to the plate. As a result, pattern accuracy is reduced, or it is difficult to perform patterning.

It is desirable to provide an offset printing blanket cleaning liquid and a method of cleaning an offset printing blanket which are capable of reducing drying time after cleaning a blanket, a method of manufacturing a display unit, and a method of manufacturing a printed material.

Moreover, it is desirable to provide an ink composition enabling printing with high-definition patterning, and a printing method with use of the ink composition and a method of manufacturing a display unit which each use the ink composition.

According to an embodiment of the disclosure, there is provided an offset printing blanket cleaning liquid including: a solvent having a dipole moment of about 1.7 or more but less than about 4.1 and having a π covalent bond in a molecular skeleton thereof.

According to an embodiment of the disclosure, there is provided a method of cleaning an offset printing blanket including: immersing a blanket in a cleaning liquid including a solvent, the solvent having a dipole moment of about 1.7 or more but less than about 4.1 and having a π covalent bond in a molecular skeleton thereof.

According to an embodiment of the disclosure, there is provided a first method of manufacturing a display unit including: forming a display device on a substrate, in which the forming of the display device includes: immersing a blanket in a cleaning liquid including a solvent, the solvent having a dipole moment of about 1.7 or more but less than about 4.1 and having a π covalent bond in a molecular skeleton thereof, coating the blanket with an ink composition including an organic material to form a transfer layer, pressing a plate with a predetermined pattern against the transfer layer to form a pattern layer on the blanket, and transferring the pattern layer to a printing substrate.

According to an embodiment of the disclosure, there is provided a method of manufacturing a printed material including: forming a pattern layer on a substrate, in which the forming of the pattern layer includes: immersing a blanket in a cleaning liquid including a solvent, the solvent having a dipole moment of about 1.7 or more but less than about 4.1 and having a π covalent bond in a molecular skeleton thereof, coating the blanket with an ink composition including an organic material to form a transfer layer, pressing a plate with a predetermined pattern against the transfer layer to form a pattern layer on the blanket, and transferring the pattern layer to a printing substrate.

In the offset printing blanket cleaning liquid, the method of cleaning an offset printing blanket, the first method of manufacturing a display unit, and the method of manufacturing a printed material according to the embodiments of the disclosure, the solvent having a dipole moment of about 1.7 or more but less than about 4.1 and having a π covalent bond in a molecular skeleton thereof is used to suppress absorption of the solvent into the blanket.

According to an embodiment of the disclosure, there is provided an ink composition including: an organic material; and a solvent having a dipole moment of about 1.3 to about 3.0 both inclusive and having a π covalent bond in a molecular skeleton thereof.

According to an embodiment of the disclosure, there is provided a printing method including: coating a blanket with an ink composition including an organic material and a solvent to form a transfer layer, the solvent having a dipole moment of about 1.3 to about 3.0 both inclusive and having a π covalent bond in a molecular skeleton thereof; pressing a plate with a predetermined pattern against the transfer layer to form a pattern layer on the blanket, and transferring the pattern layer to a printing substrate.

According to an embodiment of the disclosure, there is provided a second method of manufacturing a display unit including: forming a display device on a substrate, in which the forming of the display device includes: coating a blanket with an ink composition including an organic material and a solvent to transfer layer, the solvent having a dipole moment of about 1.3 to about 3.0 both inclusive and having a π covalent bond in a molecular skeleton thereof, pressing a plate with a predetermined pattern against the transfer layer to form a pattern layer on the blanket, and transferring the pattern layer to a printing substrate.

In the ink composition, the printing method, and the second method of manufacturing a display unit according to the embodiments of the disclosure, the solvent having a dipole moment of about 1.3 to about 3.0 both inclusive and having a π covalent bond in a molecular skeleton thereof is used to suppress absorption of the solvent into the blanket.

In the offset printing blanket cleaning liquid, the method of cleaning an offset printing blanket, the first method of manufacturing a display unit, and the method of manufacturing a printed material according to the embodiments of the disclosure, since the solvent having a dipole moment of about 1.7 or more but less than about 4.1 and having a π covalent bond in a molecular skeleton thereof is used, drying time after cleaning the blanket is allowed to be reduced.

Moreover, in the ink composition, the printing method, and the second method of manufacturing a display unit according to the embodiments of the disclosure, since the solvent having a dipole moment of about 1.3 to about 3.0 both inclusive and having a π covalent bond in a molecular skeleton thereof is used, printing with high-definition patterning is achievable.

It is to be understood that both the foregoing general description and the following detailed description are exemplary, and are intended to provide further explanation of the application as claimed.

Additional features and advantages are described herein, and will be apparent from the following Detailed Description and the figures.

### BRIEF DESCRIPTION OF THE FIGURES

The accompanying drawings are included to provide a further understanding of the application, and are incorporated in and constitute a part of this specification. The drawings illustrate embodiments and, together with the specification, serve to explain the principles of the application.

FIGS. 1A to 1D are process diagrams describing a flow of a printing method according to an embodiment of the disclosure.

FIGS. 2A to 2D are process diagrams following FIGS. 1A to 1D.

FIGS. 3A and 3B are characteristic diagrams illustrating a relationship between dipole moment and weight increase rate of a blanket and a relationship between dipole moment and swelling ratio of the blanket, respectively.

FIG. 4 is a characteristic diagram illustrating a relationship between respective solvents, and time of cleaning a remaining organic film and swelling ratio after cleaning.

FIG. 5 is a diagram illustrating dipole moments of respective solvents.

FIG. 6 is a flow chart of a method of manufacturing a display unit according to an embodiment of the disclosure.

FIG. 7 is a sectional view illustrating an example of a configuration of the display unit illustrated in FIG. 6.

FIG. 8 is a sectional view illustrating another example of the configuration of the display unit illustrated in FIG. 6.

FIG. 9 is a schematic view illustrating an example of a pixel drive circuit of the display unit illustrated in FIG. 7.

FIG. 10 is a circuit diagram illustrating an example of the pixel drive circuit illustrated in FIG. 9.

FIG. 11 is a plan view illustrating a schematic configuration of a module including the display unit according to the above-described embodiment.

FIG. 12 is a perspective view illustrating an appearance of Application Example 1 of the display unit according to the above-described embodiment.

FIGS. 13A and 13B are perspective views illustrating an appearance of Application Example 2 from a front side and a back side, respectively.

FIG. 14 is a perspective view illustrating an appearance of Application Example 3.

FIG. 15 is a perspective view illustrating an appearance of Application Example 4.

FIGS. 16A to 16G illustrate Application Example 5, where FIGS. 16A and 16B are a front view and a side view in a state in which Application Example 5 is opened, respectively, and FIGS. 16C, 16D, 16E, 16F, and 16G are a front view, a left side view, a right side view, a top view, and a bottom view in a state in which Application Example 5 is closed, respectively.

FIG. 17 is a characteristic diagram illustrating dipole moments and contact angles with respect to the blanket of respective solvents.

FIG. 18 is a characteristic diagram in Experimental Examples 1 to 5 of the disclosure.

FIGS. 19A to 19E are schematic views illustrating printing patterns in Experimental Examples 1 to 5.

### DETAILED DESCRIPTION

Preferred embodiments of the disclosure will be described in detail below referring to the accompanying drawings. It is to be noted that description will be given in the following order.

1. First Embodiment
1-1. Offset printing blanket cleaning liquid
1-2. Cleaning method
1-3. Configuration and manufacturing method of organic EL display unit

2. Second Embodiment
2-1. Ink composition
2-2. Manufacturing method
2-3. Configuration of organic EL display unit

3. Application Examples

4. Examples

### 1. First Embodiment

(1-1. Offset Printing Blanket Cleaning Liquid)

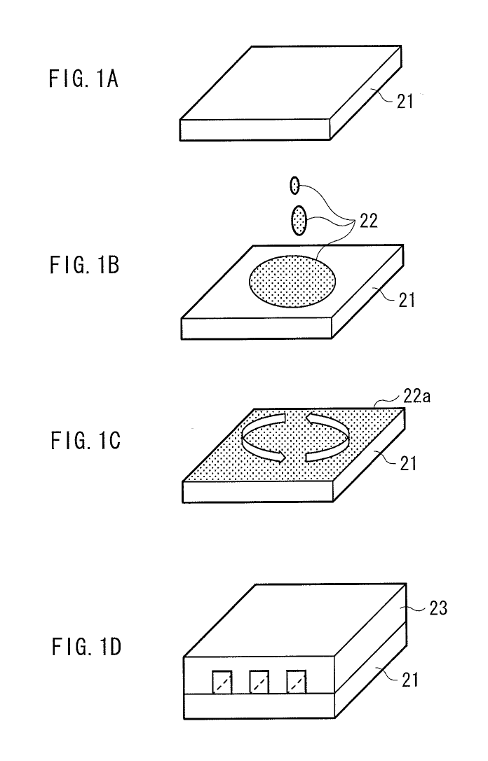

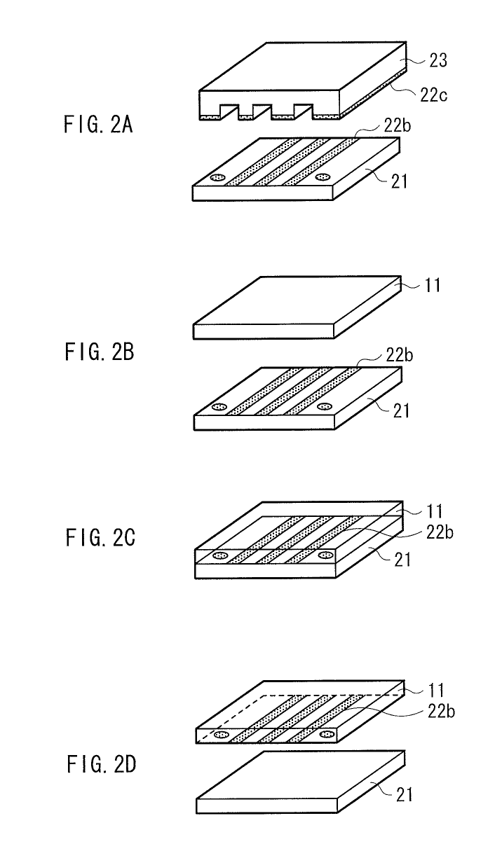

An offset printing blanket cleaning liquid according to an embodiment of the disclosure is used to clean a plate before or after printing when a light-emitting layer is formed by a plate printing method. In the plate printing method, for example, reverse offset printing, as described above, an ink coating (a transfer layer 22a) is formed on a blanket 21, and the blanket 21 is brought into contact with an engraved plate (a reverse printing plate 23), and then a pattern (a pattern layer 22b) remaining on the blanket 21 is brought into contact with a printing substrate (a substrate 11) to be transferred from the blanket 21 to the printing substrate. Thus, printing is performed (refer to FIGS. 1A to 1D and FIGS. 2A to 2D). In the embodiment, a cleaning liquid removing foreign substances or printing residues on a plate used for the plate printing method will be described in detail below.

FIGS. 1A to 1D and 2A to 2D illustrate an example of a process of reverse offset printing. In the reverse offset printing, first, as illustrated in FIG. 1A, a blanket 21 having a soft material layer (not illustrated) on a base is prepared. Next, as illustrated in FIG. 1B, the soft material layer of the blanket 21 is coated with an ink composition 22. Then, as illustrated in FIG. 1C, a transfer layer 22a made of the ink composition 22 is formed by a spin coating method. Next, as illustrated in FIG. 1D, a reverse printing plate 21 is pressed against the transfer layer 22a.

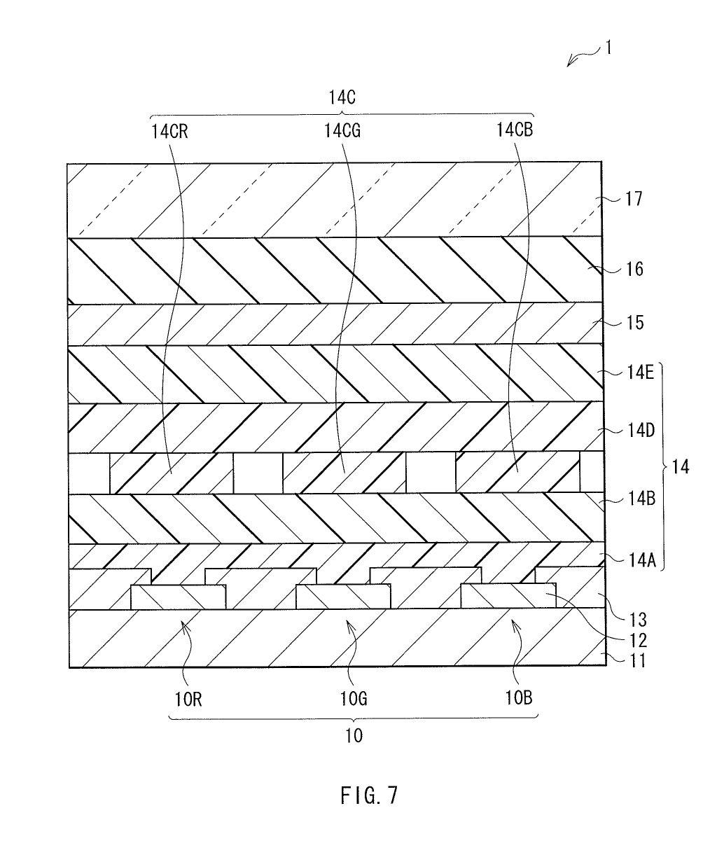

As described above, the reverse printing plate 23 has, on one surface thereof, a depression section with a pattern corresponding to a desired pattern (for example, a red light-emitting layer 14CR, refer to FIG. 7). When the reverse printing plate 23 and the blanket 21 are brought into contact with each other to allow the depression section of the reverse printing plate 23 and the transfer layer 22a to face each other, as illustrated in FIG. 2A, a pattern layer 22b made of the ink composition 22 with the same pattern as the pattern of the depression section of the reverse printing plate 23 is formed on the blanket 21. A non-printing section 22c made of the ink composition 22 with a reverse pattern of the pattern of the depression section (the same pattern as a pattern of a protrusion section) is formed on the reverse printing plate 23.

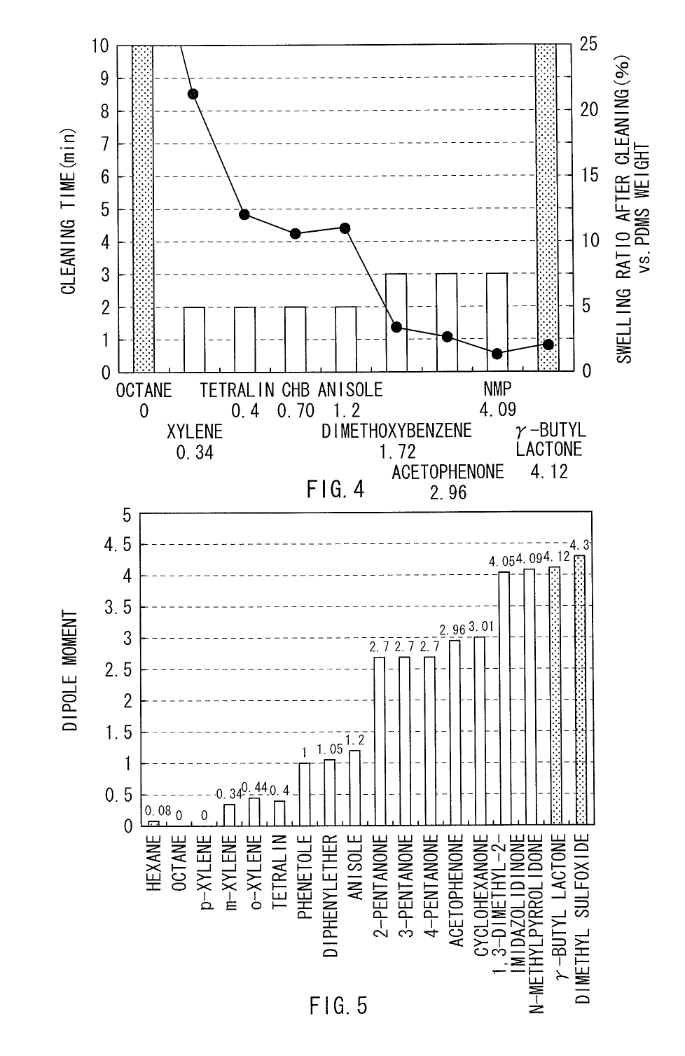

Next, as illustrated in FIG. 2B, a printing substrate (for example, a substrate 11, refer to FIG. 5) is prepared, and the printing substrate is aligned to allow a printing surface thereof to face the pattern layer 22b of the blanket 21. Then, as illustrated in FIG. 2C, the substrate 11 is pressed against the blanket 21, and then, as illustrated in FIG. 2D, the blanket 21 is separated from the substrate 11. Thus, a pattern layer 22b (a first pattern) is printed on the substrate 11. After that, the pattern layer 22b is subjected to treatment such as heating. Then, in the case where a next pattern (a second pattern) is printed on the substrate 11, printing is performed by a similar process with use of the same blanket 21 or a new blanket 21.

The offset printing blanket cleaning liquid (hereinafter referred to as “cleaning liquid R”) according to the embodiment is used to clean the blanket 21, for example, in the case where the second pattern is printed on the substrate 1 with use of the same blanket 21, as described above. Moreover, for example, the cleaning liquid R is used to clean the blanket 21 before the blanket 21 is coated with an ink composition for the first pattern. A solvent used in the cleaning liquid R is appropriately selected, depending on a material forming the blanket 21 subjected to cleaning and a composition of a material (an organic film made of an ink composition) to be removed by the cleaning liquid R. More specifically, the solvent used in the cleaning liquid R is a solvent not impairing releasability of the blanket 21, being not easily absorbed by the blanket 21, and having solubility therein of an organic film.

As described above, the blanket 21 is formed of silicone rubber containing, as a main component, polydimethylsiloxane with high releasability from the organic film. The blanket 21 made of silicone rubber has low surface density and is easily impregnated with a solvent (a swelling phenomenon). Moreover, polydimethylsiloxane existing on a surface of the blanket 21 has little polarity. More specifically, since a dipole moment of polydimethylsiloxane on the surface of the blanket 21 is as low as about 0 to 0.5, a lower-polarity solvent causes an increase in a swelling amount of the blanket 21.

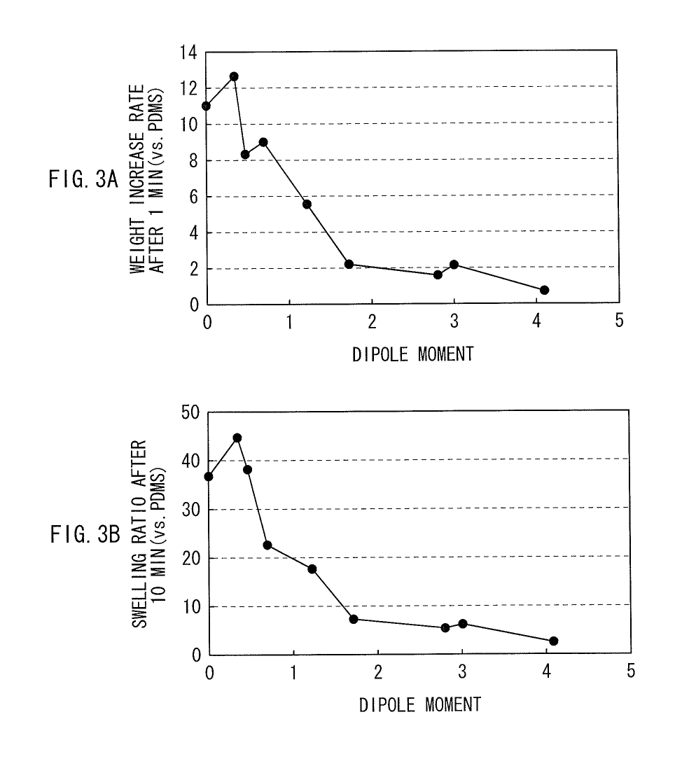

FIG. 3A illustrates weight increase rates (%) of the blanket 21 made of silicone rubber after the blanket is immersed in solvents with various dipole moments for one minute. FIG. 3B illustrates swelling ratios (%) of the blanket 21 after the blanket is immersed in the solvents with various dipole moments for ten minutes. As can be seen from FIGS. 3A and 3B, the weight increase rate of the blanket 21 after one-minute immersion and the swelling ratio of the blanket 21 after ten-minute immersion in solvents with a dipole moment nearly equal to the dipole moment of polydimethylsiloxane are extremely high. The swelling ratio after the ten-minute immersion is decreased with an increase in the dipole moment of the solvent, and the swelling ratio is decreased to about 10% at a dipole moment of around 1.5. Therefore, it is considered that a solvent with a dipole moment of about 1.5 or more is preferably used in the cleaning liquid R for the blanket 21. Moreover, the swelling ratio after the ten-minute immersion and the weight increase rate after the one-minute immersion are 2% or less and 10% or less, respectively, at a dipole moment of around 1.7, and are substantially uniform. Therefore, it is clear that a solvent with a dipole moment of about 1.7 or more is more preferably used as the cleaning liquid R for the blanket 21.

Moreover, in addition to low absorption into the blanket 21, it is necessary for the cleaning liquid R to have high solubility therein of the organic film made of the ink composition remaining on the blanket 21.

The ink composition includes a material (a solute) forming a target object and a solvent dissolving the material. As the solute of the ink composition, for example, an organic material is used in the case where an organic layer 14 (refer to FIG. 5) of an organic EL device 10 configuring an organic EL display unit 1 is formed. More specifically as the organic material (solute) of the ink composition, for example, a polymer or an oligomer with a molecular weight of about 5000 or more is preferably used. In particular, in the case where the light-emitting layer 14C is formed, the light-emitting layer 14C exhibits fluorescence or phosphorescence; therefore, an organic light-emitting material having a π-conjugated system in a molecule thereof is used.

Therefore, as the cleaning liquid R, a solvent having high solubility therein of the above-described organic light-emitting material is preferably used. As the solvent with high solubility, in terms of compatibility with the solute, a solvent having a dipole moment within a predetermined range is preferably used. Moreover, in the case where the organic light-emitting material having a π-conjugated system in a molecule thereof is used to exhibit the above-described fluorescence or phosphorescence, also in terms of compatibility with the solute, a solvent having a π covalent bond in a molecular skeleton thereof, more specifically a solvent having an oxygen atom or a nitrogen atom is preferably used.

FIG. 4 illustrates a relationship between time of cleaning the organic film from the blanket 21 by various solvents (indicated by a bar graph) and swelling ratios (%) of the blanket 21 after cleaning by the various solvents (indicated by a line graph). As can be seen from FIG. 4, when the blanket 21 is immersed in a solvent with a dipole moment of about 0.4 to 4.09 both inclusive for about three minutes, the organic film on the blanket 21 is dissolved and removed. On the other hand, even if the blanket 21 is immersed in octane not having a π covalent bond (with a dipole moment of 0), and dimethyl sulfoxide (a dipole moment of 4.3) and γ-butyl lactone (a dipole moment of 4.12) both having a high dipole moment for ten or more minutes, the organic film is not completely dissolved in these solvents; therefore, it is clear that these solvents have low solubility therein of the organic film.

It is to be noted that, even though the organic film is completely removed through immersing the blanket 21, for about two minutes, in xylene, tetralin, cyclohexylbenzene, and anisole all having a low dipole moment (for example, 1.2 or less), the swelling ratio of the blanket 21 is as high as 10% or more, and it takes one or more hours to completely dry the blanket 21. On the other hand, the organic film on the blanket 21 is completely removed through immersing the blanket 21, for about three minutes, in 1,3-dimethoxybenzene (with a dipole moment of about 1.72), acetophenone (with a dipole moment of 2.96), and N-methylpyrrolidone (with a dipole moment of 4.09) all having a high dipole moment (for example, 1.7 or more), and the blanket hardly swells. A slight increase in the swelling ratio is caused by the solvent remaining on the surface of the blanket 21, and the solvent is completely removable through blowing away the solvent by air or the like.

Thus, it is considered that the cleaning liquid R for the offset printing blanket according to the embodiment preferably uses a solvent having a dipole moment of about 1.7 or more but less than about 4.1 and having a π covalent bond in a molecular skeleton thereof.

FIG. 5 illustrates examples of typical solvents not reducing durability of a silicone rubber blanket and dipole moments of the solvents. Examples of solvents within the above-described range include 1,2-dimethoxybenzene, 1,3-dimethoxybenzene, acetophenone, cyclohexanone, 2-pentanone, 3-pentanone, 4-pentanone, N-methyl-2-pyrrolidone, and 1,3-dimethyl-2-imidazolidinone. The cleaning liquid R according to the embodiment may use only one kind selected from the above-described solvents or a combination of two or more kinds of solvents. In the case where the combination of two or more kinds of solvents is used, a solvent with a dipole moment out of the above-described range may be used.

As the solvent with a dipole moment out of the above-described range, a solvent having a low contact angle with the blanket 21 is preferably combined to spread the cleaning liquid R well on the blanket 21. The wetting spread of the cleaning liquid R is accelerated with use of the solvent with a low contact angle to reduce the total amount of the used cleaning liquid R. Examples of the solvent with a low contact angle include solvents such as tetralin and anisole. However, the solvent with a low contact angle with the blanket 21 has a low dipole moment, and absorption of the solvent into the blanket 21 tends to increase; therefore, it is not suitable to use the solvent singly. Accordingly, when the above-described solvent with a low contact angle with the blanket 21 is combined, the cleaning liquid R preferably contains 50% or more of the solvent.

(1-2. Cleaning Method)

The surface of the blanket 21 is cleaned by the above-described cleaning liquid R before and after a printing process to keep the surface of the blanket 21 clean and to remove the organic film remaining on the surface of the blanket 21 at the time of printing, as described above. More specifically, when foreign substances such as dust existing on the blanket 21 are removed before printing, the cleaning liquid R is discharged onto the blanket 21, or the blanket 21 is immersed in the cleaning liquid R, and then the solvent is removed by a rotating system, an air knife, or the like. Moreover, when the second pattern is printed with use of the same blanket 21 after printing the first pattern, the blanket 21 is immersed in the cleaning liquid R, and then the blanket 21 is kept immersed for several minutes (for example, five to ten minutes) while constantly supplying the cleaning liquid R. A method of drying the blanket 21 is performed by a method similar to the above-described method with use of a rotating system, an air knife, or the like to remove the solvent. In the embodiment, since a solvent which is not easily absorbed into the blanket 21 is used as the cleaning liquid R, a complicated drying method such as heating or vacuum drying is not necessary.

(1-3. Configuration and Manufacturing Method of Organic EL Display Unit)

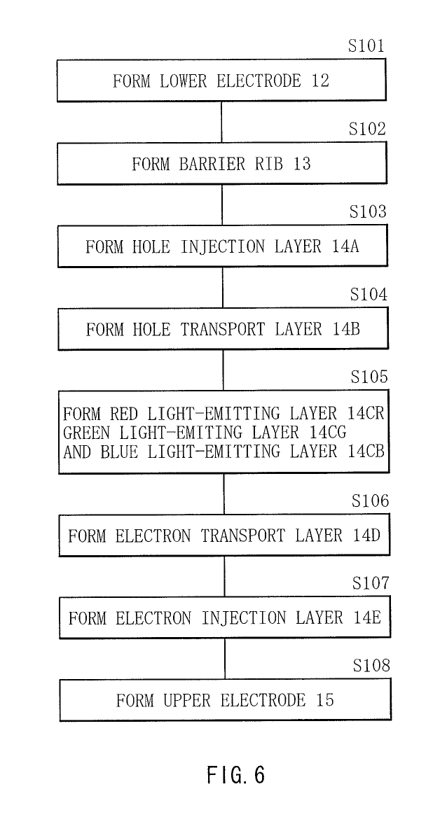

FIG. 6 is a flow chart illustrating a method of manufacturing a display unit 1 according to an embodiment of the disclosure, and FIG. 7 illustrates an example of a sectional configuration of the display unit 1 obtained by the manufacturing method. The display unit 1 is configured of red organic EL devices 10R, green organic EL devices 10G, and blue organic EL devices 10B arranged in a matrix. Each of the red organic EL devices 10R, the green organic EL devices 10G, and the blue organic EL devices 10B includes a lower electrode 12, the organic layer 14, and an upper electrode 15 on a substrate 11. In the display unit 1, red light-emitting layers 14CR of the red organic EL devices 10R, green light-emitting layers 14CG of the green organic EL devices 10G, and blue light-emitting layers 14CB of the blue organic EL devices 10B are formed by the reverse offset printing illustrated in FIGS. 1A to 1D and 2A to 2D.

(Forming Lower Electrode 12)

First, a transparent conductive film made of, for example, ITO (an oxide of indium and tin) is formed on an entire surface of the substrate 11 on which a pixel drive circuit (not illustrated) is formed, and patterning is performed on the transparent conductive film to thereby form each of the lower electrodes 12 of the red organic EL devices 10R, the green organic EL devices 10G, and the blue organic EL devices 10B (step S101). At this time, each of the lower electrodes 12 is connected to a driving transistor of the pixel drive circuit. For the substrate 11, for example, a known material such as quartz, glass, metal foil, or a film or a sheet made of a resin may be used; however, quartz or glass is preferably used. For each of the lower electrodes 12, a transparent conductive film made of a simple substance or an alloy of a metal element such as chromium (Cr), gold (Au), platinum (Pt), nickel (Ni), copper (Cu), tungsten (W), or silver (Ag), InZnO (indium zinc oxide), an alloy of zinc oxide (Zn) and aluminum (Al), or the like may be used.

(Forming Barrier Rib 13)

Next, an inorganic insulating film made of SiO₂ or the like is formed on the lower electrodes 12 and the substrate 11 by, for example, a CVD (Chemical Vapor Deposition) method, and patterning is performed on the inorganic insulating film with use of a photolithography technique and an etching technique to form a barrier rib 13 (step S102). The barrier rib 13 secures insulation between the lower electrode 12 and the upper electrode 15 and forms a light emission region into a desired shape; therefore, the barrier rib 13 has an opening corresponding to the light emission region. After the barrier rib 13 is formed, oxygen plasma treatment is performed on a surface (a surface where the barrier rib 13 and the lower electrodes 12 are formed) of the substrate 11 to clean a surface of the lower electrode 12.

(Forming Hole Injection Layer 14A and Hole Transport Layer 14B)

After the oxygen plasma treatment is performed, a hole injection layer 14A and a hole transport layer 14B common to the red organic EL devices 10R, the green organic EL devices 10G, and the blue organic EL devices 10B of the organic layer 14 are formed in this order on the lower electrodes 12 and the barrier rib 13 (steps S103 and S104).

For example, as will be described in detail later, the following materials may be used for the hole injection layer 14A and the hole transport layer 14B. As the material of the hole injection layer 14A, for example, polyaniline, polythiophene, polypyrrole, polyphenylene vinylene, polythienylene vinylene, polyquinoline, polyquinoxaline, or a derivative thereof, a conductive polymer such as a polymer including an aromatic amine structure in a main chain or a side chain, metal phthalocyanine (such as copper phthalocyanine), or carbon may be used. In addition to them, oligoaniline or polydioxythiophene such as poly(3,4-ethylenedioxythiophene) (PEDOT) may be used. Moreover, Nafion (trademark) and Liquion (trademark) available from H. C. Starck GmbH, ELsource (trademark) available from Nissan Chemical Industries. Ltd., a conductive polymer called Verazol (trademark) available from Soken Chemical & Engineering Co., Ltd. or the like may be used.

As the material of the hole transport layer 14B, for example, a polymer material such as polybinylcarbazole, polyfluorene, polyaniline, polysilane, a polysiloxane derivative having an aromatic amine in a side chain or a main chain, polythiophene or a derivative thereof, or polypyrrole may be used.

(Forming red light-emitting layer 14CR, green light-emitting layer 14CG, and blue light-emitting layer 14CB)

After the hole transport layer 14B is formed, the red light-emitting layers 14CR of the red organic EL devices 10R, the green light-emitting layers 14CG of the green organic EL devices 10G, and the blue light-emitting layers 14CB of the blue organic EL devices 10B are formed by reverse offset printing (step S105).

More specifically, the red light-emitting layers 14CR (the green light-emitting layers 14CG and the blue light-emitting layers 14CB) are formed with use of the above-described reverse offset printing (refer to FIGS. 1A to 1D and 2A to 2D). First, as described above, after the blanket 21 is cleaned with use of the above-described cleaning liquid R, the solvent is removed by, for example, an air knife. Next, as illustrated in FIG. 1A, the blanket 21 having the soft material layer on the base is prepared. Then, as illustrated in FIG. 1B, the soft material layer of the blanket 21 is coated with the ink composition 22 (for example, first, an ink for the red light-emitting layer 14CR). Next, as illustrated in FIG. 1C, the transfer layer 22a made of the ink composition 22 is formed by a spin coating method. It is to be noted that when the red light-emitting layers 14CR, the green light-emitting layers 14CG, and the blue light-emitting layers 14CB are formed in air, emission lifetimes of the organic EL devices 10R, 10G, and 10B may be reduced; therefore, printing is preferably performed under a nitrogen atmosphere.

After the transfer layer 22a made of the ink composition 22 for the red light-emitting layer 14CR is formed on the blanket 21, as illustrated in FIG. 1D, the reverse printing plate 23 is pressed against the transfer layer 22a. In this process, the blanket 21 and the reverse printing plate 23 are so arranged to become parallel to each other, and pressure is applied to a back surface of the blanket 21 to allow the blanket 21 and the reverse printing plate 23 to be brought into uniform contact with each other.

As described above, the reverse printing plate 23 has, on one surface thereof, a depression section with a pattern corresponding to a desired pattern (for example, the light-emitting layers 14CR). When the reverse printing plate 23 and the blanket 21 are brought into contact with each other to allow the depression section of the reverse printing plate 23 and the transfer layer 22a to face each other, as illustrated in FIG. 2A, the pattern layer 22b made of the ink composition 22 with the same pattern (for example, a pattern corresponding to the red light-emitting layers 14CR) as the pattern of the depression section of the reverse printing plate 23 is formed on the blanket 21. The non-printing section 22c made of the ink composition 22 with a reverse pattern of the pattern of the depression section (the same pattern as the pattern of the protrusion section) is formed on the reverse printing plate 23.

Next, as illustrated in FIG. 2B, the substrate 11 on which layers until the hole transport layer 14B are formed is prepared, and the substrate 11 is aligned to allow the pattern layer 22b of the blanket 21 and the hole transport layer 14B to face each other. In this case, the pattern layer 22b of the blanket 21 is aligned with positions corresponding to the red organic EL devices 10R. Next, as illustrated in FIG. 2C, the substrate 11 is pressed against the blanket 21, and then, as illustrated in FIG. 2D, the blanket 21 is separated from the substrate 11. Thus, the pattern layer 22b is printed on the hole transport layer 14B. The pattern layer 22b on the substrate 11 is heated to completely remove the solvent. Thus, the red light-emitting layers 14CR are formed. After that, as described above, the blanket 21 is cleaned with use of the above-described cleaning liquid R, and the solvent is removed by an air knife or the like, and then the green light-emitting layers 14CG and the blue light-emitting layers 14CB are formed in a similar manner.

Other methods of forming the red light-emitting layers 14CR, the green light-emitting layers 14CG, and the blue light-emitting layers 14CB include an inkjet printing method and a nozzle printing method. However, in these methods, it is necessary to maintain a liquid ink in regions where the light-emitting layers are to be formed until the ink is dried, and accordingly, it is necessary to form an upper barrier rib in addition to the barrier rib 13 in the embodiment serving as a lower barrier rib. On the other hand, when the red light-emitting layers 14CR, the green light-emitting layers 14CG, and the blue light-emitting layers 14CB are formed by the reverse offset printing, the upper barrier rib for maintaining the ink is not necessary, and simplification of the configuration of the display unit 1 illustrated in FIG. 7 is achievable. Moreover, the red light-emitting layers 14CR, the green light-emitting layers 14CG, and the blue light-emitting layers 14CB are not contaminated by the upper barrier rib.

The organic material as the solute of the ink composition 22, in particular, a polymer material forms the red light-emitting layers 14CR, the green light-emitting layers 14CG, and the blue light-emitting layers 14CB, and emits light by the recombination of electrons and holes in response to the application of an electric field. Examples of the polymer material include a polyfluorene-based polymer derivative, a (poly)paraphenylene vinylene derivative, a polyphenylene derivative, a polyvinylcarbazole derivative, a polythiophene derivative, a perylene-based pigment, a coumarin-based pigment, a rhodamine-based pigment, and the above-described polymer doped with an organic EL material. As a doping material, for example, rubrene, perylene, 9,10-diphenylanthracene, tetraphenyl butadiene, nile red, or Coumarin6 may be used.

Moreover, the ink composition 22 may include a low-molecular material in addition to the above-described polymer material. When the low-molecular material is used, the red light-emitting layers 14CR, the green light-emitting layers 14CG, and the blue light-emitting layers 14CB are allowed to be formed with high definition on the substrate 11 by patterning, and resolution of the display unit 1 is improvable.

More specifically, when the transfer layer 22a is formed on the blanket 21 (refer to FIG. 1C), or before the pattern layer 22b is transferred from the blanket 21 to the substrate 11 (a printing substrate) as will be described later (refer to FIGS. 2A and 2B), the low-molecular material inhibits the ink composition 22 (the transfer layer 22a or the pattern layer 22b) from being formed into a film on the blanket 21. Therefore, high-definition patterning is achievable. The conformation of the above-described polymer material varies according to concentration and spin coating conditions. In the case where the low-molecular material is not included in the ink composition 22, it is presumed that molecules of the polymer material easily intertwine with one another, and the polymer material is easily formed into a film on the blanket 21 accordingly. Since the low-molecular material inhibits the polymer material from being formed into a film, the red light-emitting layers 14CR and the green light-emitting layers 14CG are allowed to be formed with high-definition line and space (line resolution) on the substrate 11. In the display unit 1, the low-molecular material, together with the above-described polymer material, forms the red light-emitting layers 14CR, the green light-emitting layers 14CG, and the blue light-emitting layers 14CB.

The low-molecular material of the ink composition 22 means a low-molecular material with a substantially single molecular weight other than a compound made up of molecules of a polymer or a condensation product having a high molecular weight which is produced through successively repeating the same or similar reaction by a low-molecular compound. Moreover, in the low-molecular material, a new chemical bond between molecules is not formed by heating, and the low-molecular material exits in a single molecular state.

The weight-average molecular weight (Mw) of such a low-molecular material is preferably 50000 or less, and is more preferably 15000 or less, because, compared to a material with a large molecular weight of, for example, larger than 50000, a material with a small molecular weight to some extent has various properties; therefore, conditions such as solubility in a solvent and viscosity of an ink are easily adjusted.

Further, a ratio between the polymer material and the low-molecular material is preferably within a range of about 10:1 to 1:2 both inclusive in weight ratio, and is more preferably within a range of about 2:1 to 1:2 both inclusive in weight ratio. When the ratio between the polymer material and the low-molecular material is less than about 10:1 in weight ratio, an effect caused by the low-molecular material is less likely to be exerted. Meanwhile, when the ratio between the polymer material and the low-molecular material is larger than about 1:2, it may be difficult to form a film.

As the low-molecular material, for example, benzene, styrylamine, triphenylamine, porphyrin, triphenylene, azatriphenylene, tetracyanoquinodimethane, triazole, imidazole, carbazole, oxadiazole, polyarylalkane, phenylenediamine, arylamine, oxazole, anthracene, fluorenone, hydrazone, stilbene, or a derivative thereof, or a heterocyclic conjugated system monomer or oligomer such as a polysilane-based compound, a vinylcarbazole-based compound, a thiophene-based compound, or an aniline-based compound may be used.

Specific examples of the above-described low-molecular material include α-naphthylphenylphenylenediamine, porphyrin, metal tetraphenylporphyrin, metal naphthalocyanine, hexacyanoazatriphenylene, 7,7,8,8-tetracyanoquinodimethane (TCNQ), 7,7,8,8-tetracyano-2,3,5,6-tetrafluoroquinodimethane (F4-TCNQ), tetracyano-4,4,4-tris(3-methylphenylphenylamino)triphenyamine, N,N,N′,N′,-tetrakis(p-tolyl)p-phenylenediamine, N,N,N′,N′,-tetraphenyl-4,4′-diaminobiphenyl, N-phenylcarbazole, 4-di-p-tolylaminostilbene, poly(paraphenylenevinylene), poly(thiophenevinylene), and poly(2,2′-thienylpyrrol). However, the low-molecular material is not limited thereto.

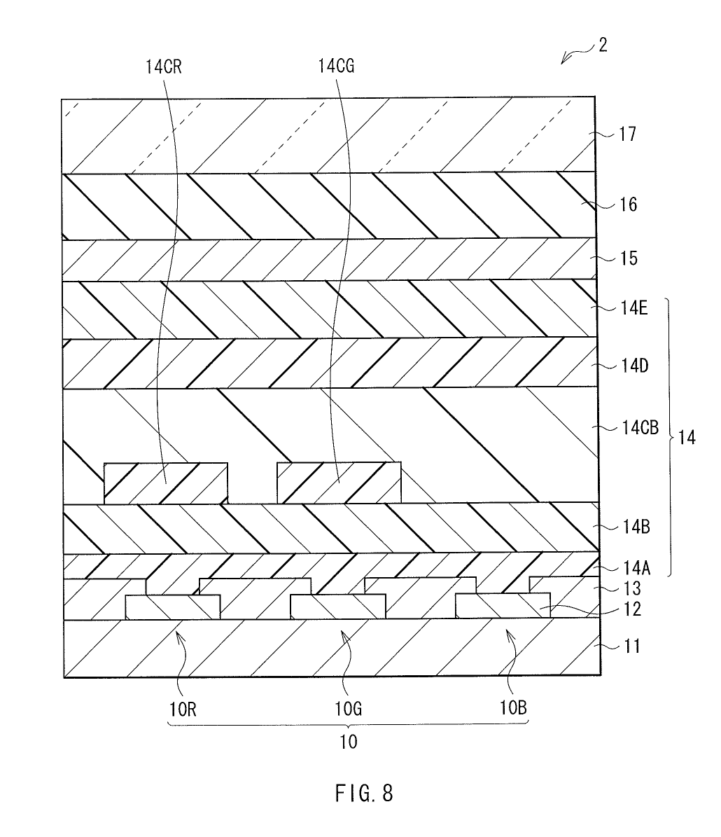

It is to be noted that, as illustrated in FIG. 8, the blue light emitting layer 14CB may be formed as a common layer. In this case, after the red light-emitting layers 14CR and the green light-emitting layers 14CG are formed, the blue light-emitting layer 14CB is formed on entire surfaces of the red light-emitting layers 14CR, the green light-emitting layers 14CG, and the hole transport layer 14B by an evaporation method. As the material of the blue light-emitting layer 14CB serving as a common layer, for example, an anthracene compound as a host material doped with a blue or green fluorescent pigment as a guest material is used. Thus, the blue light-emitting layer 14CB emits blue or green light.

Moreover, when the low-molecular material is included in the ink composition 22 forming the red light-emitting layers 14CR and the green light-emitting layers 14CG in the case where the blue light-emitting layer 14CB serves as a common layer, injection efficiency of holes and electrons from the blue light-emitting layer 14CB laminated on the red light-emitting layers 14CR and the green light-emitting layers 14CG to each of the light-emitting layers 14CR and 14CG is improvable during operation of a display unit 2. In other words, characteristics of the red organic EL devices 10R and the green organic EL devices 10G are improved.

In the case where the red light-emitting layers 14CR and the green light-emitting layers 14CG do not include the above-described low-molecular material, a difference between the energy level of the blue light-emitting layer 14CB and the energy levels of the red light-emitting layers 14CR and the green light-emitting layers 14CG is increased. In other words, hole or electron injection efficiency between the blue light-emitting layer 14CB and the red and green light-emitting layers 14CR and 14CG may be reduced, and desired characteristics may not be obtained. On the other hand, when the red light-emitting layers 14CR and the green light-emitting layers 14CG are made of the low-molecular material together with the polymer material, the difference in energy level is reduced, and the above-described injection efficiency of holes and electrons are improvable.

(Forming Electron Transport Layer 14D, Electron Injection Layer 14e, and Upper Electrode 15)

After the blue light-emitting layer 14CB are formed, the electron transport layer 14D, the electron injection layer 14E, and the upper electrode 15 are formed on entire surfaces of the red, green, and blue light-emitting layers 14CR, 14CG, and 14CB (in the display unit 1) or an entire surface of the blue light-emitting layer 14CB (in the display unit 2) by an evaporation method (steps S106, S107, and S108).

The electron transport layer 14D enhances electron transport efficiency to the red light-emitting layers 14CR, the green light-emitting layers 14CG, and the blue light-emitting layers 14CB. Examples of the material of the electron transport layer 14D include quinoline, perylene, phenanthroline, bisstyryl, pyrazine, triazole, oxazole, fullerene, oxadiazole, fluorenone, a derivative thereof, and a metal complex thereof. More specific examples include tris(8-hydroxyquinoline) aluminum (Alq3 for short), anthracene, naphthalene, phenanthrene, pyrene, perylene, butadiene, coumarin, C60, acridine, stilbene, 1,10-phenanthroline, a derivative thereof, and a metal complex thereof.

The electron injection layer 14E enhances electron injection efficiency. As the material of the electron injection layer 14E, for example, lithium oxide (Li₂O) which is an oxide of lithium (Li), cesium carbonate (Cs₂CO₃) which is a complex oxide of cesium, or a mixture of the oxide and the complex oxide may be used. Moreover, as the material of the electron injection layer 14E, a simple substance, a mixture, or an alloy of an alkali-earth metal such as calcium (Ca) or barium (Ba), an alkali metal such as lithium or cesium, a metal with a small work function such as indium (In) or magnesium (Mg) may be used.

The upper electrode 15 is disposed on an entire surface of the substrate 11 while being insulated from the lower electrode 15 by the barrier rib 13 and the organic layer 14, and functions as an electrode common to the red organic EL devices 10R, the green organic EL devices 10G, and the blue organic EL devices 10B. The upper electrode 15 is configured of, for example, a metal conductive film of aluminum, magnesium, calcium, sodium (Na), or the like. The upper electrode 15 is preferably formed of an alloy of magnesium and silver (an Mg—Ag alloy) having favorable conductivity in the case of being used as a thin film and having small light absorption. The ratio between magnesium and silver in the Mg—Ag alloy is not specifically limited, but the ratio is preferably within a range of Mg:Ag=about 20:1 to 1:1 both inclusive in film thickness ratio. Moreover, the material of the upper electrode 15 may be an alloy of aluminum and lithium (an Al—Li alloy).

The upper electrode 15 may be configured of a mixture layer including an organic light-emitting material such as an aluminum quinoline complex, a styrylamine derivative, or a phthalocyanine derivative. In this case, the upper electrode 15 may further include, as a third layer, a layer with light transmittance such as an Mg—Ag alloy.

After the upper electrode 15 is formed, a protective layer 16 made of amorphous silicon nitride with low water permeability is formed by, for example, an evaporation method or a CVD method. After the protective layer 16 is formed, a sealing substrate 17 provided with a light-shielding film and a color filter (both not illustrated) is bonded onto the protective film 16 with an adhesive layer (not illustrated) in between. Thus, the display unit 1 illustrated in FIG. 7 is completed.

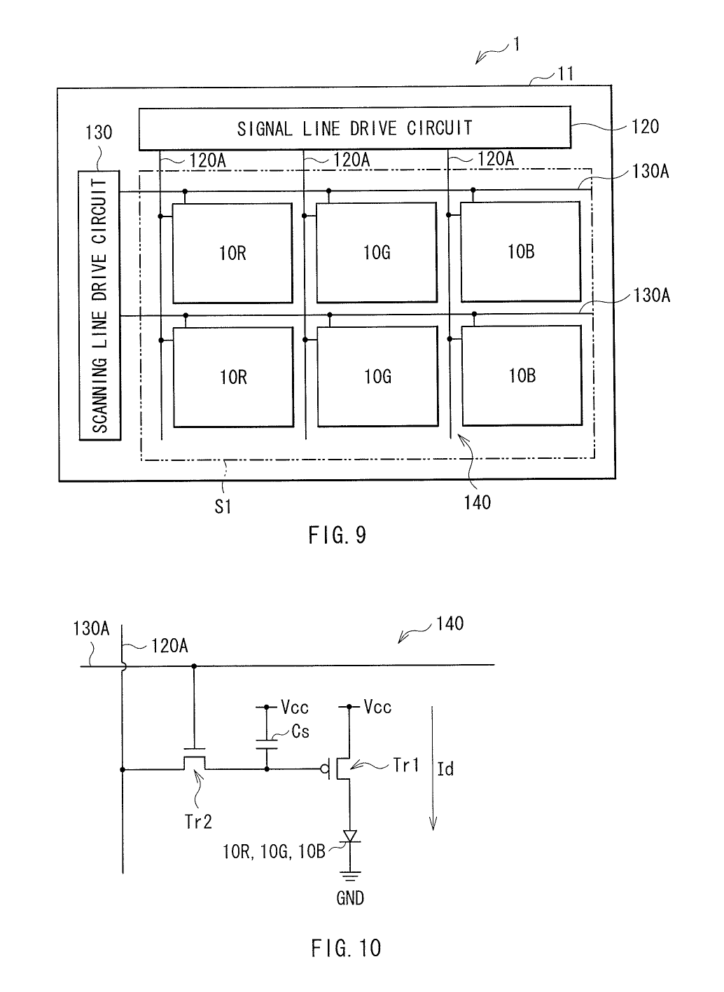

FIG. 9 illustrates a planar configuration of the display unit 1 including the organic EL devices 10 according to the embodiment. The display unit 1 is used as an organic EL television or the like, and includes, for example, a plurality of organic EL devices 10 (for example, the red organic EL devices 10R, the green organic EL devices 10G, and the blue organic EL devices 10B) which are arranged in a matrix as a display region 1110 on the substrate 11. A signal line drive circuit 120 and a scanning line drive circuit 130 as drivers for image display are disposed around the display region 110. It is to be noted that a combination of adjacent organic EL devices 1010 configures one pixel.

A pixel drive circuit 140 is disposed in the display region 110. FIG. 10 illustrates an example of the pixel drive circuit 140. The pixel drive circuit 140 is an active drive circuit formed below the lower electrode 12. In other words, the pixel drive circuit 140 includes a driving transistor Tr1 and a writing transistor Tr2, a capacitor (retention capacitor) Cs between the driving transistor Tr1 and the writing transistor Tr2, and the organic EL device 10 (for example, 11R, 11G, or 11B) connected to the driving transistor Tr1 in series between a first power source line (Vcc) and a second power source line (GND). The driving transistor Tr1 and the writing transistor Tr2 each are configured of a typical TFT, and the TFT may have, for example, an inverted stagger configuration (a so-called bottom gate type) or a stagger configuration (a top gate type), and the configuration of the TFT is not specifically limited.

In the pixel drive circuit 140, a plurality of signal lines 120A are arranged in a column direction, and a plurality of scanning lines 130A are arranged in a row direction. An intersection between each signal line 120A and each scanning line 130A corresponds to one (one sub-pixel) of organic EL devices 10. Each signal line 120A is connected to the signal line drive circuit 120, and an image signal is supplied from the signal line drive circuit 120 to a source electrode of the writing transistor Tr2 through the signal line 120A. Each scanning line 130A is connected to the scanning line drive circuit 130, and a scanning signal is sequentially supplied from the scanning line drive circuit 130 to a gate electrode of the writing transistor Tr2 through the scanning line 130A.

In the display unit 1, a scanning signal is supplied from the scanning line drive circuit 130 to each pixel through a gate electrode of the writing transistor Tr2, and an image signal supplied from the signal line drive circuit 120 through the writing transistor Tr2 is retained in the retention capacitor Cs. In other words, on-off control of the driving transistor Tr1 is performed in response to the signal retained in the retention capacitor Cs, and a drive current Id is thereby injected into each of the red organic EL devices 10R, the green organic EL devices 10G, and the blue organic EL devices 10B to emit light by the recombination of electrons and holes. In the case of bottom emission, the light passes through the lower electrodes 12 and the substrate 11, and in the case of a top emission, the light passes through the upper electrode 15, a wavelength conversion section, and the sealing substrate 17, and then the light is extracted.

In the case where only one blanket is used in a continuous printing process in a plate printing method, it is necessary to remove a printing residue (a remaining organic film) or foreign substances on the blanket. Moreover, in the plate printing method, a surface of the blanket and a printing substrate are brought into direct contact with each other when performing printing on the printing substrate. Therefore, in the case where a foreign substance such as dust exists on the surface of the blanket, for example, in the display unit, a defect such as a short circuit may be caused by the foreign substance. Moreover, when the printing residue is removed with use of, for example, an adhesive, the adhesive is reversely transferred to the blanket to cause a decline in releasability or a deterioration in characteristics of organic EL devices.

As a method of solving the above-described issues, a method of immersing the blanket in a solvent to clean and remove the foreign substances or the printing residue from the blanket is considered. However, silicone rubber forming the blanket easily absorbs the solvent, and in continuous printing, there is time to completely dry the blanket after cleaning in consideration of stability of a printing pattern. However, as described above, the blanket has high absorption of the solvent, and it takes significant time (for example, ten hours to several days) to completely dry the blanket. Accordingly, manufacturing efficiency declines. Moreover, manufacturing efficiency is improvable through changing the blanket every time the printing pattern is changed; however, in this case, manufacturing cost is increased due to an increase in the number of blankets, storage of the blankets in an environment with high cleanness, an increase in the number of processes, and the like.

On the other hand, the offset printing blanket cleaning liquid R according to the embodiment uses a solvent having a dipole moment of about 1.7 or more but less than about 4.1 and having a π covalent bond in a molecular skeleton thereof. Polydimethylsiloxane existing on the surface of the blanket 21 has little polarity. Therefore, when a solvent having higher polarity than polydimethylsiloxane is used, absorption of the solvent into the blanket 21 is suppressed, thereby suppressing swelling of the blanket.

Thus, according to the embodiment, the solvent having a dipole moment of about 1.7 or more but less than about 4.1 and having a π covalent bond in a molecular skeleton thereof is used as the offset printing blanket cleaning liquid R. Therefore, drying time after cleaning the blanket 21 before and after printing is allowed to be reduced. Moreover, the same blanket is allowed to be continuously used in multi-stage printing without adding further equipment such as a solvent drying device. Accordingly, a display unit with high display quality and low cost is achievable.

### 2. Second Embodiment

(2-1. Ink Composition)

An ink composition according to a second embodiment of the disclosure is used to form, for example, light-emitting layers 14C of red (R), green (G), and blue (B) in an organic EL display unit (the display unit 1, refer to FIG. 7) by a plate printing method with use of a plate. In the plate printing method, for example, reverse offset printing, as described above, first, an ink coating (the transfer layer 22a) is formed on the blanket 21, and then the blanket 21 is brought into contact with an engraved plate (the reverse printing plate 23), and then a pattern (the pattern layer 22b) remaining on the blanket 21 is brought into contact with a printing substrate (the substrate 11) to be transferred from the blanket 21 to the printing substrate. Thus, printing is performed (refer to FIGS. 1A to 1D and FIGS. 2A to 2D). In the embodiment, the structure of the ink composition used in the plate printing method will be described in detail below.

The ink composition includes a material (solute) forming a target object and a solvent dissolving the material.

As the solute of the ink composition, for example, an organic material is used in the case where the organic layer 14 (refer to FIG. 7) of each organic EL device 10 configuring the organic EL display unit 1 is formed. In the plate printing method, it is necessary to increase the viscosity of the ink composition in terms of printing performance. Therefore, as the organic material (solute) of the ink composition, for example, a polymer or an oligomer with a molecular weight of about 5000 or more is preferably used. In particular, in the case where the light-emitting layer 14C is formed, the light-emitting layer 14C exhibits fluorescence or phosphorescence; therefore, an organic light-emitting material having a π-conjugated system in a molecule thereof is preferably used.

As the solvent of the ink composition, a solvent having high solubility therein of the above-described organic material is preferably used. As the solvent with high solubility, in terms of compatibility with the solute, a solvent having a dipole moment within a predetermined range is preferably used. Moreover, in the case where the organic light-emitting material having a π-conjugated system in a molecule thereof is used to exhibit the above-described fluorescence or phosphorescence, also in terms of compatibility with the solute, a solvent having a π covalent bond in a molecular skeleton thereof, more specifically a solvent having an oxygen atom or a nitrogen atom is preferably used.

A preferable value of the dipole moment of the solvent of the ink composition according to the embodiment will be described below.

For example, when a solvent having high compatibility with silicone rubber is used as an ink solvent, the blanket 21 made of silicone rubber easily absorbs the ink solvent. Therefore, an ink applied to the blanket 21 may be rapidly dried to cause difficulty in pattern formation. Therefore, as the solvent of the ink composition according to the embodiment, a solvent which has superior solubility therein of the organic material and is not easily absorbed into the blanket 21 is preferably used.

A blanket, in particular, the above-described blanket 21 made of silicone rubber is typically formed of polydimethylsiloxane as a base (a main component). Since polydimethylsiloxane exits on a surface of the blanket 21, and has little polarity, swelling of polydimethylsiloxane is not easily caused by a solvent with high polarity. Typically, the dipole moment is used as an indicator of polarity, and the dipole moment of polydimethylsiloxane is within a range of about 0 to 0.5.

Therefore, as the solvent of the ink composition according to the embodiment, a solvent having a higher dipole moment than polydimethylsiloxane, more specifically, a solvent with a dipole moment of more than about 0.5 is preferably used, and a solvent with a dipole moment of about 1.3 or more is more preferably used.

On the other hand, to improve coating properties on the blanket 21, a solvent having a small contact angle with the blanket 21 is preferably used. The blanket 21 made of silicone is formed of polydimethylsiloxane as a base, as described above. Therefore, when a solvent having polarity or a dipole moment close to the polarity or the dipole moment of polydimethylsiloxane is used as an auxiliary solvent, wettability is improvable. Moreover, when a difference between the dipole moment of polydimethylsiloxane and the dipole moment of the solvent of the ink composition is large, a printing pattern may not be maintained. Therefore, the dipole moment of the solvent is preferably about 4 or less, and more preferably about 3.0 or less.

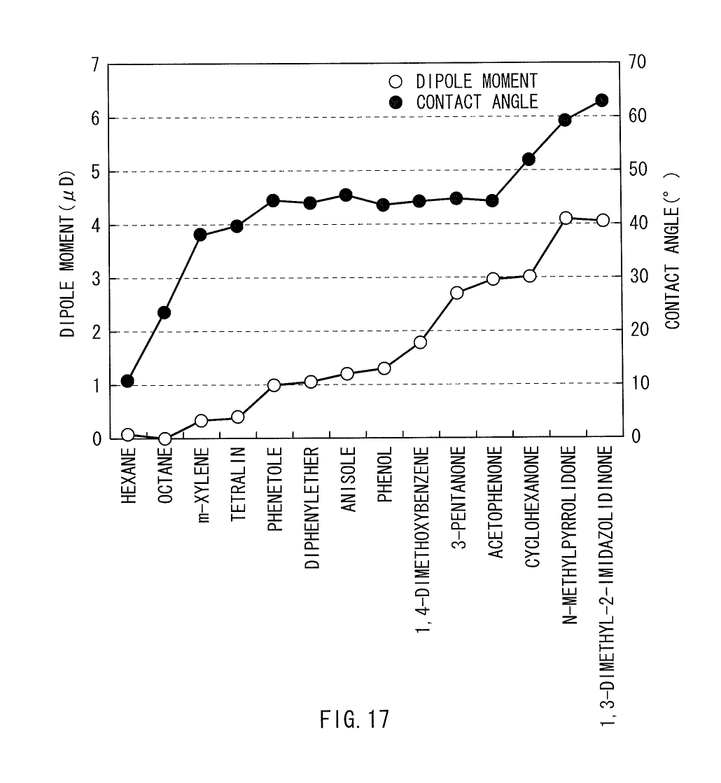

Thus, it is considered that a preferable value of the dipole moment of the solvent is within a range of about 1.3 to about 3.0 both inclusive. FIG. 17 illustrates dipole moments and contact angles with the blanket 21 of various solvents including hexane, octane, xylene, tetralin, phenetole, diphenylether, anisole, acetophenone, cyclohexanone, N-methyl-pyrrolidone, and 3-dimethyl-2-imidazolidinone. Specific examples of the solvent of the ink composition according to the embodiment in FIG. 17 include phenol, 2-pentane, 3-pentane, 4-pentane, acetophenone, cyclohexanone and N-methyl-pyrrolidone.

It is to be noted that a combination of two or more kinds of solvents may be used as the solvent of the ink composition according to the embodiment. In this case, a solvent with a dipole moment out of the above-described range may be used. To improve the coating properties on the blanket 21, for example, a solvent with a small contact angle with the blanket 21 may be combined as an auxiliary solvent. A solvent not having a conjugated system and having smaller interaction between molecules tends to have a smaller contact angle. More specifically, as the auxiliary solvent, a solvent having polarity close to the polarity of polydimethylsiloxane, for example, ether not having a straight-chain hydrocarbon system or a π bond such as hexane or octane, or an alcohol solvent may be used. The contact angle of the ink composition with the blanket 21 is preferably about 30° or less.

(2-2. Manufacturing Method)

FIGS. 1A to 1D and 2A to 2D illustrate a process of reverse offset printing. First, as illustrated in FIG. 1A, the blanket 21 is prepared. The blanket 21 is configured of, for example, a soft material layer made of silicone rubber laminated on a base made of PET (polyethylene terephthalate) or metal. As illustrated in FIG. 1B, the soft material layer of the blanket 21 is coated with the ink composition 22. Then, as illustrated in FIG. 1C, the transfer layer 22a made of the ink composition 22 is formed by a spin coating method.

Next, as illustrated in FIG. 1D, the reverse printing plate 21 is pressed against the blanket 21 on which the transfer layer 22a is formed. In this process, the blanket 21 and the reverse printing plate 23 are so arranged to become parallel to each other, and pressure is applied to a back surface of the blanket 21 to allow the blanket 21 and the reverse printing plate 23 to be brought into uniform contact with each other.

The reverse printing plate 23 is made of, for example, an inorganic material such as glass or silicon, or metal such as stainless, copper, or nickel, and has a depression section with a pattern corresponding to a desired printed material. When the reverse printing plate 23 and the blanket 21 are brought into contact with each other to allow the depression section of the reverse printing plate 23 and the transfer layer 22a to face each other, as illustrated in FIG. 2A, the pattern layer 22b made of the ink composition 22 with the same pattern as the pattern of the depression section of the reverse printing plate 23 is formed on the blanket 21. The non-printing section 22c made of the ink composition 22 with a reverse pattern of the pattern of the depression section (the same pattern as the pattern of the protrusion section) is formed on the reverse printing plate 23. The reverse printing plate 23 and the blanket 21 are preferably brought into contact with each other within a short time, for example, one minute after the transfer layer 22a is formed on the blanket 21. If too much time elapses, the solvent of the ink composition 22 is volatilized to dry the transfer layer 22a.

Next, as illustrated in FIG. 2B, the substrate 11 is prepared, and the substrate 11 is aligned to allow the pattern layer 22b of the blanket 21 and a pattern formation position on the substrate 11 to face each other. Then, as illustrated in FIG. 2C, the substrate 11 is pressed against the blanket 21 by, for example, a compressed gas pressurization method, and then, as illustrated in FIG. 2D, the blanket 21 is separated from the substrate 11. Thus, the pattern layer 22b is printed on the substrate 11. The blanket 21 and the substrate 11 are preferably brought into contact with each other within thirty minutes after the pattern layer 22b is formed. If too much time elapses, the solvent of the ink composition 22 is volatilized, and it is difficult to transfer (separate) the pattern layer 22A from the blanket 21 accordingly.

(2-3. Configuration of Organic EL Display Unit)

FIG. 6 is a flow chart illustrating the method of manufacturing the display unit 1 according to the embodiment of the disclosure, and FIG. 7 illustrates an example of a sectional configuration of the display unit 1 obtained by the manufacturing method. The display unit 1 is configured of the red organic EL devices 10R, the green organic EL devices 10G, and the blue organic EL devices 10B arranged in a matrix. Each of the red organic EL devices 10R, the green organic EL devices 10G, and the blue organic EL devices 10B includes the lower electrode 12, the organic layer 14, and the upper electrode 15 on the substrate 11. In the display unit 1, the red light-emitting layers 14CR of the red organic EL devices 10R, the green light-emitting layers 14CG of the green organic EL devices 10G, and the blue light-emitting layers 14CB of the blue organic EL devices 10B are formed by the reverse offset printing illustrated in FIGS. 1A to 1D and 2A to 2D.

(Forming Lower Electrode 12)

First, a transparent conductive film made of, for example, ITO (an oxide of indium and tin) is formed on an entire surface of the substrate 11 on which a pixel drive circuit (not illustrated) is formed, and patterning is performed on the transparent conductive film to thereby form each of the lower electrodes 12 of the red organic EL devices 10R, the green organic EL devices 10G, and the blue organic EL devices 10B (step S101). At this time, each of the lower electrodes 12 is connected to a driving transistor of the pixel drive circuit. For the substrate 11, for example, a known material such as quartz, glass, metal foil, or a film or a sheet made of a resin may be used; however, quartz or glass is preferably used. For each of the lower electrodes 12, a transparent conductive film made of a simple substance or an alloy of a metal element such as chromium (Cr), gold (Au), platinum (Pt), nickel (Ni), copper (Cu), tungsten (W), or silver (Ag), InZnO (indium zinc oxide), an alloy of zinc oxide (Zn) and aluminum (Al), or the like may be used.

(Forming Barrier Rib 13)

Next, an inorganic insulating film made of SiO₂ or the like is formed on the lower electrodes 12 and the substrate 11 by, for example, a CVD (Chemical Vapor Deposition) method, and patterning is performed on the inorganic insulating film with use of a photolithography technique and an etching technique to form a barrier rib 13 (step S102). The barrier rib 13 secures insulation between the lower electrode 12 and the upper electrode 15 and forms a light emission region into a desired shape; therefore, the barrier rib 13 has an opening corresponding to the light emission region. After the barrier rib 13 is formed, oxygen plasma treatment is performed on a surface (a surface where the barrier rib 13 and the lower electrodes 12 are formed) of the substrate 11 to clean a surface of the lower electrode 12.

(Forming Hole Injection Layer 14A and Hole Transport Layer 14B)

After the oxygen plasma treatment is performed, a hole injection layer 14A and a hole transport layer 14B common to the red organic EL devices 10R, the green organic EL devices 10G, and the blue organic EL devices 10B of the organic layer 14 are formed in this order on the lower electrodes 12 and the barrier rib 13 (steps S103 and S104).

For example, as will be described in detail later, the following materials may be used for the hole injection layer 14A and the hole transport layer 14B. As the material of the hole injection layer 14A, for example, polyaniline, polythiophene, polypyrrole, polyphenylene vinylene, polythienylene vinylene, polyquinoline, polyquinoxaline, or a derivative thereof, a conductive polymer such as a polymer including an aromatic amine structure in a main chain or a side chain, metal phthalocyanine (such as copper phthalocyanine), or carbon may be used. In addition to them, oligoaniline or polydioxythiophene such as poly(3,4-ethylenedioxythiophene) (PEDOT) may be used. Moreover, Nafion (trademark) and Liquion (trademark) available from H. C. Starck GmbH, ELsource (trademark) available from Nissan Chemical Industries. Ltd., a conductive polymer called Verazol (trademark) available from Soken Chemical & Engineering Co., Ltd. or the like may be used.

As the material of the hole transport layer 14B, for example, a polymer material such as polybinylcarbazole, polyfluorene, polyaniline, polysilane, a polysiloxane derivative having an aromatic amine in a side chain or a main chain, polythiophene or a derivative thereof, or polypyrrole may be used.

(Forming Red Light-Emitting Layer 14CR, Green Light-Emitting Layer 14CG, and Blue Light-Emitting Layer 14CB)

After the hole transport layer 14B is formed, the red light-emitting layers 14CR of the red organic EL devices 10R, the green light-emitting layers 14CG of the green organic EL devices 10G, and the blue light-emitting layers 14CB of the blue organic EL devices 10B are formed by reverse offset printing (step S105).

More specifically, the red light-emitting layers 14CR (the green light-emitting layers 14CG and the blue light-emitting layers 14CB) are formed with use of the above-described reverse offset printing (refer to FIGS. 1A to 1D and 2A to 2D). First, as illustrated in FIG. 1A, the blanket 21 having the soft material layer on the base is prepared. Next, as illustrated in FIG. 1B, the soft material layer of the blanket 21 is coated with the ink composition 22 (for example, first, an ink for the red light-emitting layer 14CR). Next, as illustrated in FIG. 1C, the transfer layer 22a made of the ink composition 22 is formed by a spin coating method. It is to be noted that when the red light-emitting layers 14CR, the green light-emitting layers 14CG, and the blue light-emitting layers 14CB are formed in air, emission lifetimes of the organic EL devices 10R, 10G, and 10B may be reduced; therefore, printing is preferably performed under a nitrogen atmosphere.

After the transfer layer 22a made of the ink composition 22 for the red light-emitting layer 14CR is formed on the blanket 21, as illustrated in FIG. 1D, the reverse printing plate 23 is pressed against the transfer layer 22a.

As described above, the reverse printing plate 23 has, on one surface thereof, a depression section with a pattern corresponding to a desired pattern (for example, the light-emitting layers 14CR). When the reverse printing plate 23 and the blanket 21 are brought into contact with each other to allow the depression section of the reverse printing plate 23 and the transfer layer 22a to face each other, as illustrated in FIG. 2A, the pattern layer 22b made of the ink composition 22 with the same pattern (for example, a pattern corresponding to the red light-emitting layers 14CR) as the pattern of the depression section of the reverse printing plate 23 is formed on the blanket 21. The non-printing section 22c made of the ink composition 22 with a reverse pattern of the pattern of the depression section (the same pattern as the pattern of the protrusion section) is formed on the reverse printing plate 23.

Next, as illustrated in FIG. 2B, the substrate 11 on which layers until the hole transport layer 14B are formed is prepared, and the substrate 11 is aligned to allow the pattern layer 22b of the blanket 21 and the hole transport layer 14B to face each other. In this case, the pattern layer 22b of the blanket 21 is aligned with positions corresponding to the red organic EL devices 10R. Next, as illustrated in FIG. 2C, the substrate 11 is pressed against the blanket 21, and then, as illustrated in FIG. 2D, the blanket 21 is separated from the substrate 11. Thus, the pattern layer 22b is printed on the hole transport layer 14B. The pattern layer 22b on the substrate 11 is heated to completely remove the solvent. Thus, the red light-emitting layers 14CR are formed. After that, a new blanket 21 is prepared, and then the green light-emitting layers 14CG and the blue light-emitting layer 14CB are formed in a similar manner.

Other methods of forming the red light-emitting layers 14CR, the green light-emitting layers 14CG, and the blue light-emitting layers 14CB include an inkjet printing method and a nozzle printing method. However, in these methods, it is necessary to maintain a liquid ink in regions where the light-emitting layers are to be formed until the ink is dried, and accordingly, it is necessary to form an upper barrier rib in addition to the barrier rib 13 in the embodiment serving as a lower barrier rib. On the other hand, when the red light-emitting layers 14CR, the green light-emitting layers 14CG, and the blue light-emitting layers 14CB are formed by the reverse offset printing, the upper barrier rib for maintaining the ink is not necessary, and simplification of the configuration of the display unit 1 illustrated in FIG. 7 is achievable. Moreover, the red light-emitting layers 14CR, the green light-emitting layers 14CG, and the blue light-emitting layers 14CB are not contaminated by the upper barrier rib.

In this case, the ink composition 22 is prepared through mixing a polymer (light-emitting) material and a low-molecular material forming the red light-emitting layer 14CR or the green light-emitting layer 14CG into a solvent having a dipole moment of about 1.3 to about 3.0 both inclusive and having a π covalent bond in a molecular skeleton thereof.

The organic material as the solute of the ink composition 22, in particular, a polymer material forms the red light-emitting layers 14CR, the green light-emitting layers 14CG, and the blue light-emitting layers 14CB, and emits light by the recombination of electrons and holes in response to the application of an electric field. Examples of the polymer material include a polyfluorene-based polymer derivative, a (poly)paraphenylene vinylene derivative, a polyphenylene derivative, a polyvinylcarbazole derivative, a polythiophene derivative, a perylene-based pigment, a coumarin-based pigment, a rhodamine-based pigment, and the above-described polymer doped with an organic EL material. As a doping material, for example, rubrene, perylene, 9,10-diphenylanthracene, tetraphenyl butadiene, nile red, or Coumarin6 may be used.

Moreover, the ink composition 22 may include a low-molecular material in addition to the above-described polymer material. When the low-molecular material is used, the red light-emitting layers 14CR, the green light-emitting layers 14CG, and the blue light-emitting layers 14CB are allowed to be formed with high definition on the substrate 11 by patterning, and resolution of the display unit 1 is improvable.

More specifically, when the transfer layer 22a is formed on the blanket 21 (refer to FIG. 1C), or before the pattern layer 22b is transferred from the blanket 21 to the substrate 11 (a printing substrate) as will be described later (refer to FIGS. 2A and 2B), the low-molecular material inhibits the ink composition 22 (the transfer layer 22a or the pattern layer 22b) from being formed into a film on the blanket 21. Therefore, high-definition patterning is achievable. The conformation of the above-described polymer material varies according to concentration and spin coating conditions. In the case where the low-molecular material is not included in the ink composition 22, it is presumed that molecules of the polymer material easily intertwine with one another, and the polymer material is easily formed into a film on the blanket 21 accordingly. Since the low-molecular material inhibits the polymer material from being formed into a film, the red light-emitting layers 14CR and the green light-emitting layers 14CG are allowed to be formed with high-definition line and space (line resolution) on the substrate 11. In the display unit 1, the low-molecular material, together with the above-described polymer material, forms the red light-emitting layers 14CR, the green light-emitting layers 14CG, and the blue light-emitting layers 14CB.

The low-molecular material of the ink composition 22 means a low-molecular material with a substantially single molecular weight other than a compound made up of molecules of a polymer or a condensation product having a high molecular weight which is produced through successively repeating the same or similar reaction by a low-molecular compound. Moreover, in the low-molecular material, a new chemical bond between molecules is not formed by heating, and the low-molecular material exits in a single molecular state.

The weight-average molecular weight (Mw) of such a low-molecular material is preferably 50000 or less, and is more preferably 15000 or less, because, compared to a material with a large molecular weight of, for example, larger than 50000, a material with a small molecular weight to some extent has various properties; therefore, conditions such as solubility in a solvent and viscosity of an ink are easily adjusted.

Further, a ratio between the polymer material and the low-molecular material is preferably within a range of about 10:1 to 1:2 both inclusive in weight ratio, and is more preferably within a range of about 2:1 to 1:2 both inclusive in weight ratio. When the ratio between the polymer material and the low-molecular material is less than about 10:1, in weight ratio, an effect caused by the low-molecular material is less likely to be exerted. Meanwhile, when the ratio between the polymer material and the low-molecular material is larger than about 1:2, it may be difficult to form a film.

As the low-molecular material, for example, benzene, styrylamine, triphenylamine, porphyrin, triphenylene, azatriphenylene, tetracyanoquinodimethane, triazole, imidazole, carbazole, oxadiazole, polyarylalkane, phenylenediamine, arylamine, oxazole, anthracene, fluorenone, hydrazone, stilbene, or a derivative thereof, or a heterocyclic conjugated system monomer or oligomer such as a polysilane-based compound, a vinylcarbazole-based compound, a thiophene-based compound, or an aniline-based compound may be used.

Specific examples of the above-described low-molecular material include α-naphthylphenylphenylenediamine, porphyrin, metal tetraphenylporphyrin, metal naphthalocyanine, hexacyanoazatriphenylene, 7,7,8,8-tetracyanoquinodimethane (TCNQ), 7,7,8,8-tetracyano-2,3,5,6-tetrafluoroquinodimethane (F4-TCNQ), tetracyano-4,4,4-tris(3-methylphenylphenylamino)triphenyamine, N,N,N′,N′,-tetrakis(p-tolyl)p-phenylenediamine, N,N,N′,N′,-tetraphenyl-4,4′-diaminobiphenyl, N-phenylcarbazole, 4-di-p-tolylaminostilbene, poly(paraphenylenevinylene), poly(thiophenevinylene), and poly(2,2′-thienylpyrrol). However, the low-molecular material is not limited thereto.

Any of low-molecular materials represented by the following expressions (1) to (3) is more preferably used.

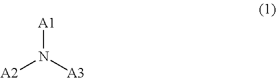

where A1 to A3 each are an aromatic hydrocarbon group, a heterocyclic group, or a derivative thereof.

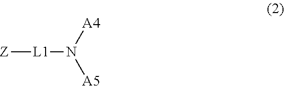

where compounds included in Expression (1) are excluded, Z1 is a nitrogen-containing hydrocarbon group or a derivative thereof, L1 is a group formed by bonding 1 to 4 divalent aromatic ring groups to one another, specifically, L1 is a divalent group formed by linking 2 to 4 aromatic rings to one another or a derivative thereof, A4 and A5 each are an aromatic hydrocarbon group or a derivative thereof, and A4 and A5 may be bonded to each other to form a ring structure.

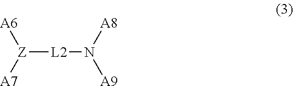

where compounds included in Expressions (1) and (2) are excluded, Z2 is a nitrogen-containing hydrocarbon group or a derivative thereof, L2 is a group formed by bonding 2 to 6 divalent aromatic ring groups to one another, specifically, L2 is a divalent group formed by linking 2 to 6 aromatic rings to one another or a derivative thereof, A6 to A9 each are a group by bonding 1 to 10 aromatic hydrocarbon groups, heterocyclic groups, or derivatives thereof to one another.

Specific examples of the compound represented by Expression (1) include compounds represented by the following Expressions (1-1) to (1-48).

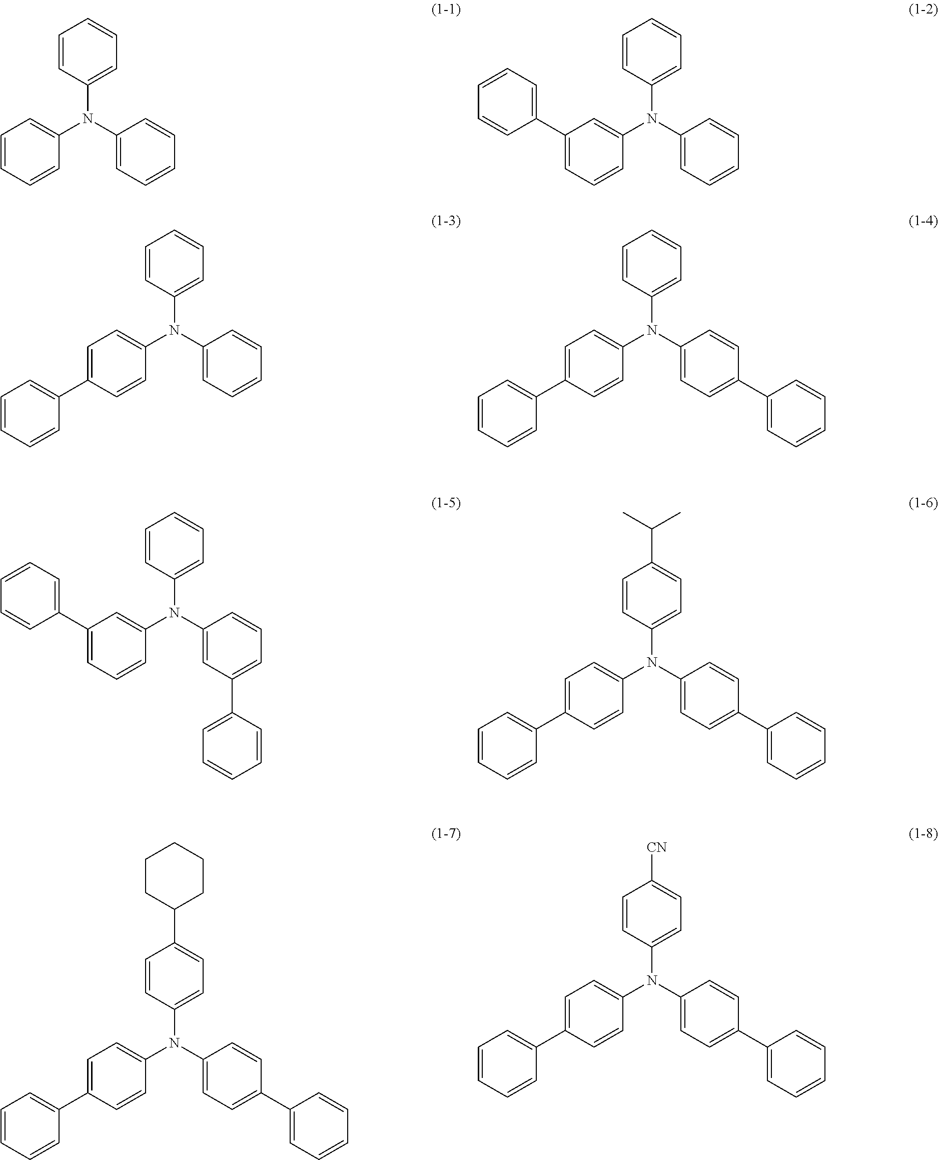

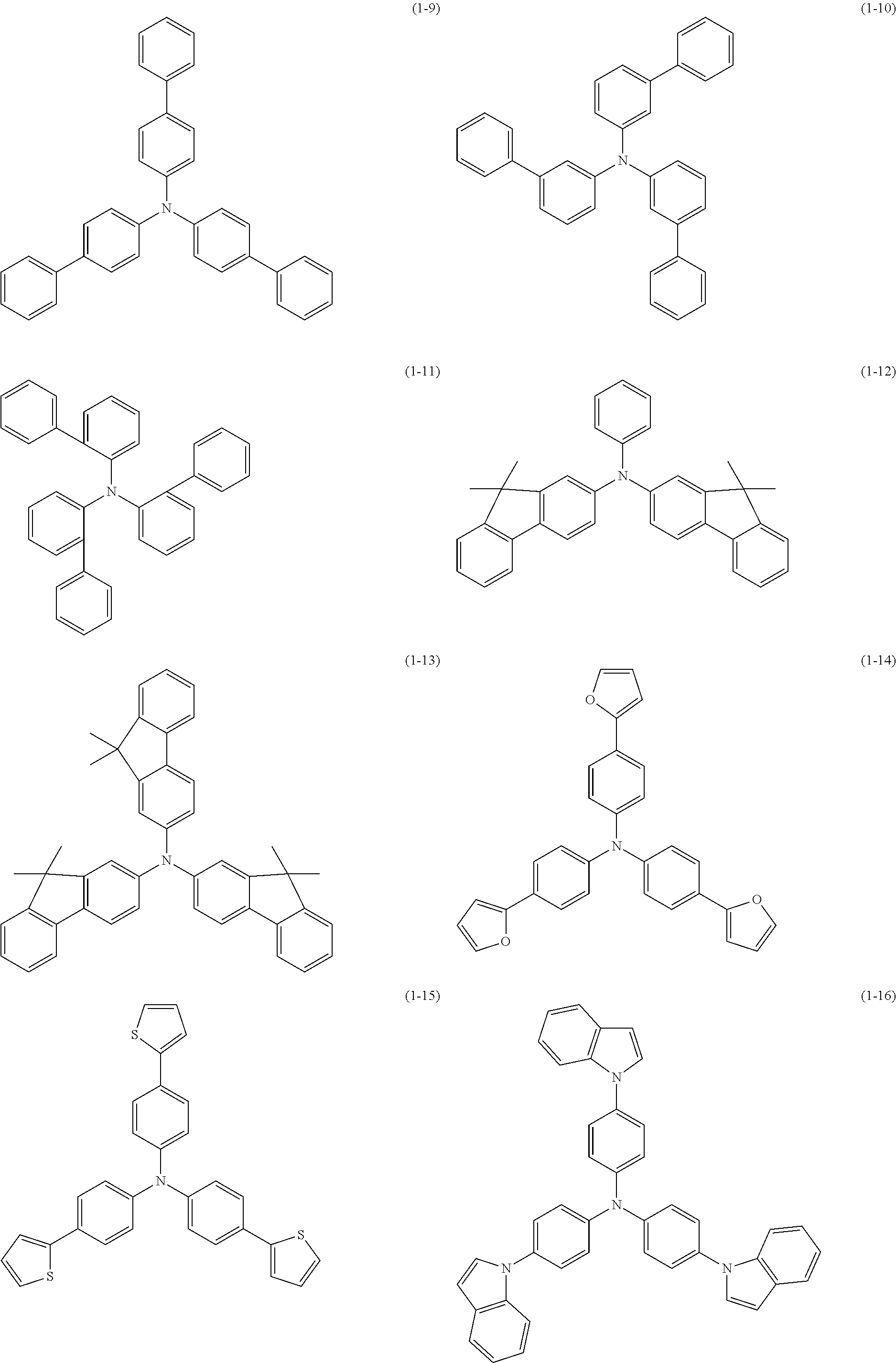

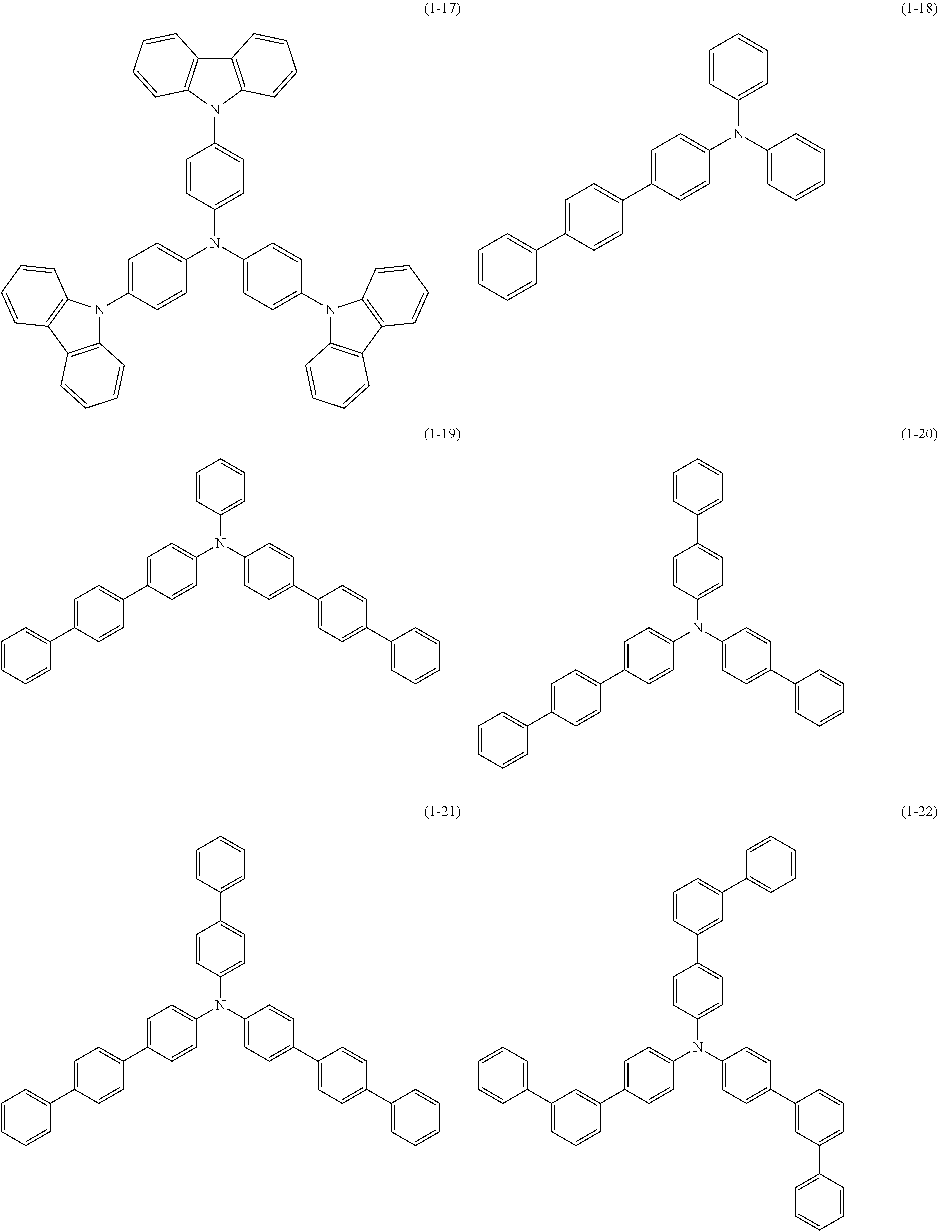 [SMILES: c1ccc2c(c1)c1ccccc1n2-c1ccc(N(c2ccc(-n3c4ccccc4c4ccccc43)cc2)c2ccc(-n3c4ccccc4c4ccccc43)cc2)cc1 ; c1ccc(-c2ccc(-c3ccc(N(c4ccccc4)c4ccccc4)cc3)cc2)cc1 ; c1ccc(-c2ccc(-c3ccc(N(c4ccccc4)c4ccc(-c5ccc(-c6ccccc6)cc5)cc4)cc3)cc2)cc1 ; c1ccc(-c2ccc(-c3ccc(N(c4ccc(-c5ccccc5)cc4)c4ccc(-c5ccccc5)cc4)cc3)cc2)cc1 ; c1ccc(-c2ccc(-c3ccc(N(c4ccc(-c5ccccc5)cc4)c4ccc(-c5ccc(-c6ccccc6)cc5)cc4)cc3)cc2)cc1 ; c1ccc(-c2cccc(-c3ccc(N(c4ccc(-c5cccc(-c6ccccc6)c5)cc4)c4ccc(-c5cccc(-c6ccccc6)c5)cc4)cc3)c2)cc1]

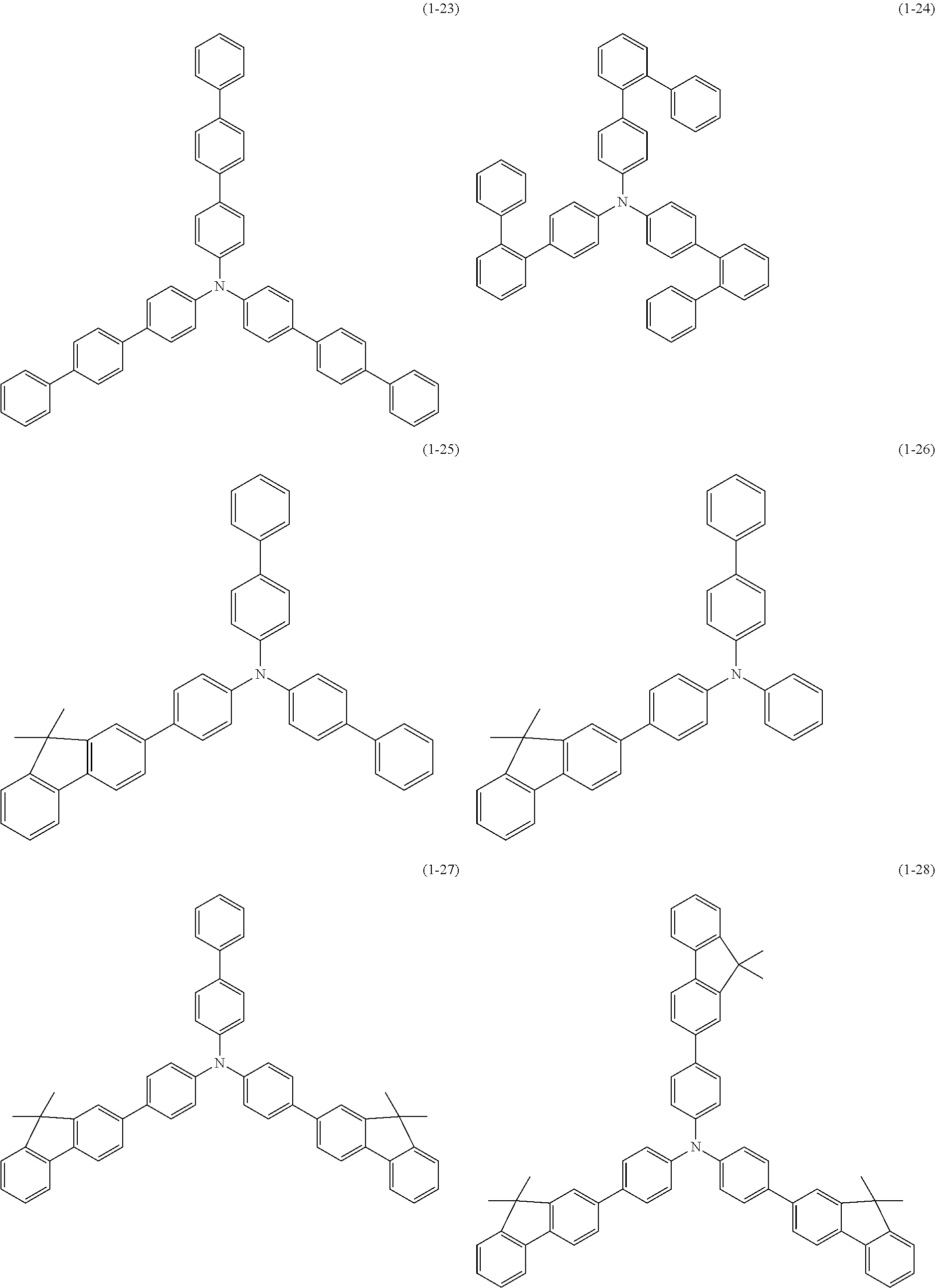

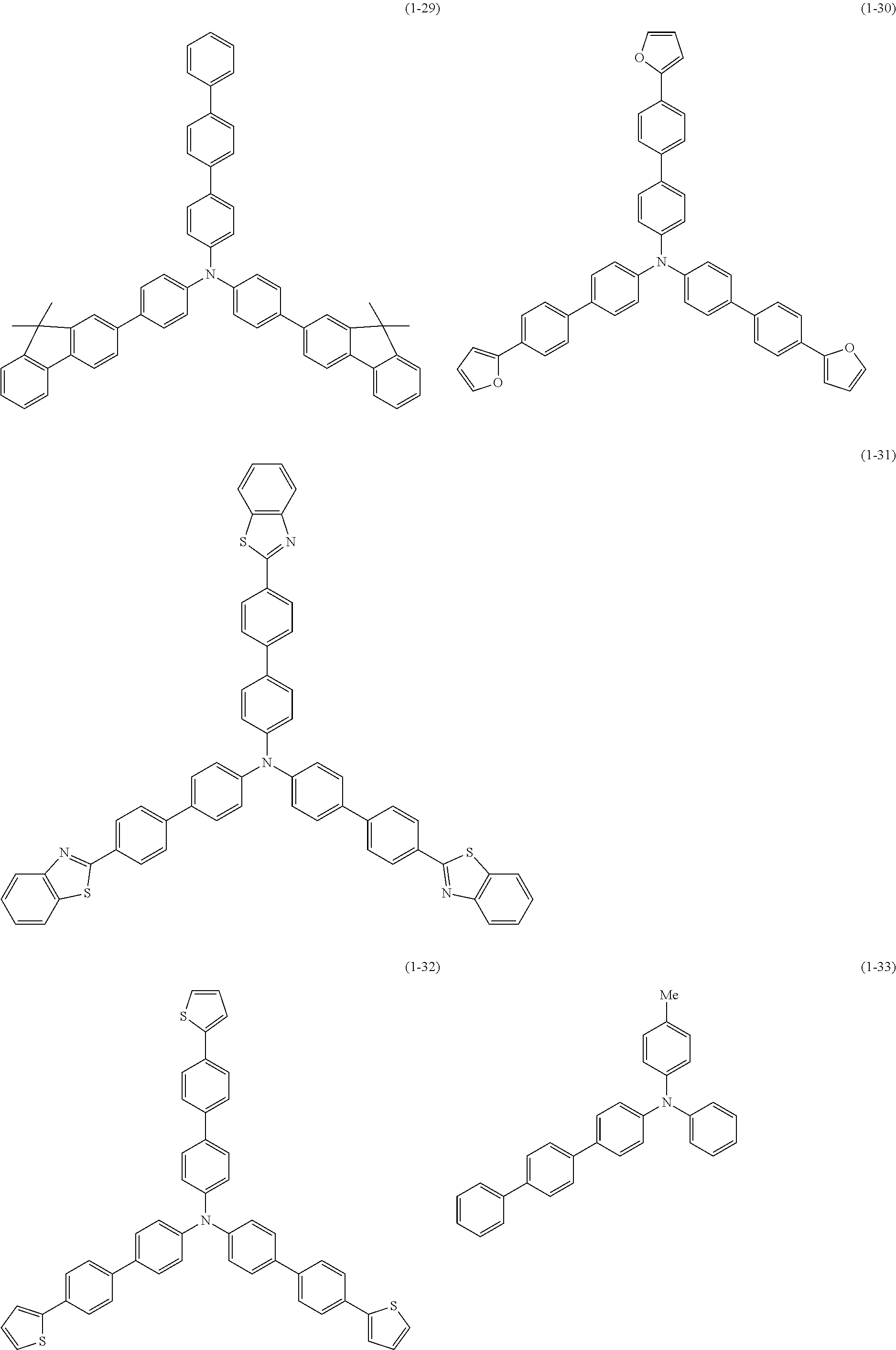

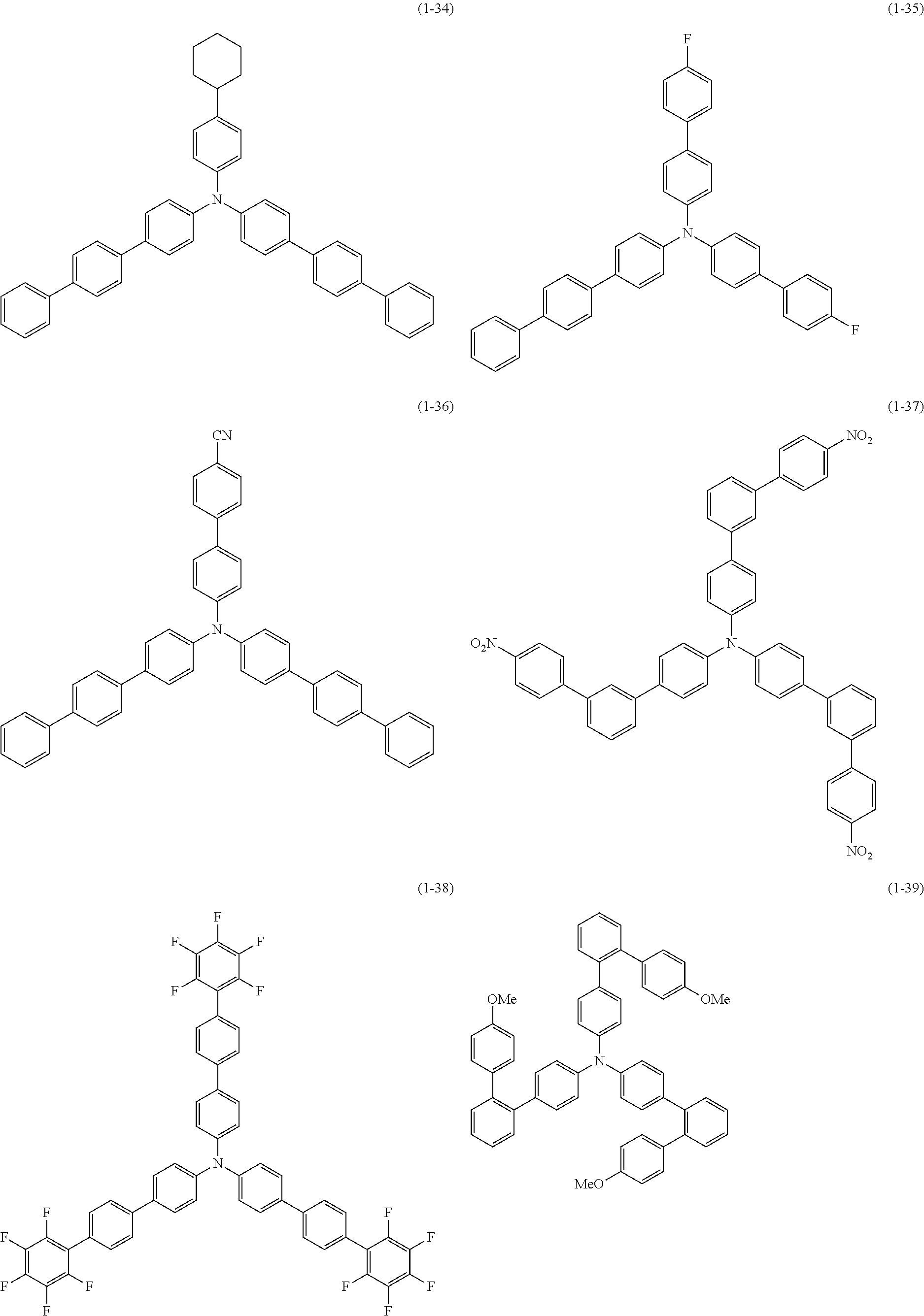

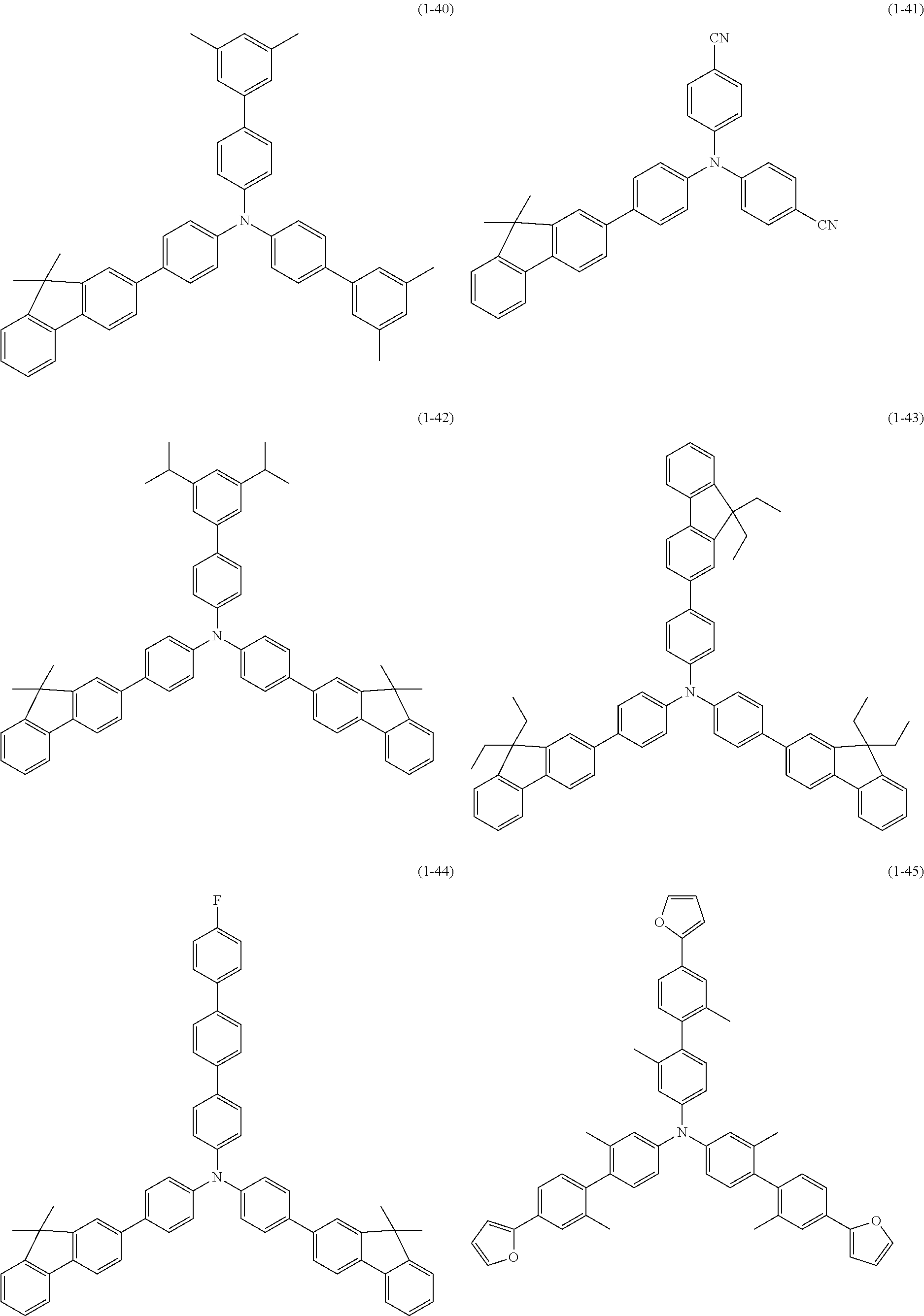

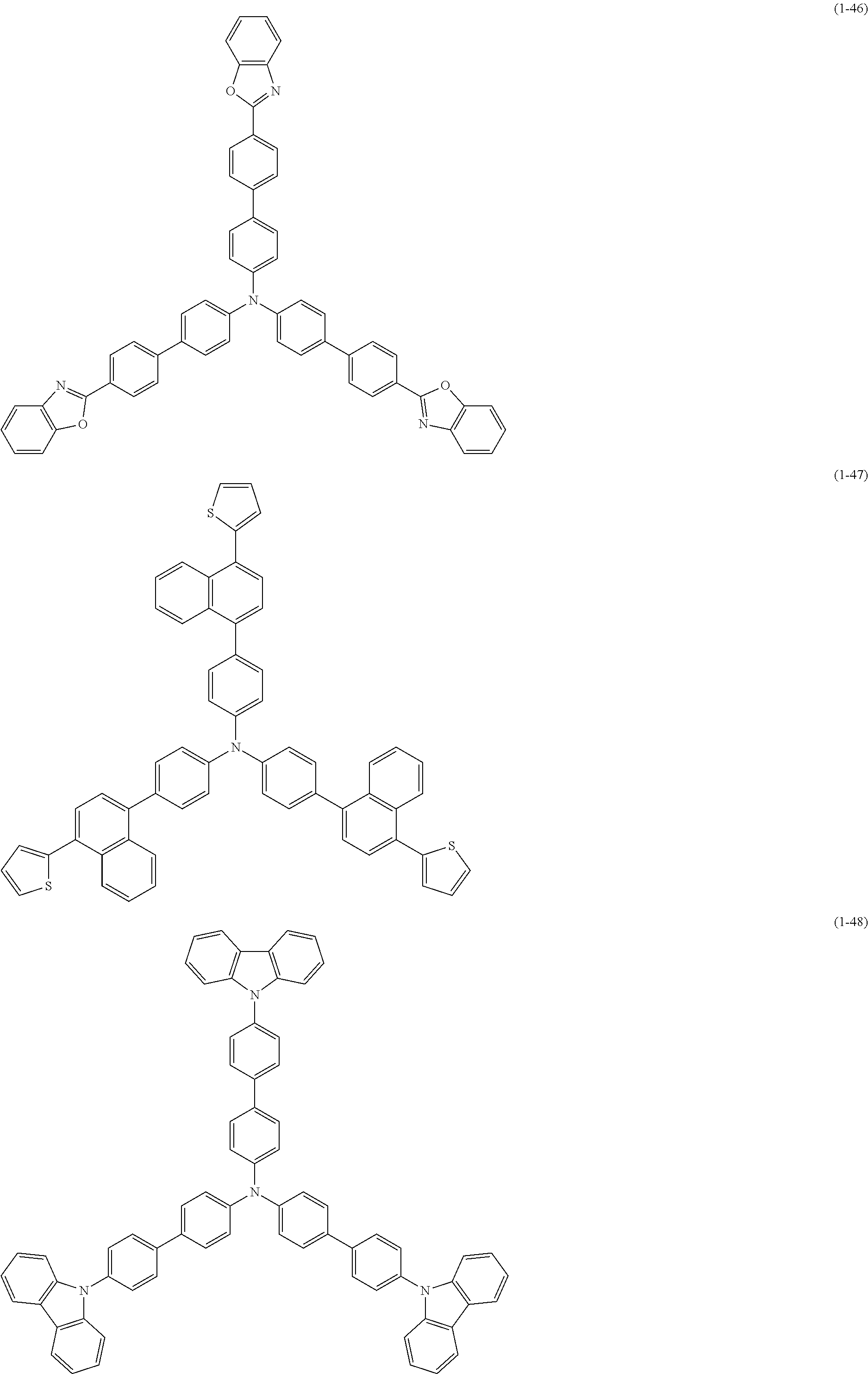 [SMILES: c1ccc2oc(-c3ccc(-c4ccc(N(c5ccc(-c6ccc(-c7nc8ccccc8o7)cc6)cc5)c5ccc(-c6ccc(-c7nc8ccccc8o7)cc6)cc5)cc4)cc3)nc2c1 ; c1csc(-c2ccc(-c3ccc(N(c4ccc(-c5ccc(-c6cccs6)c6ccccc56)cc4)c4ccc(-c5ccc(-c6cccs6)c6ccccc56)cc4)cc3)c3ccccc23)c1 ; c1ccc2c(c1)c1ccccc1n2-c1ccc(-c2ccc(N(c3ccc(-c4ccc(-n5c6ccccc6c6ccccc65)cc4)cc3)c3ccc(-c4ccc(-n5c6ccccc6c6ccccc65)cc4)cc3)cc2)cc1]

Specific examples of the compound represented by Expression (2) include compounds represented by the following Expression (2-1) to (2-163).

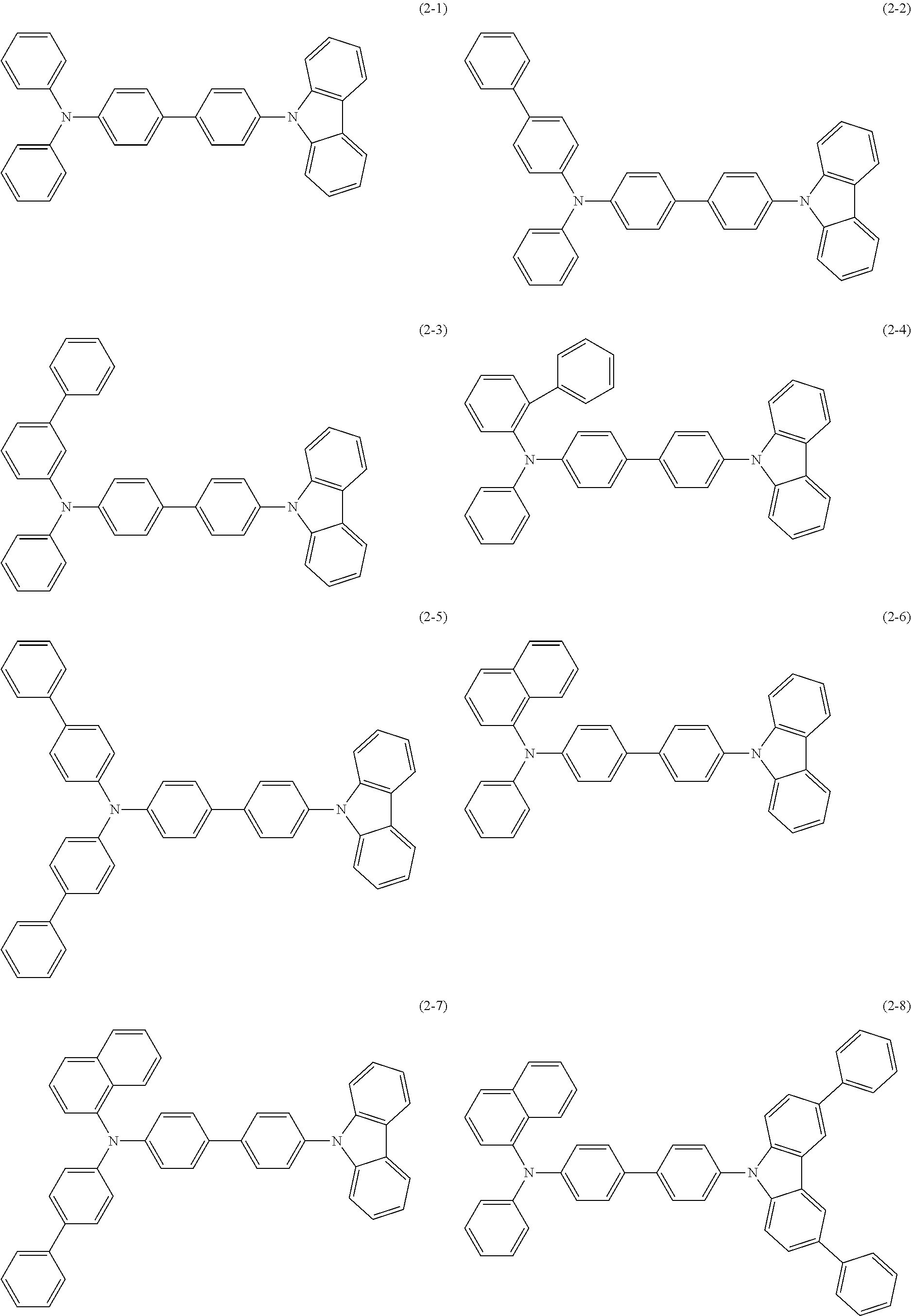

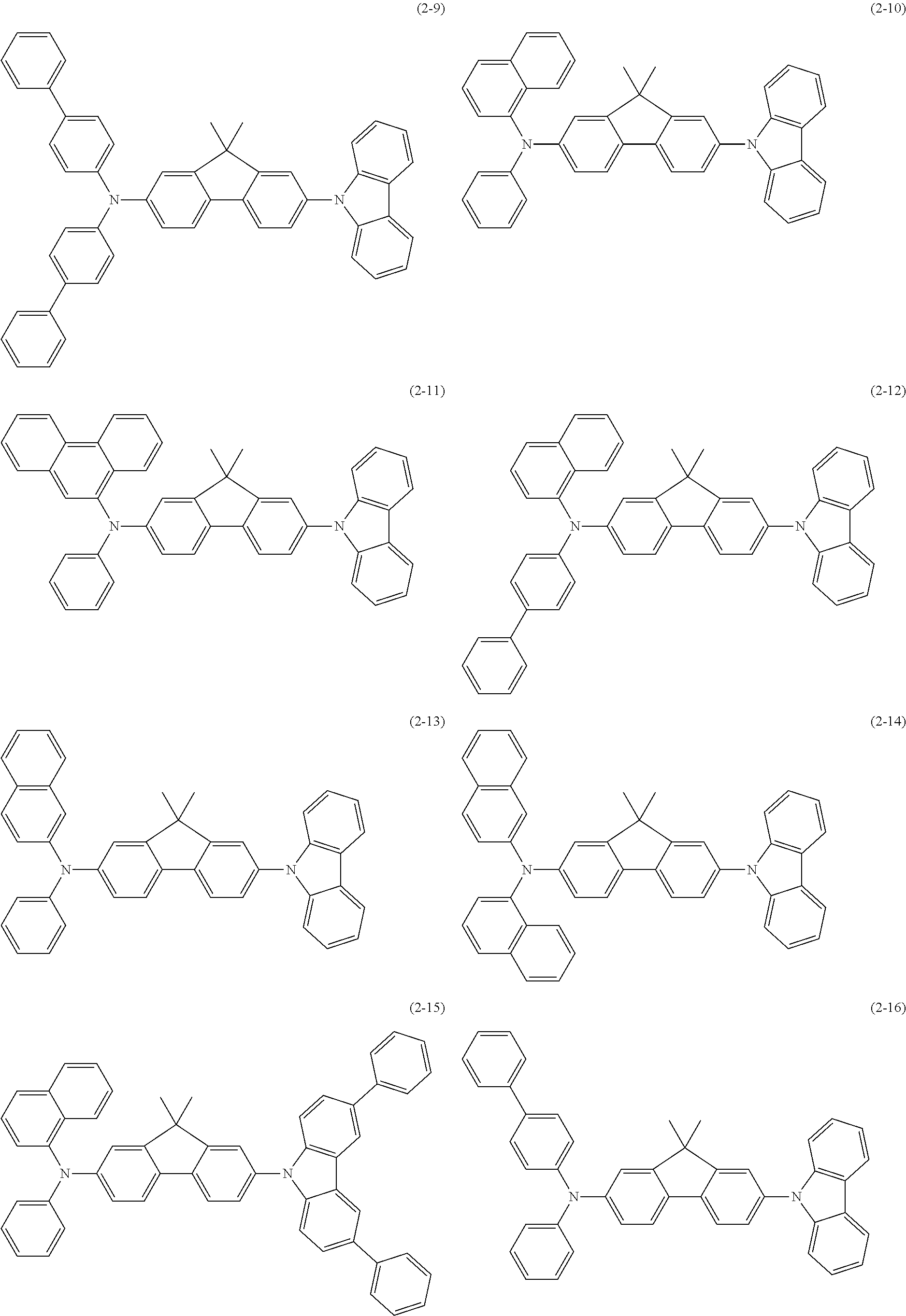

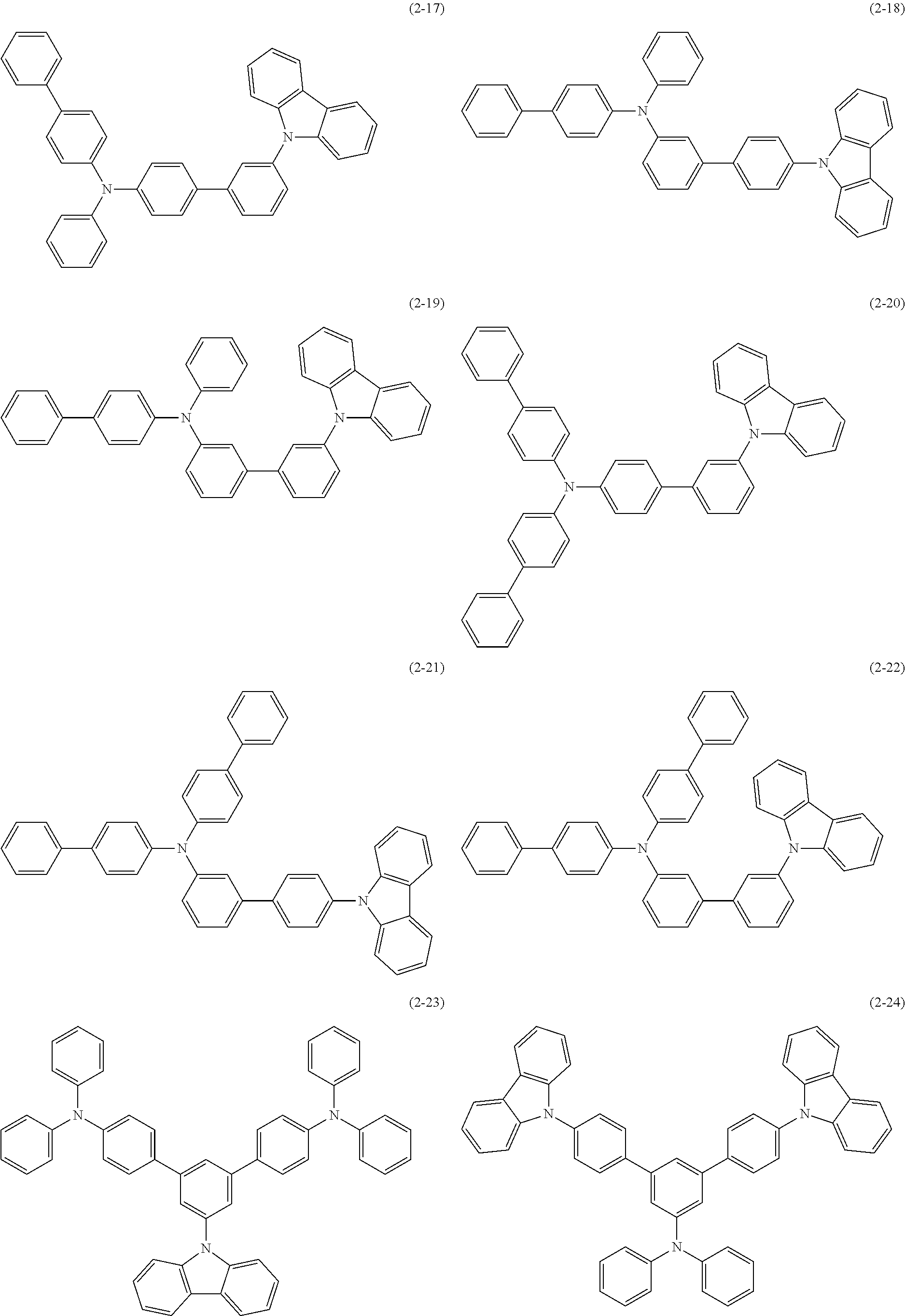

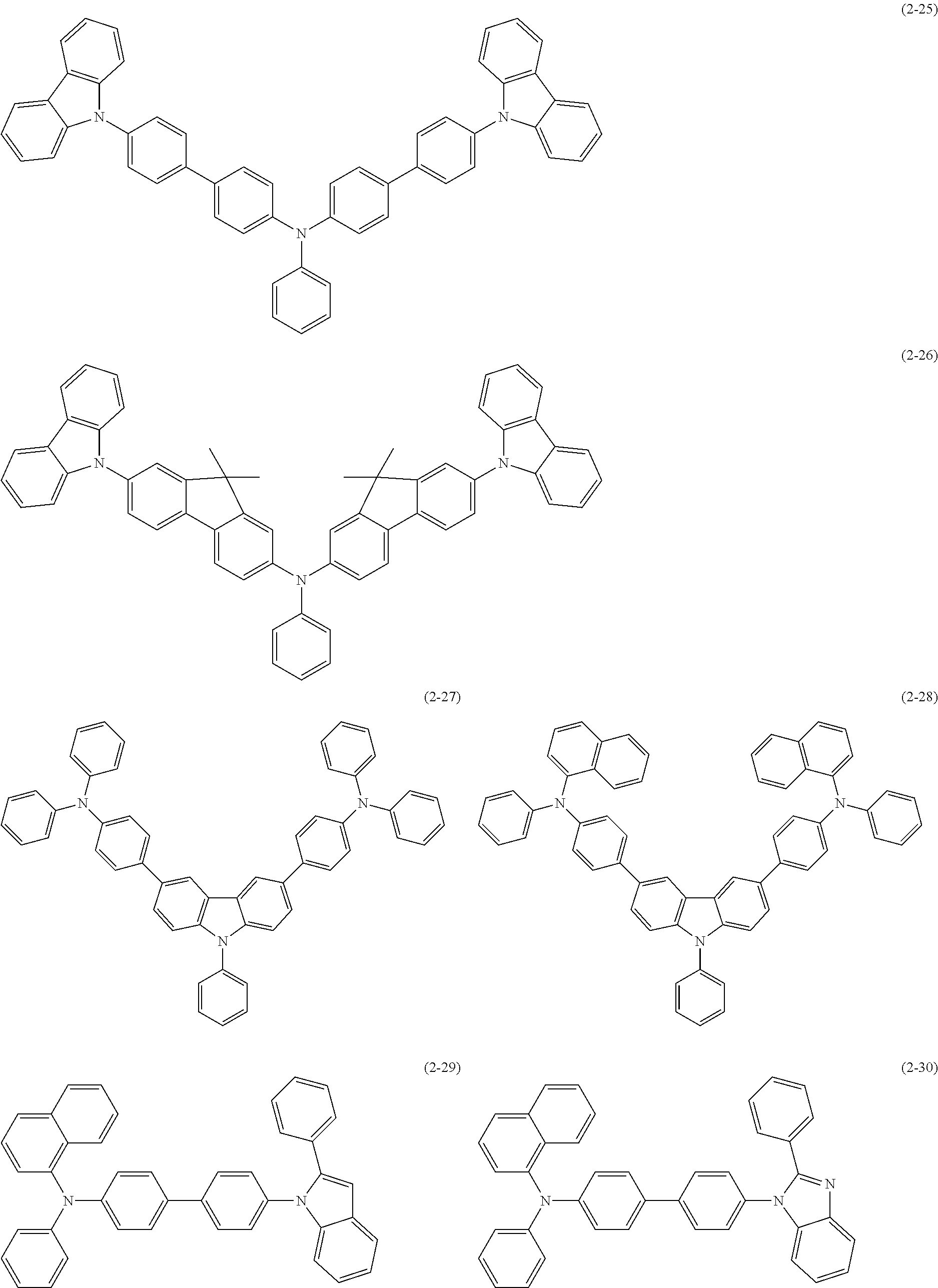

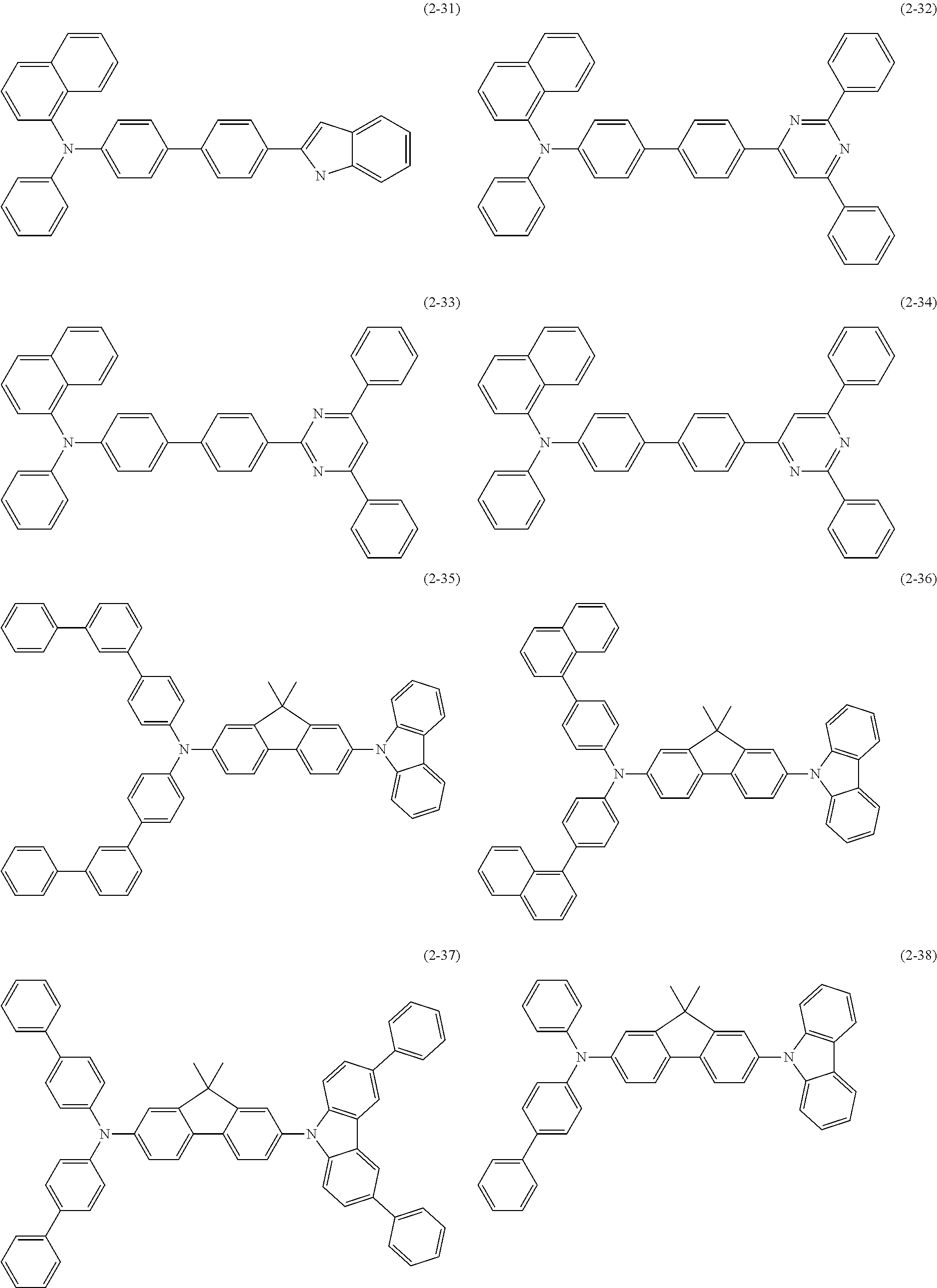

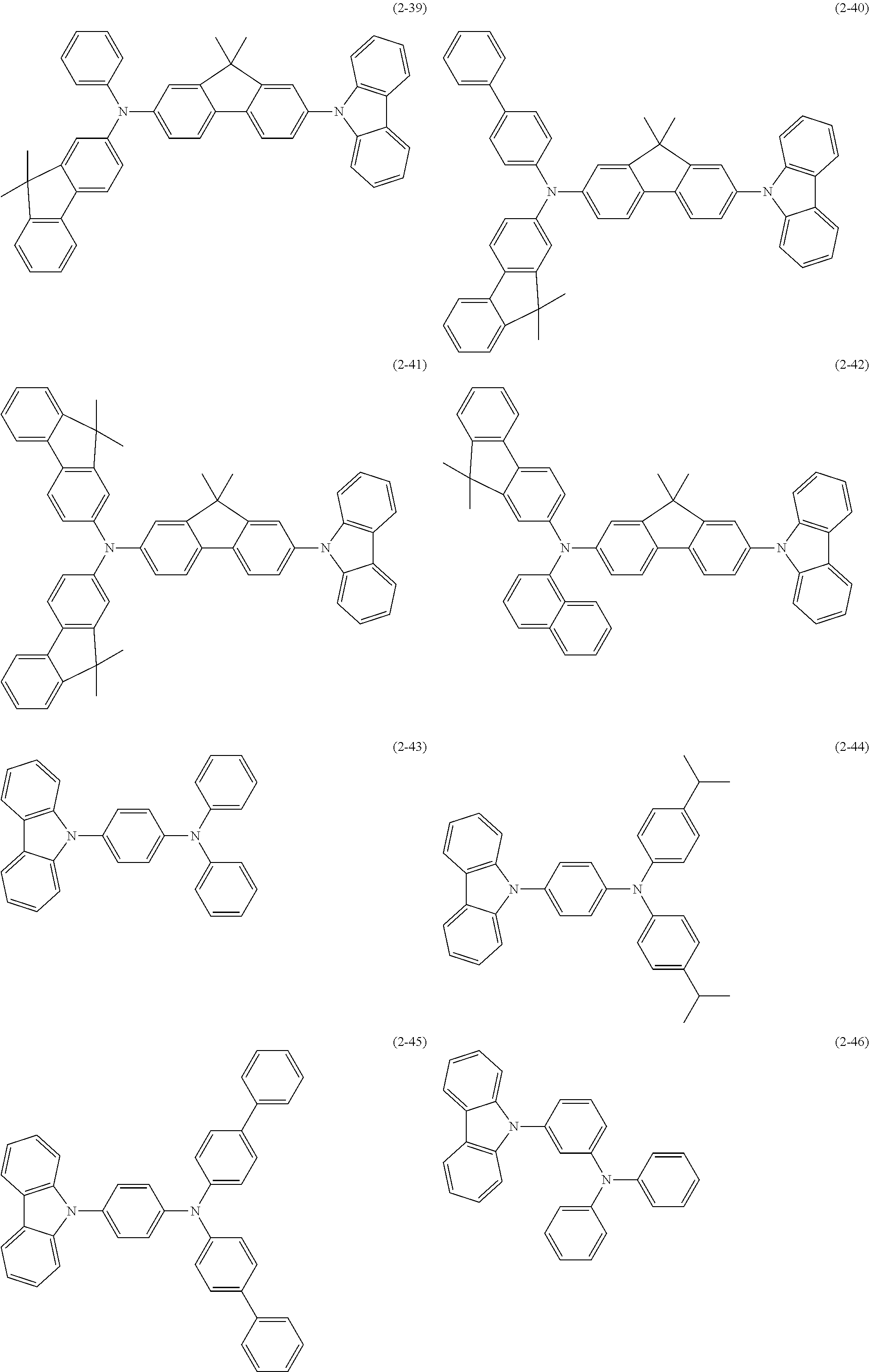

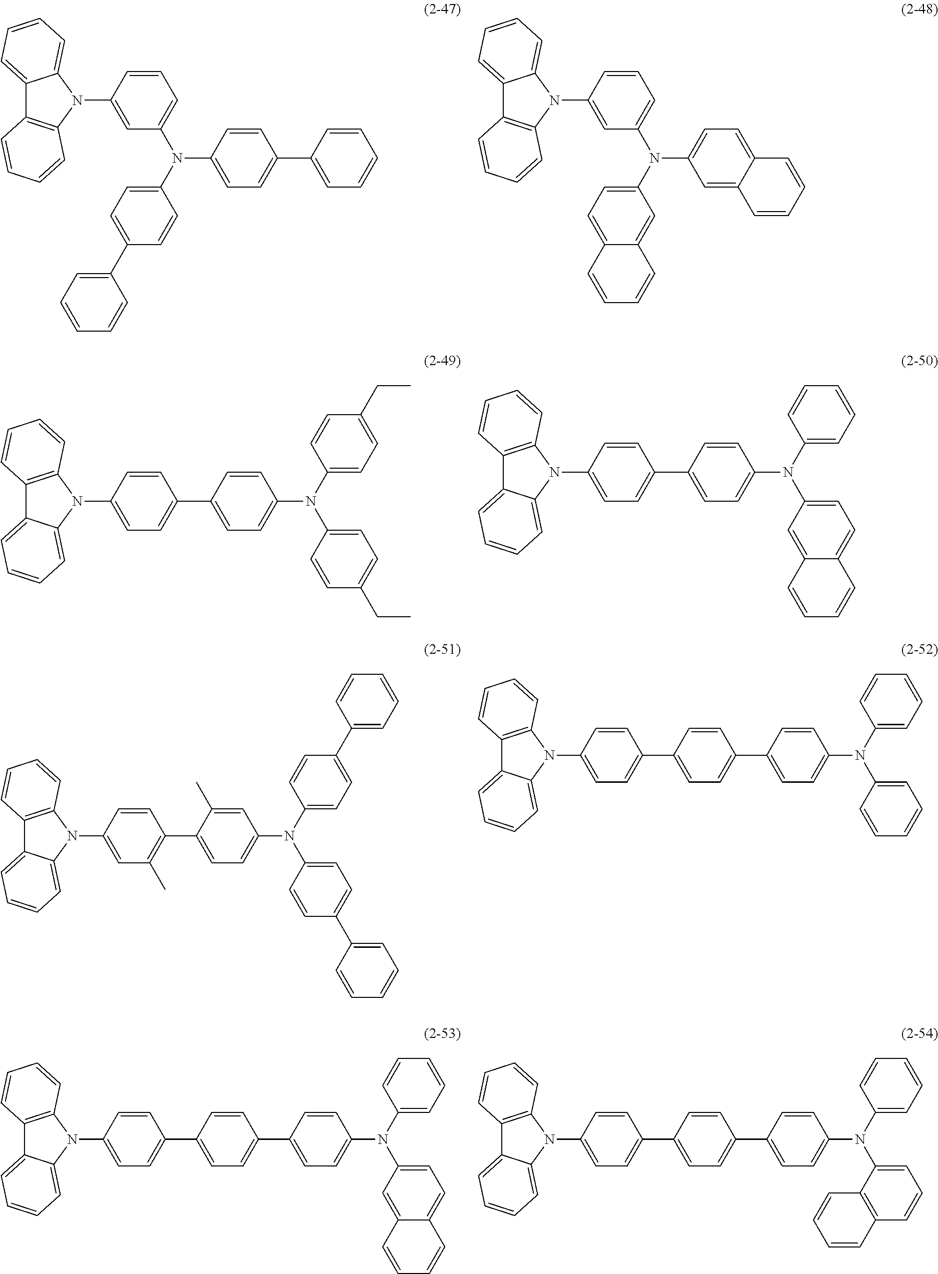

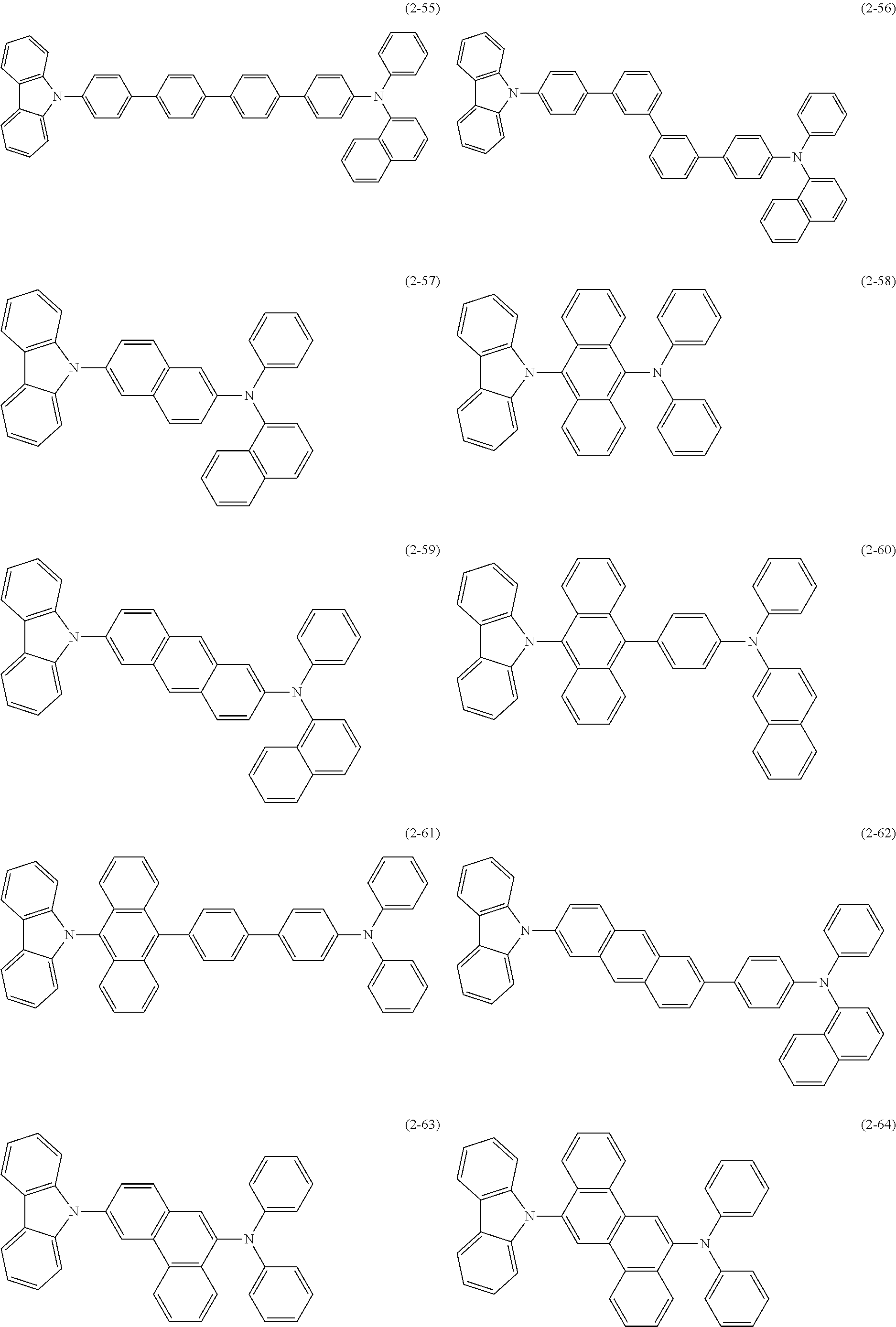

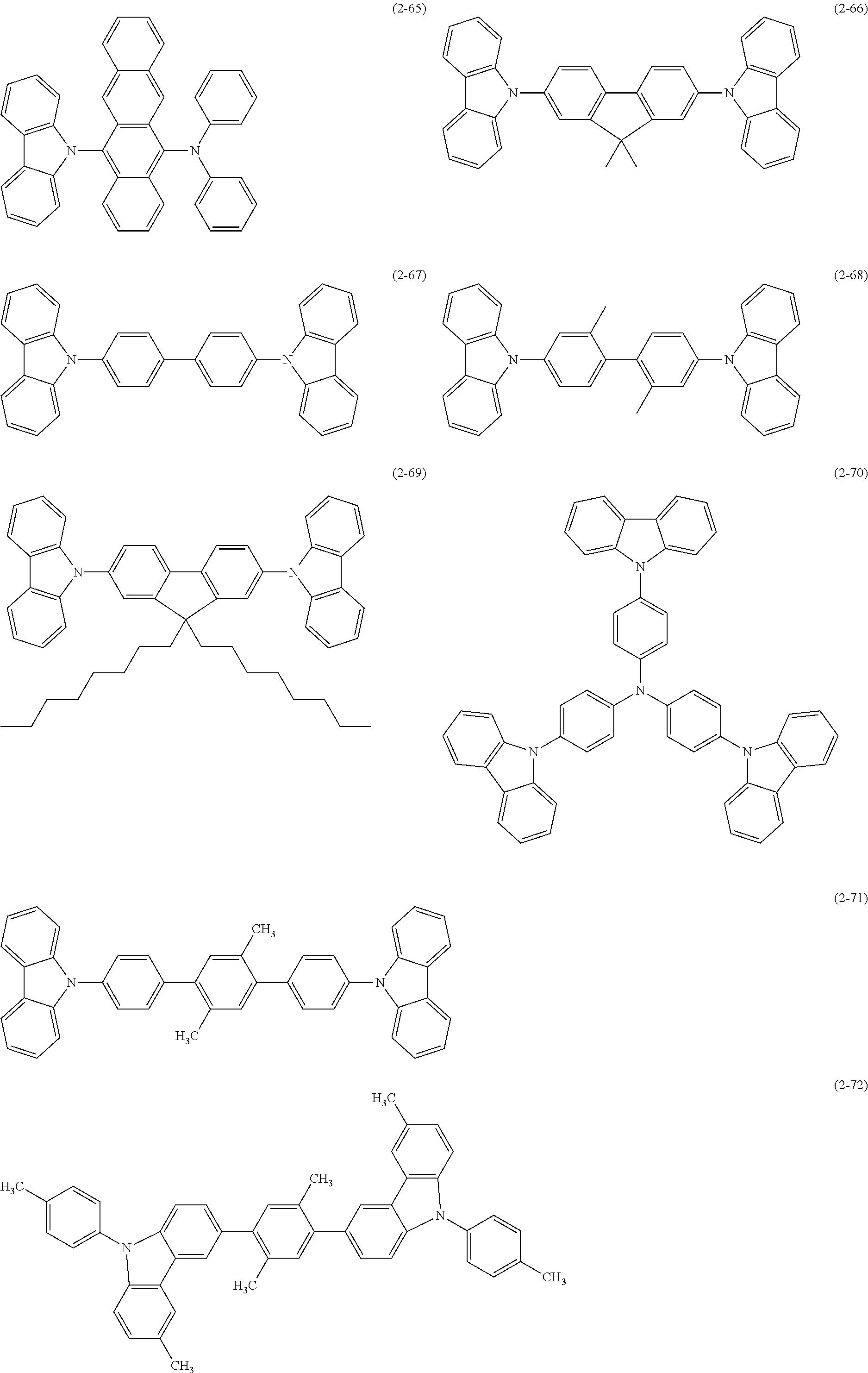

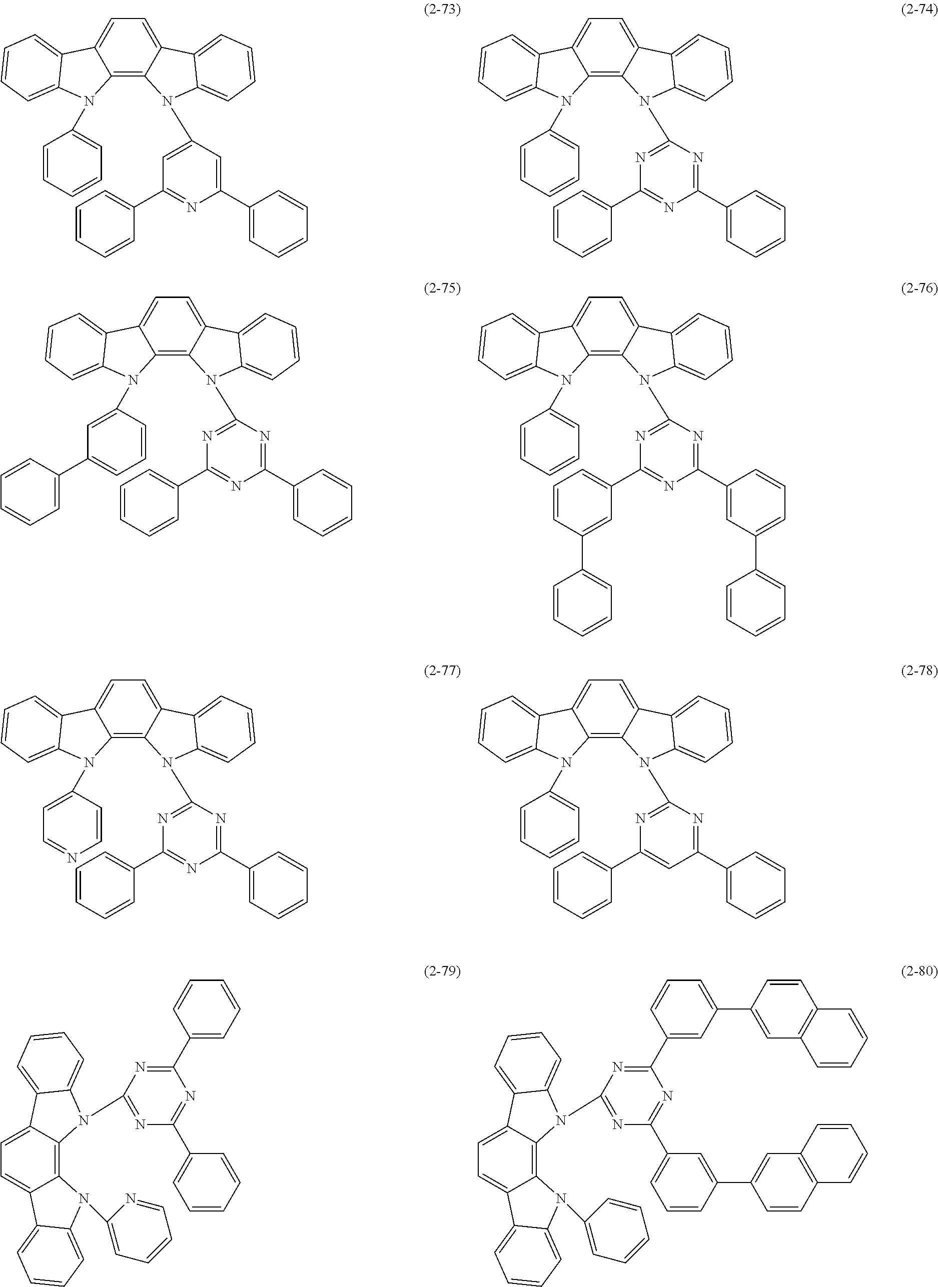

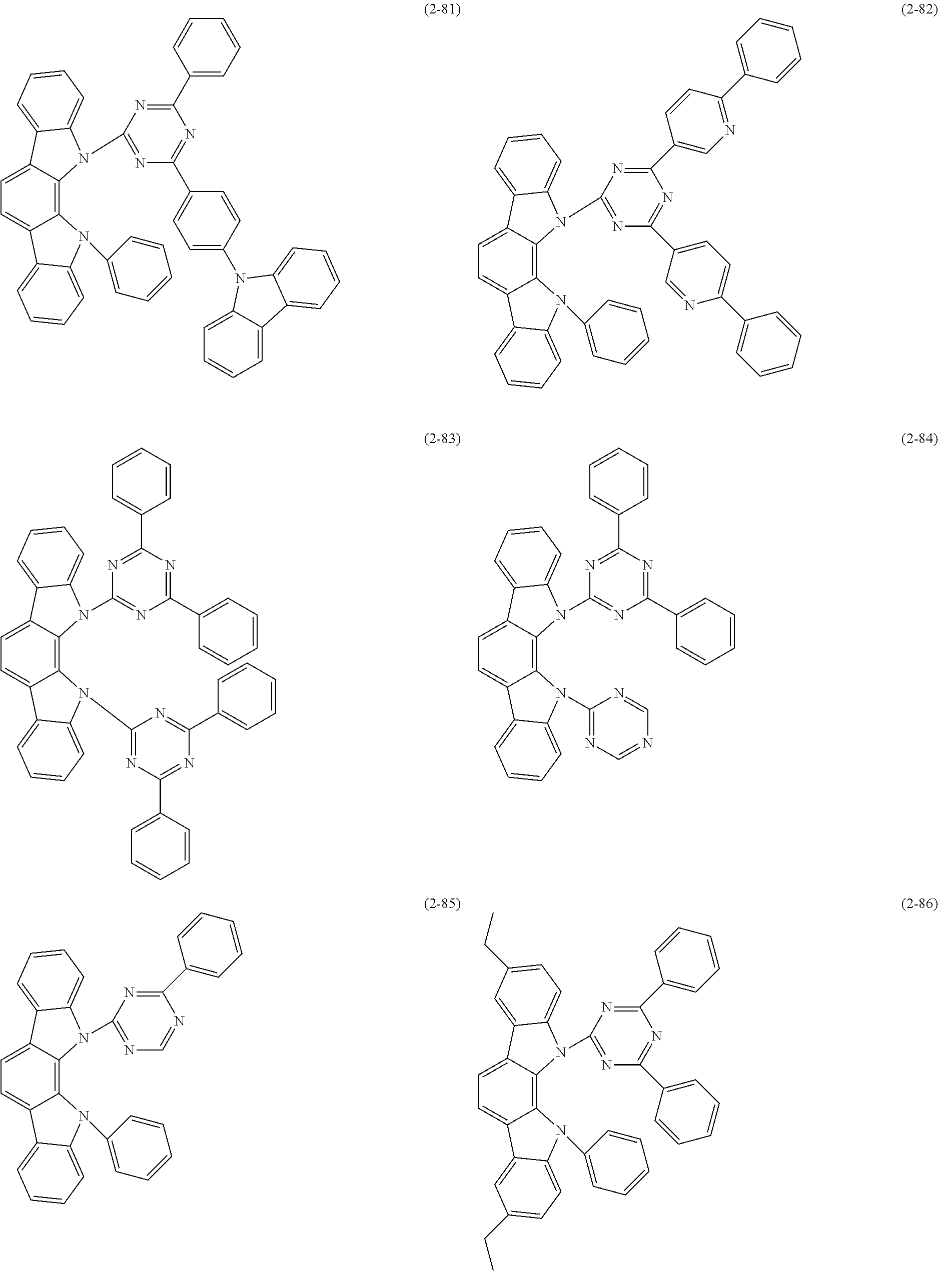

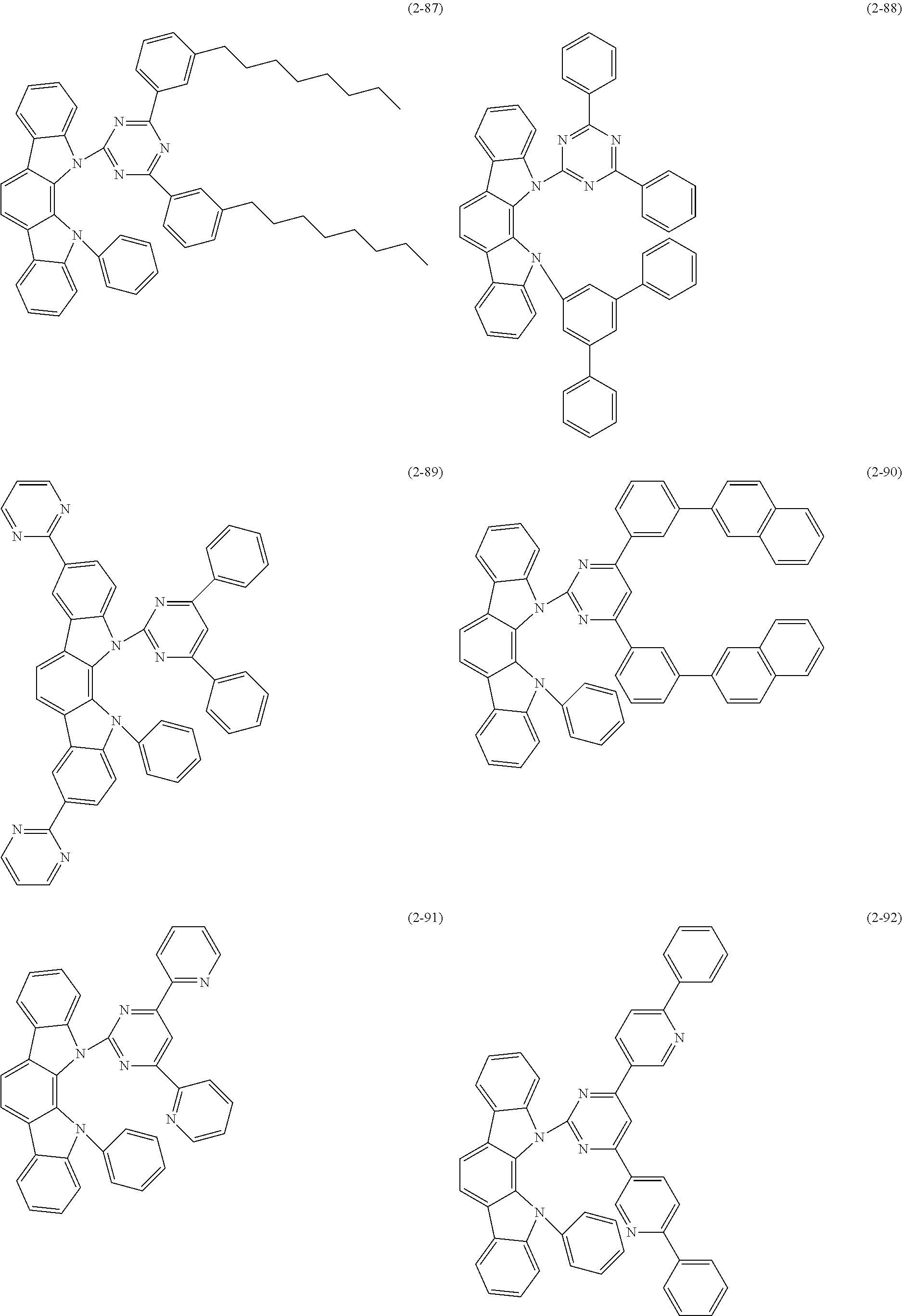

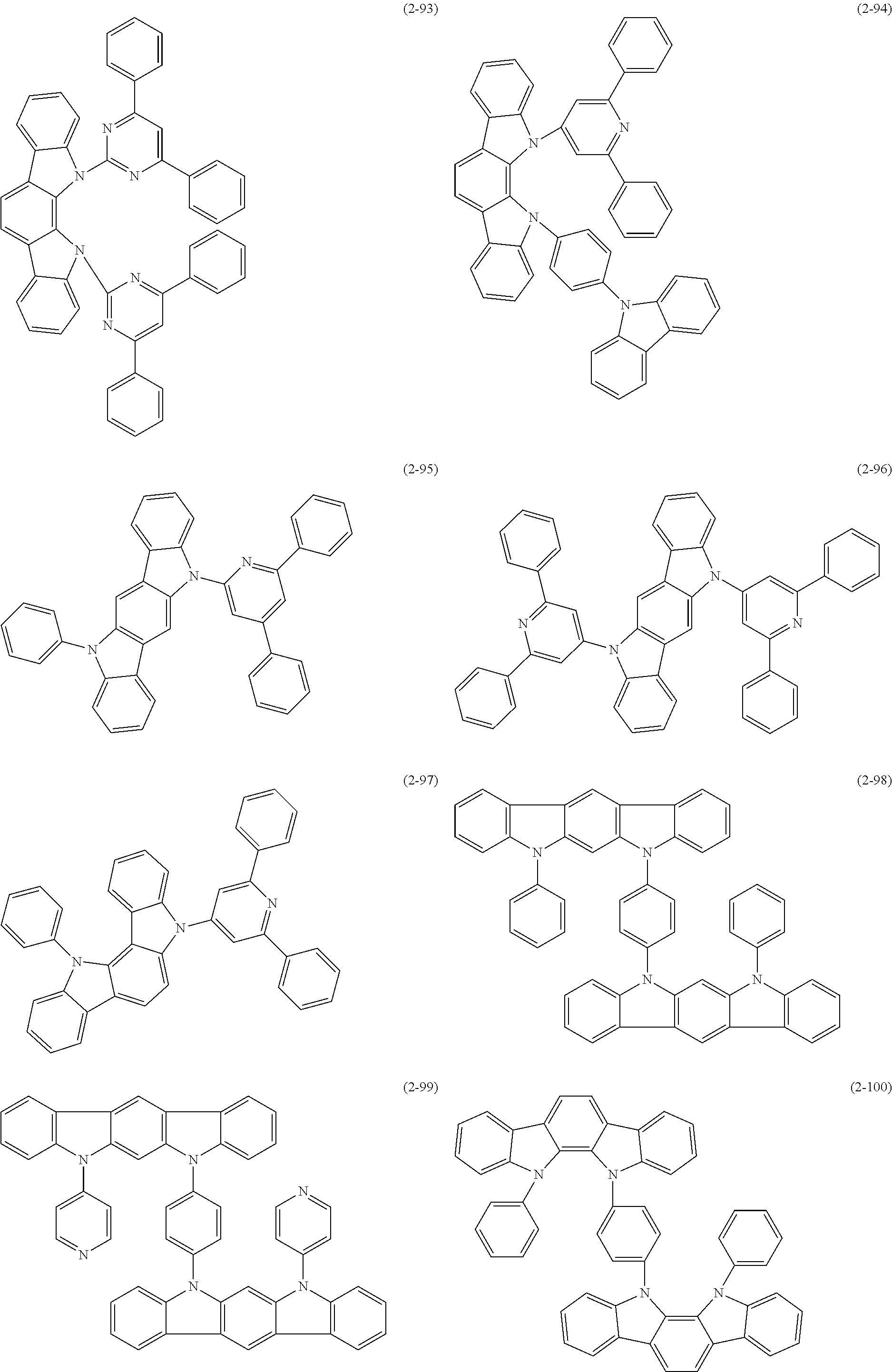

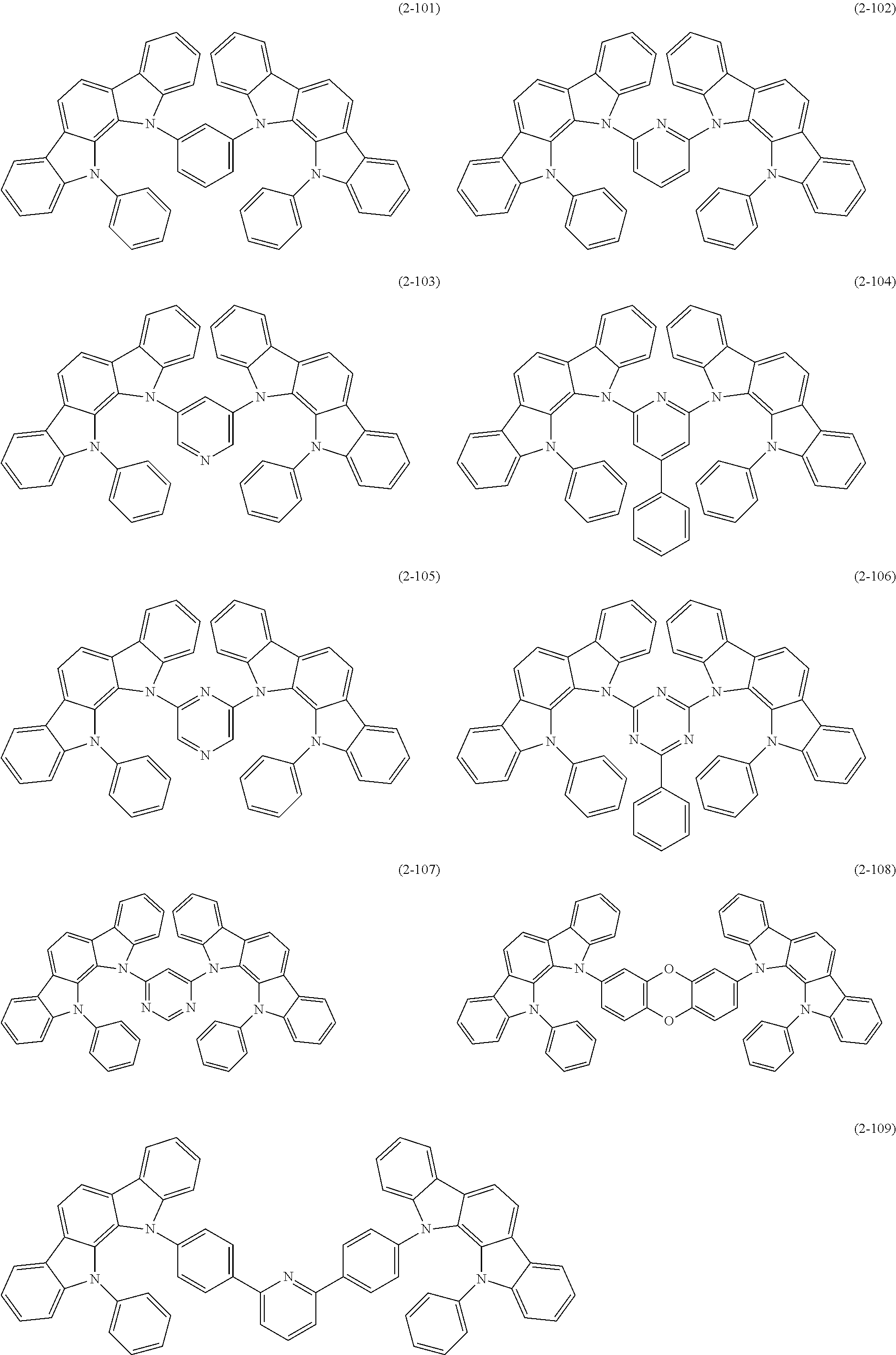

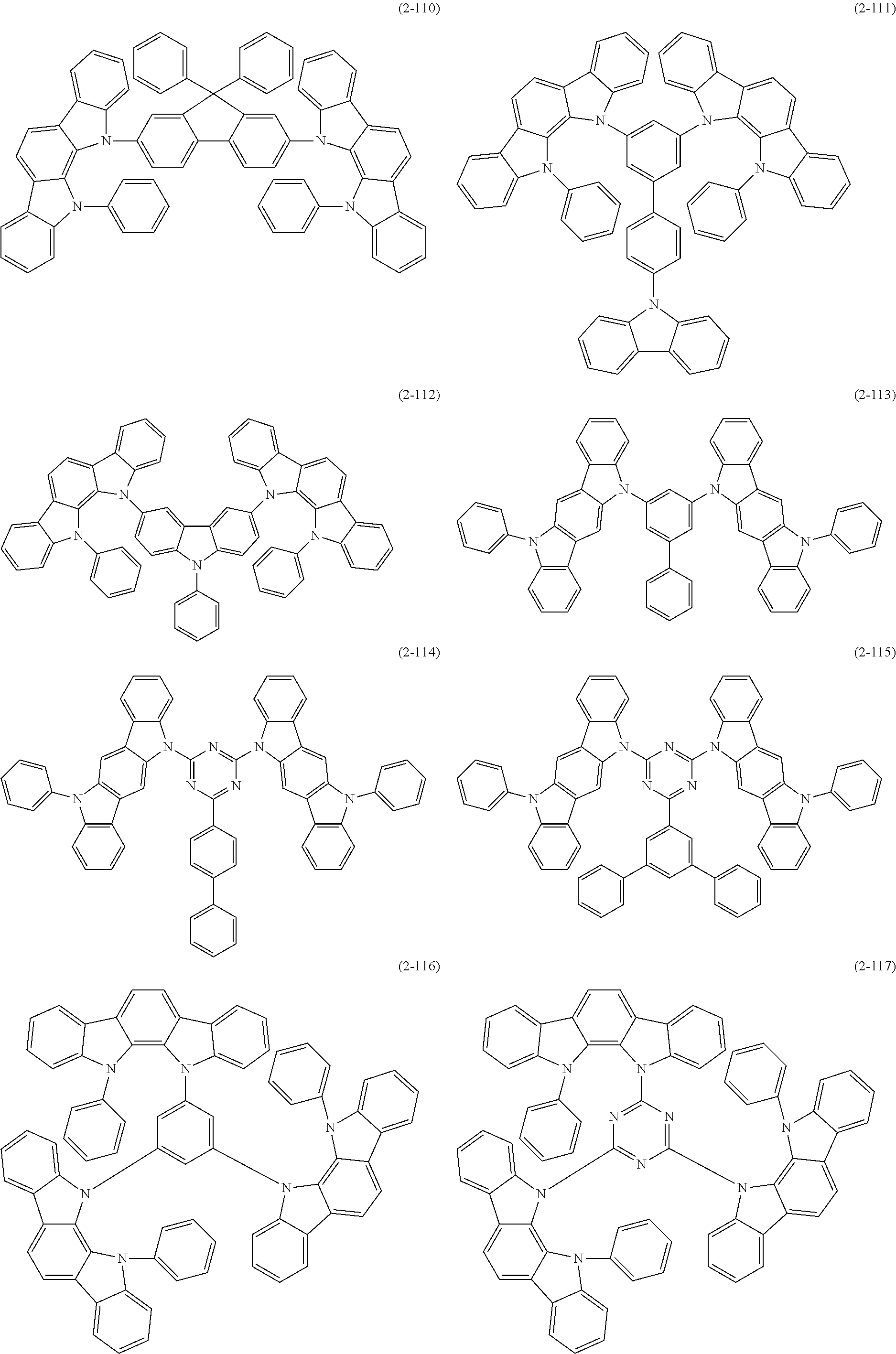

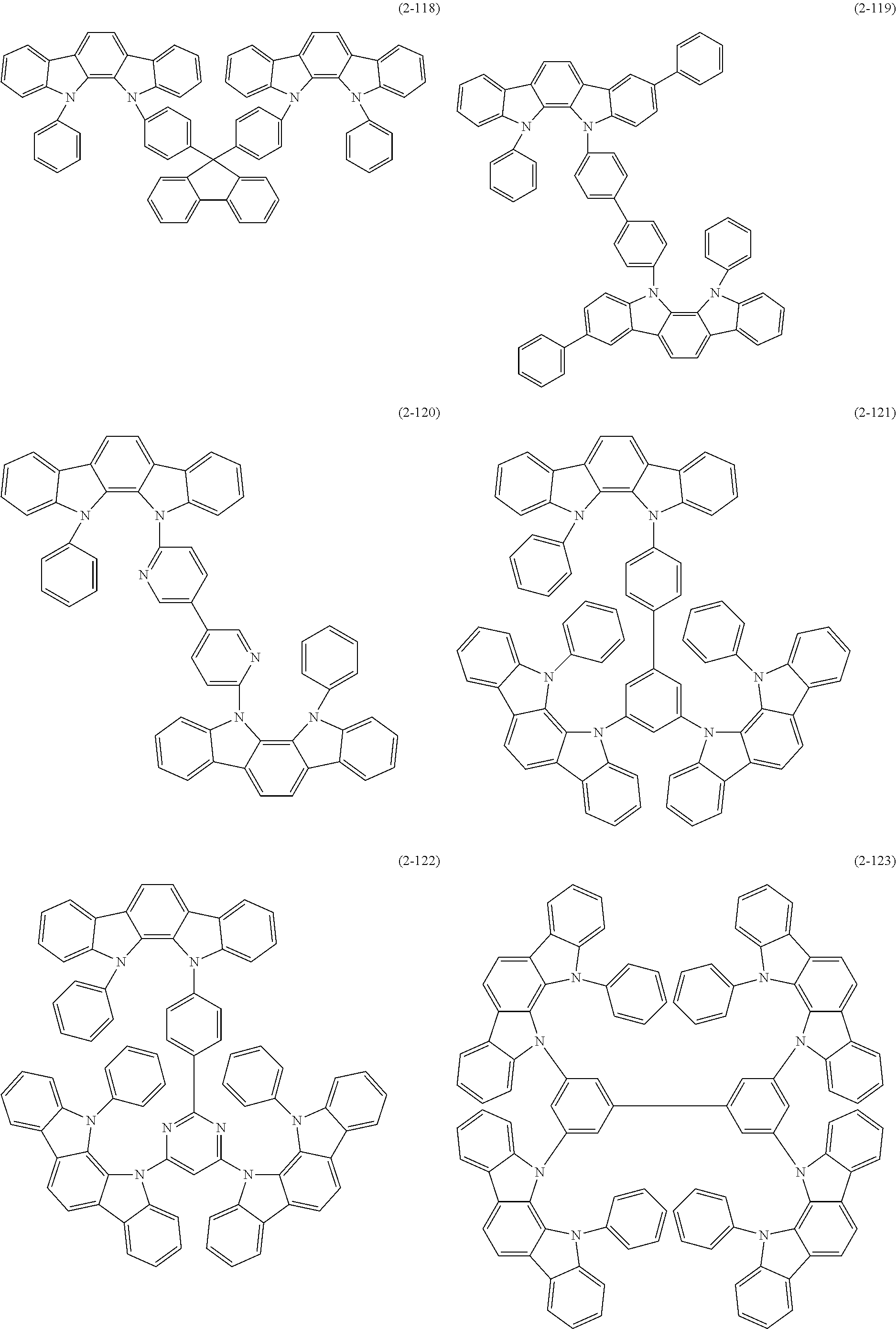

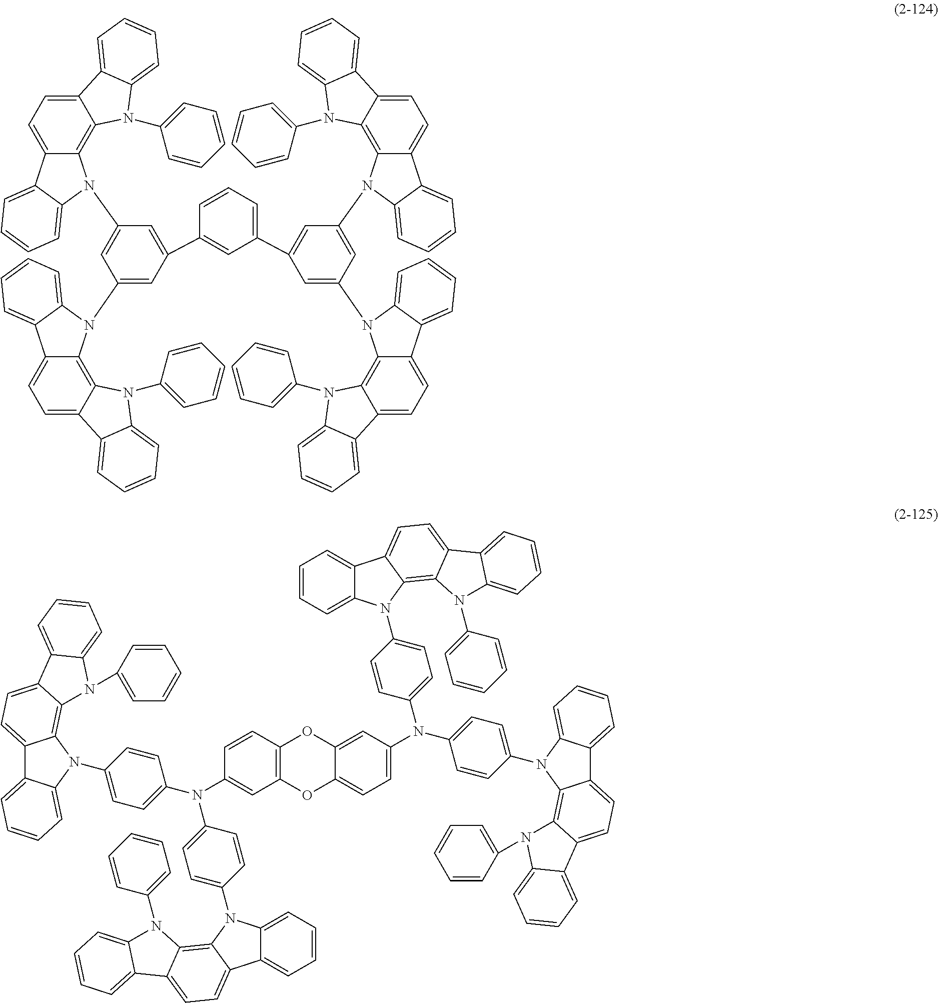

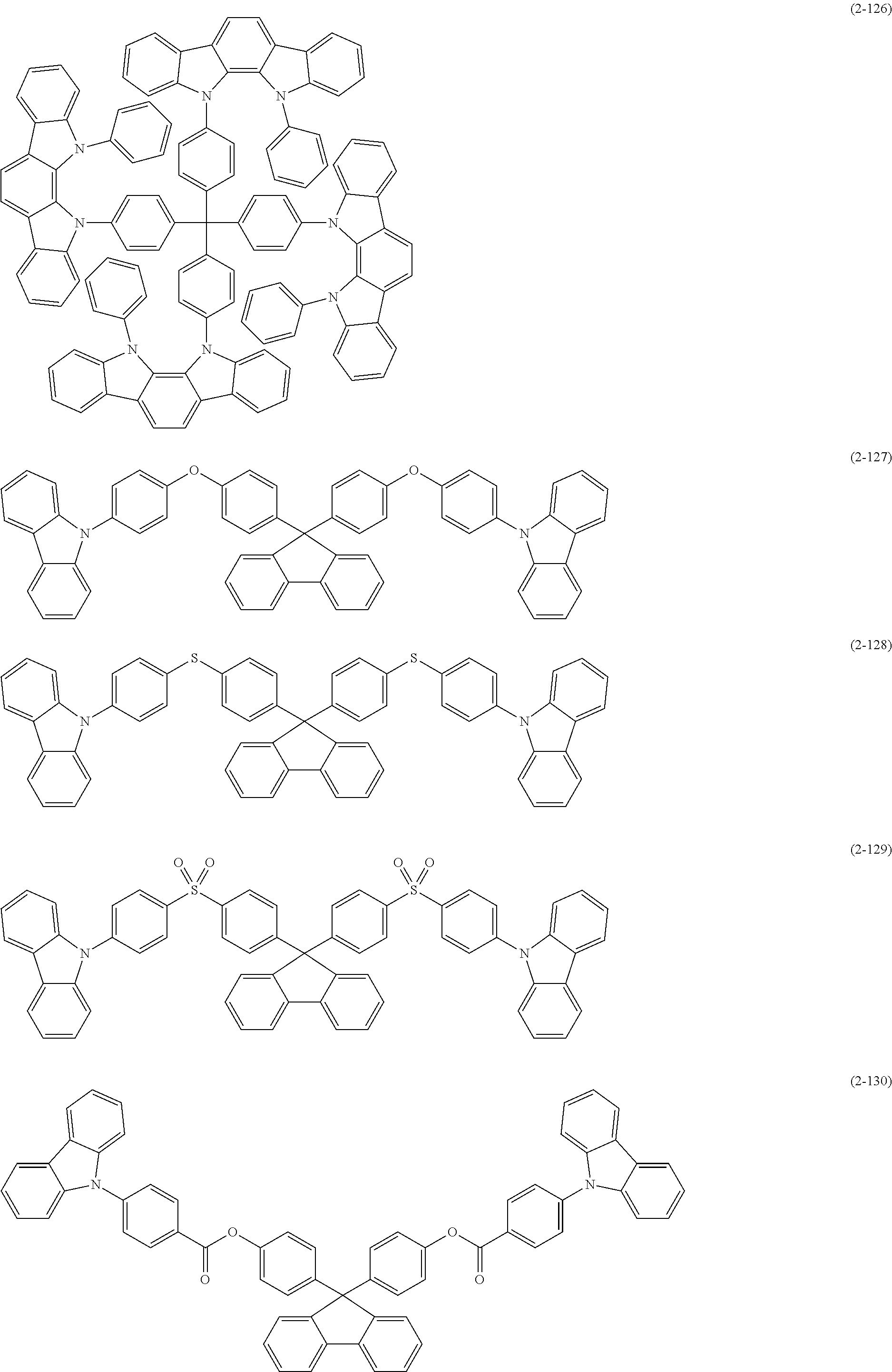

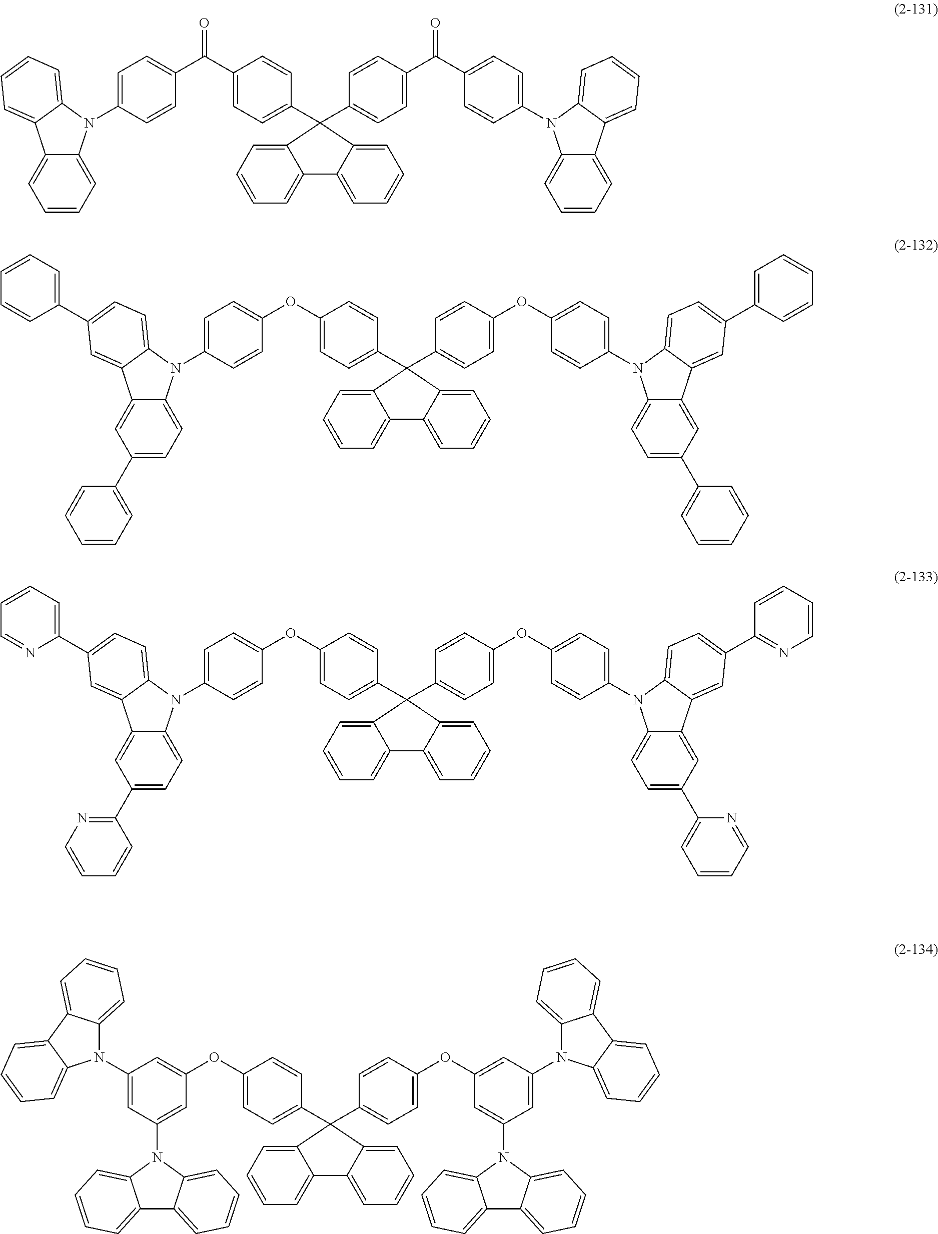

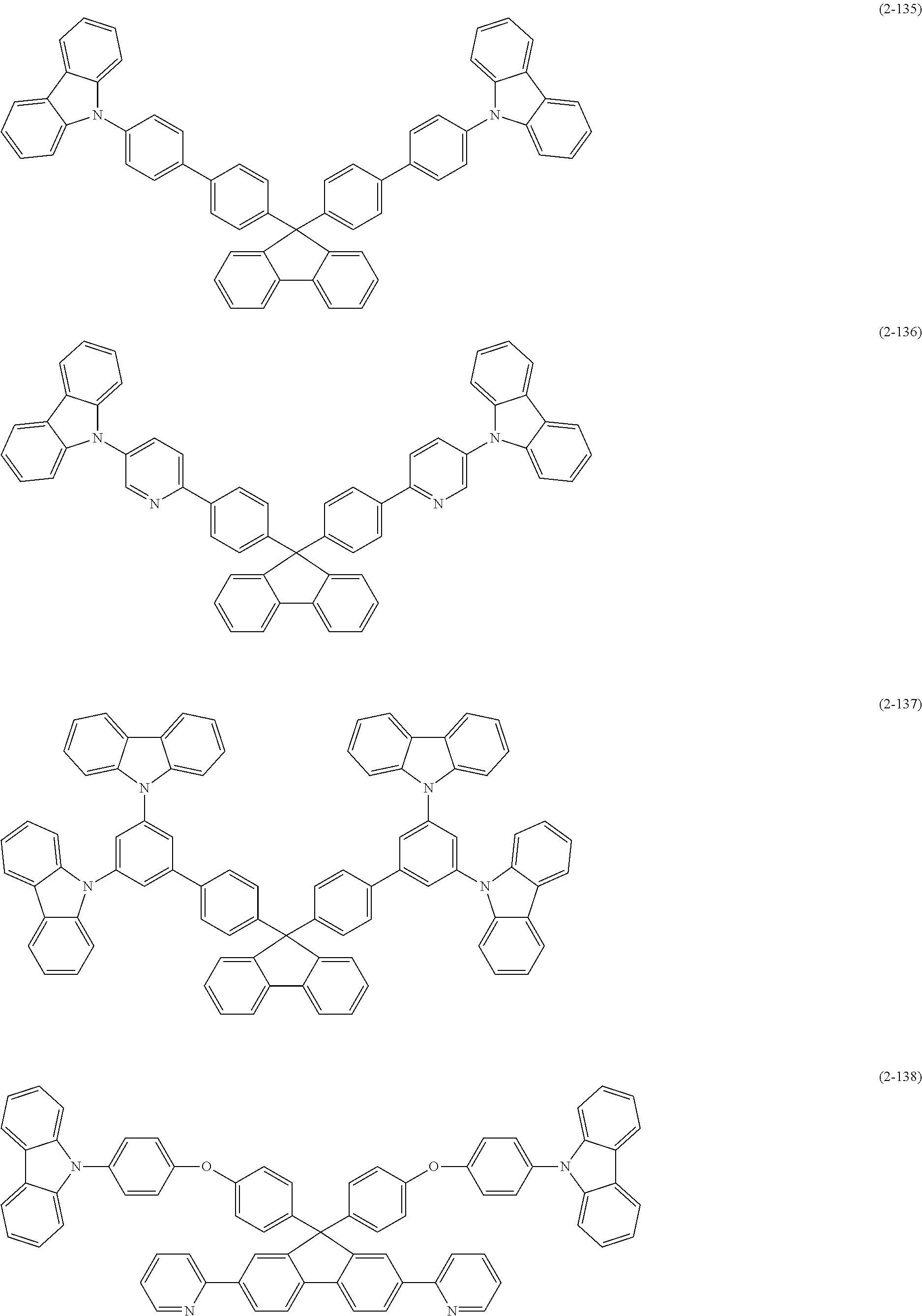

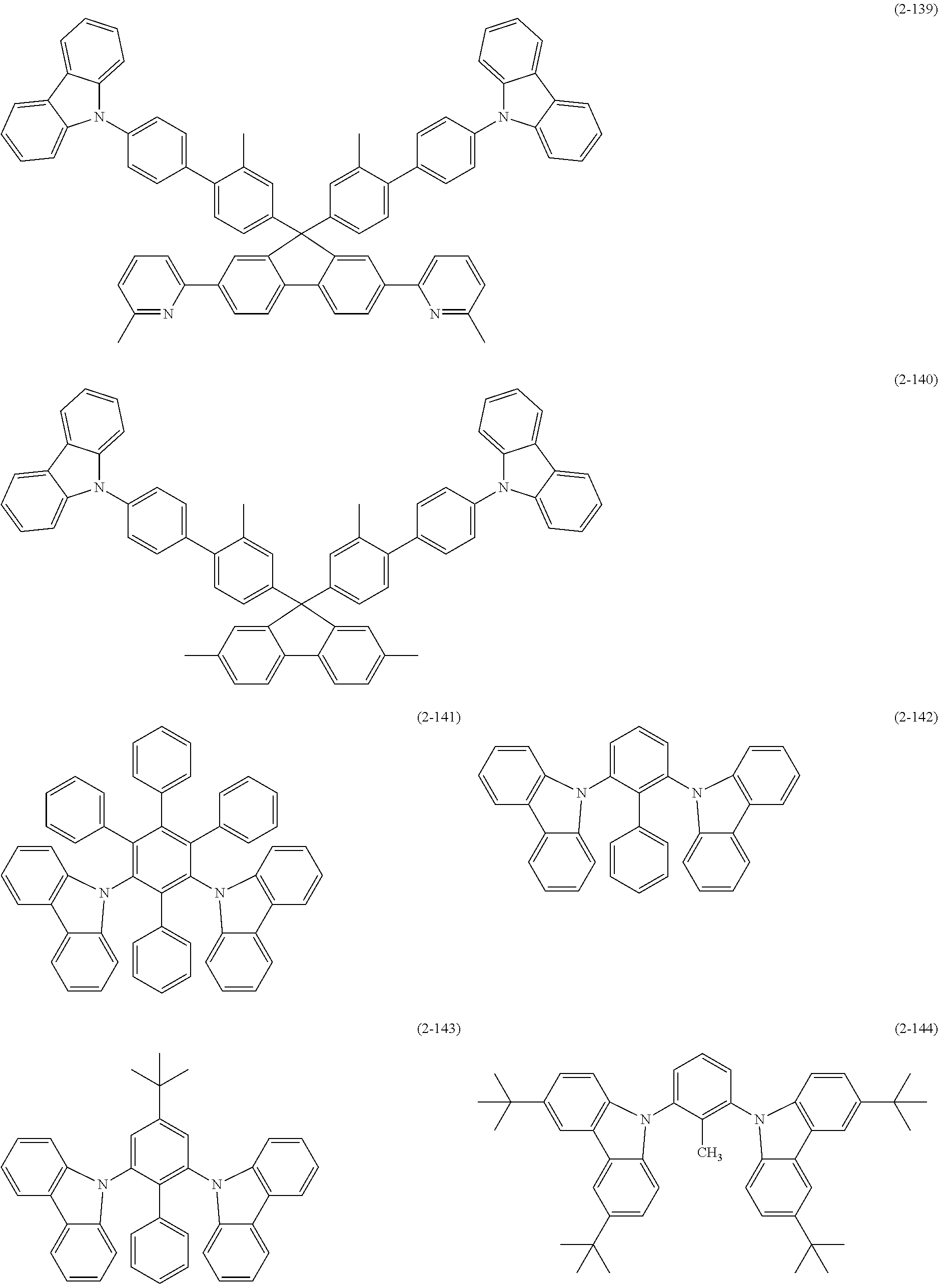

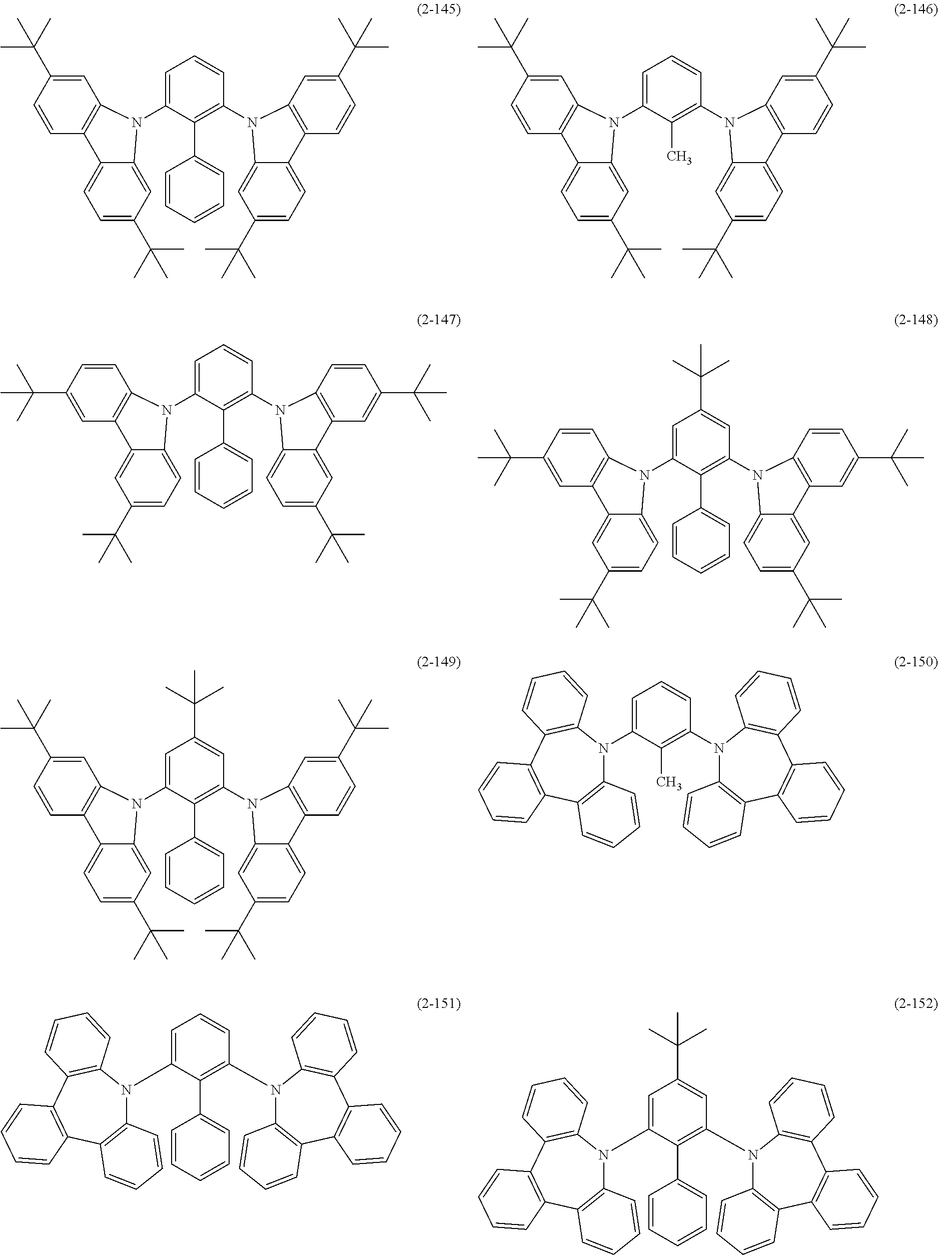

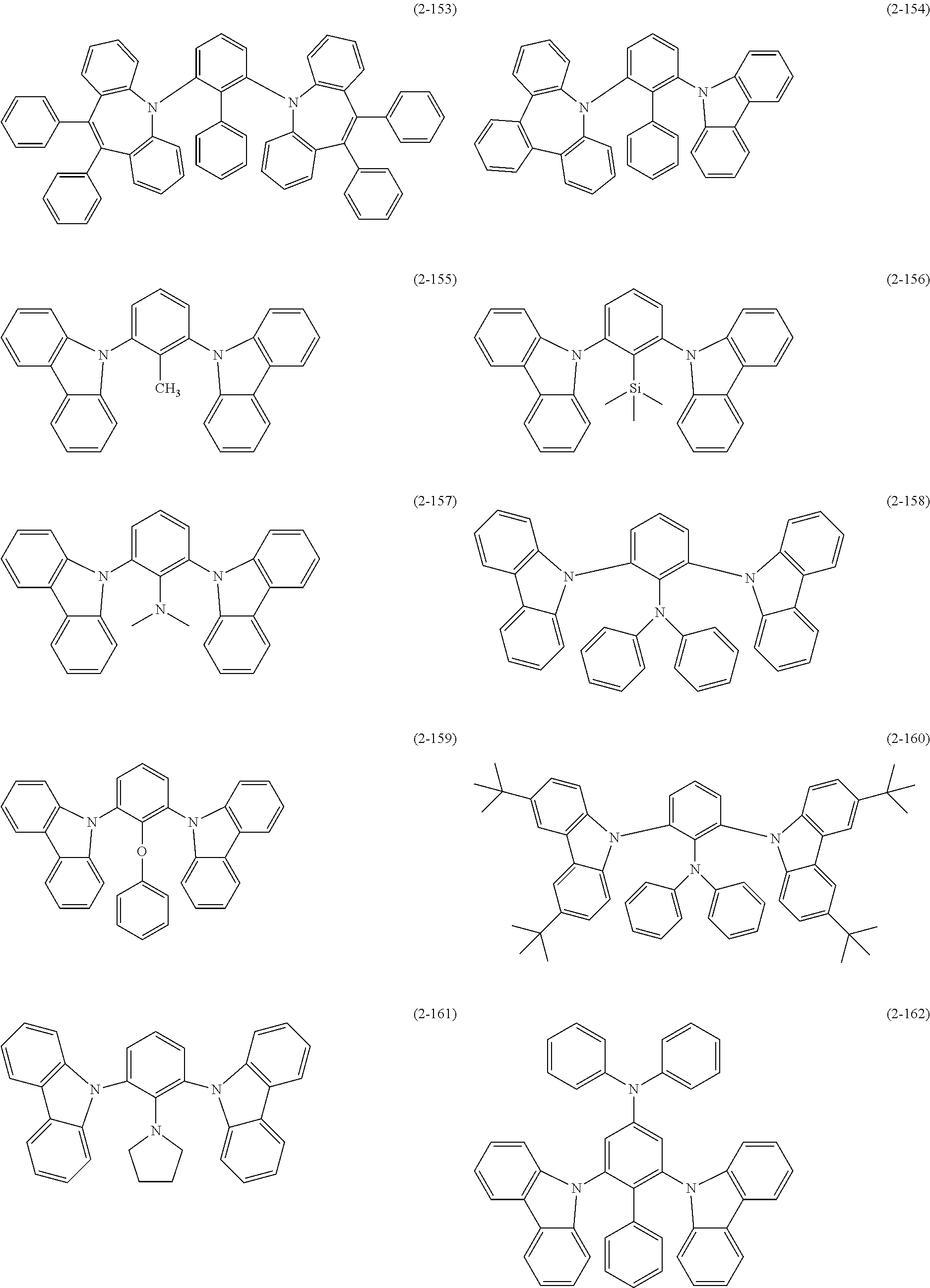

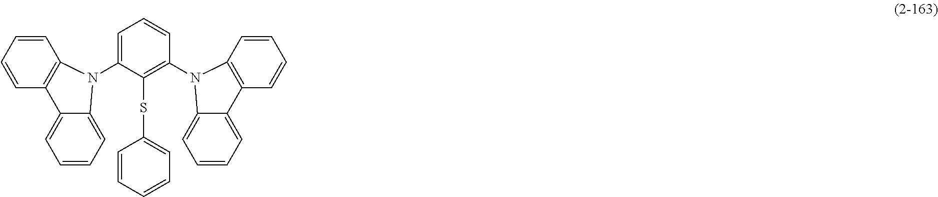 [SMILES: c1ccc(Sc2c(-n3c4ccccc4c4ccccc43)cccc2-n2c3ccccc3c3ccccc32)cc1]

Specific examples of the compound represented by Expression (3) include compounds represented by the following Formula (3-1) to (3-45).

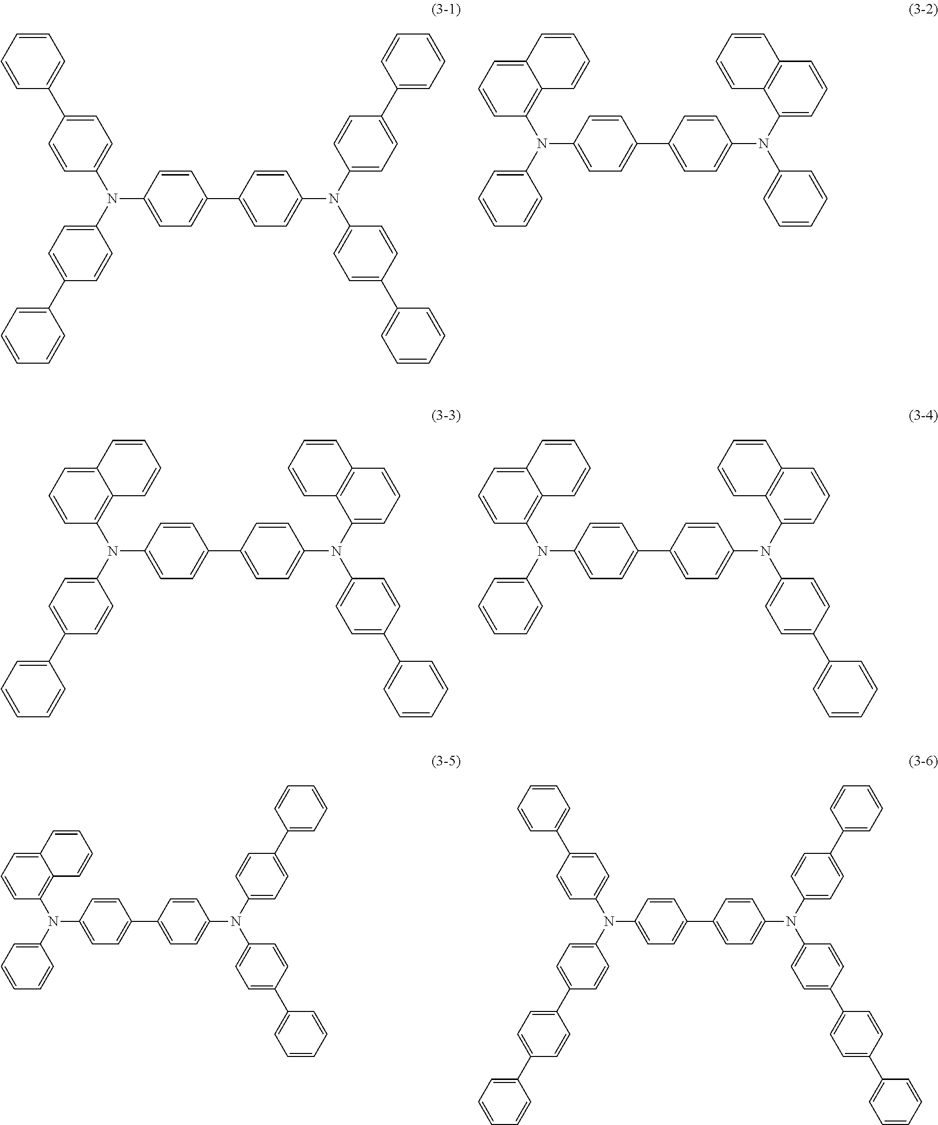

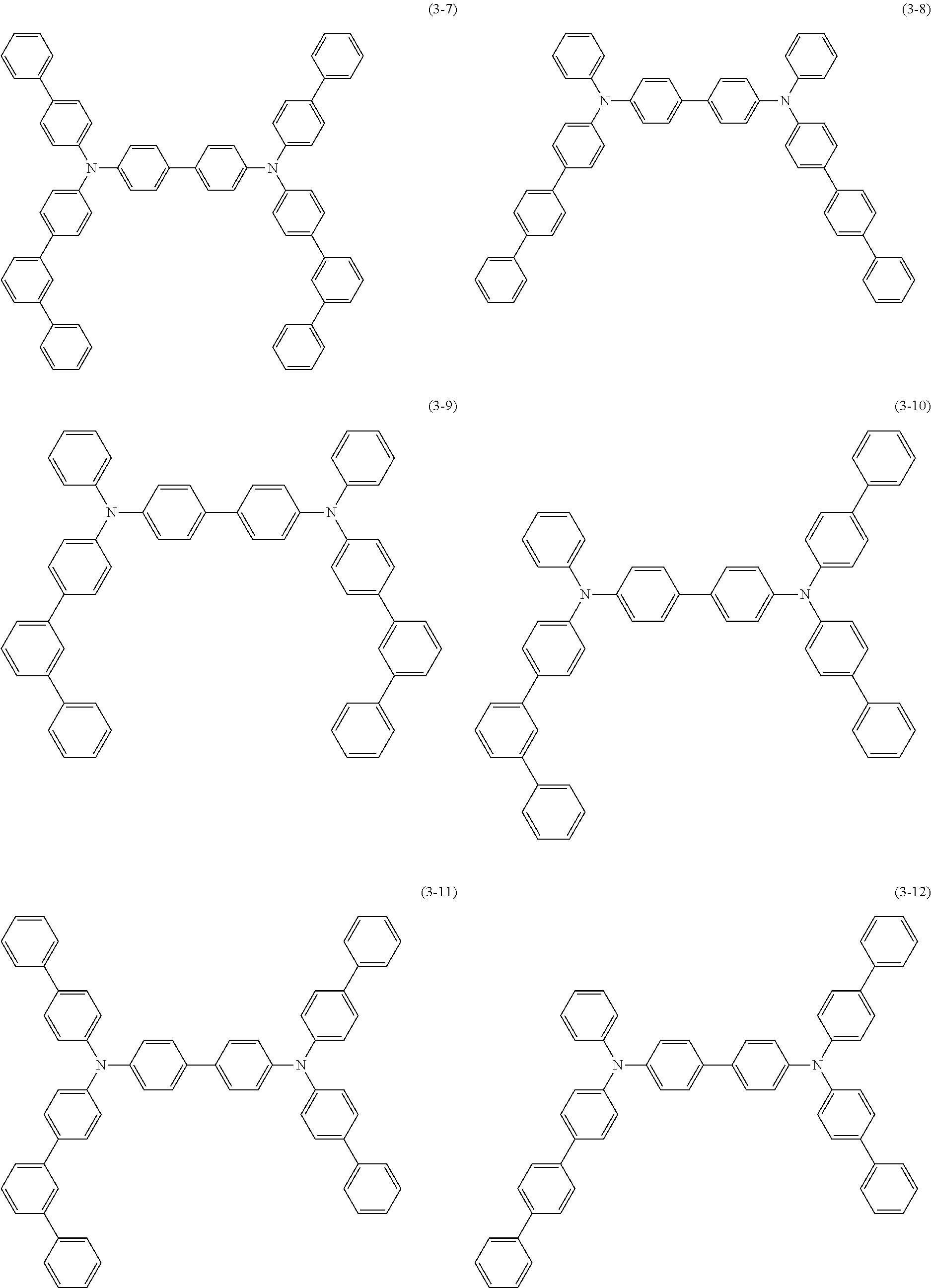

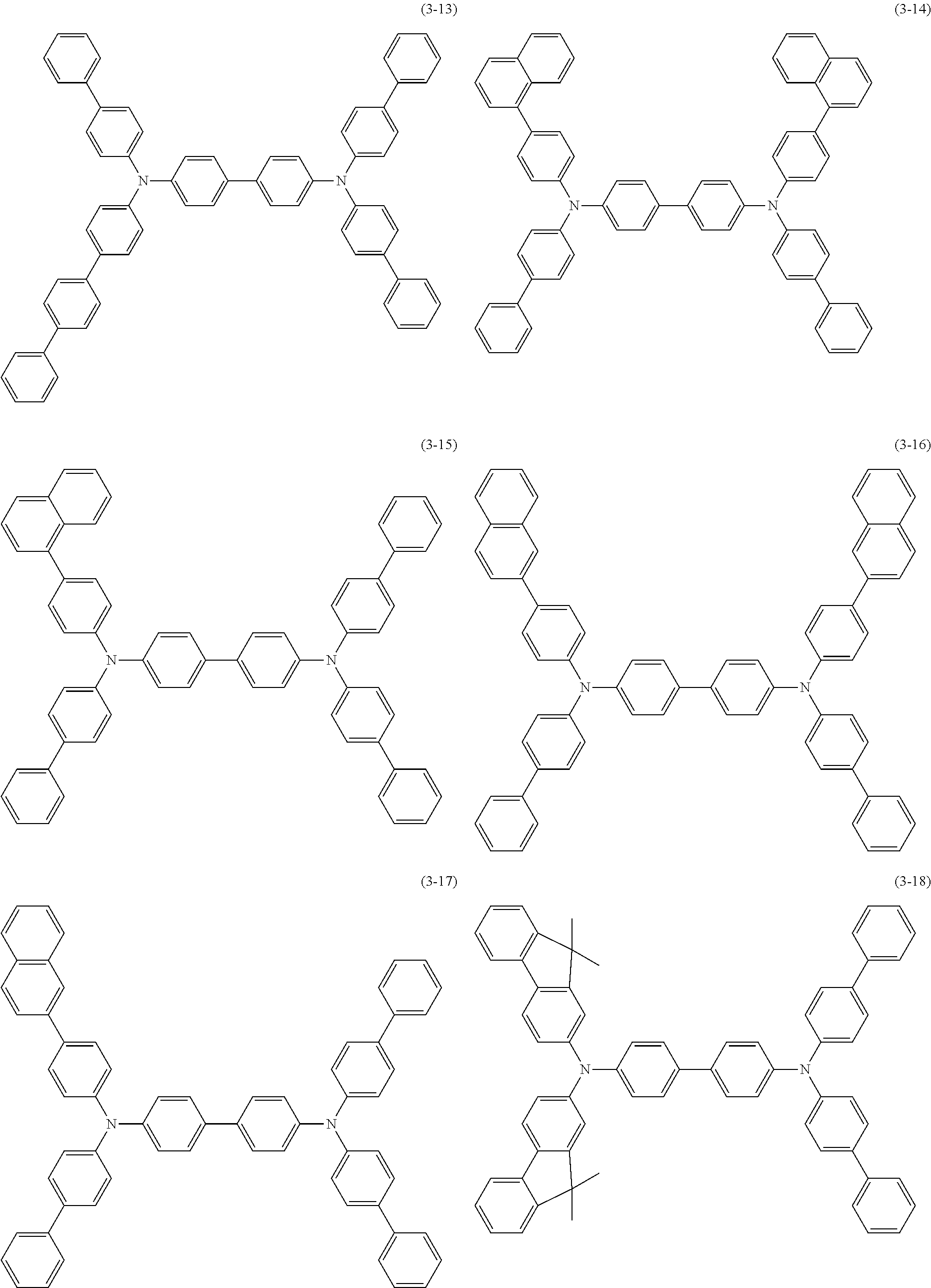

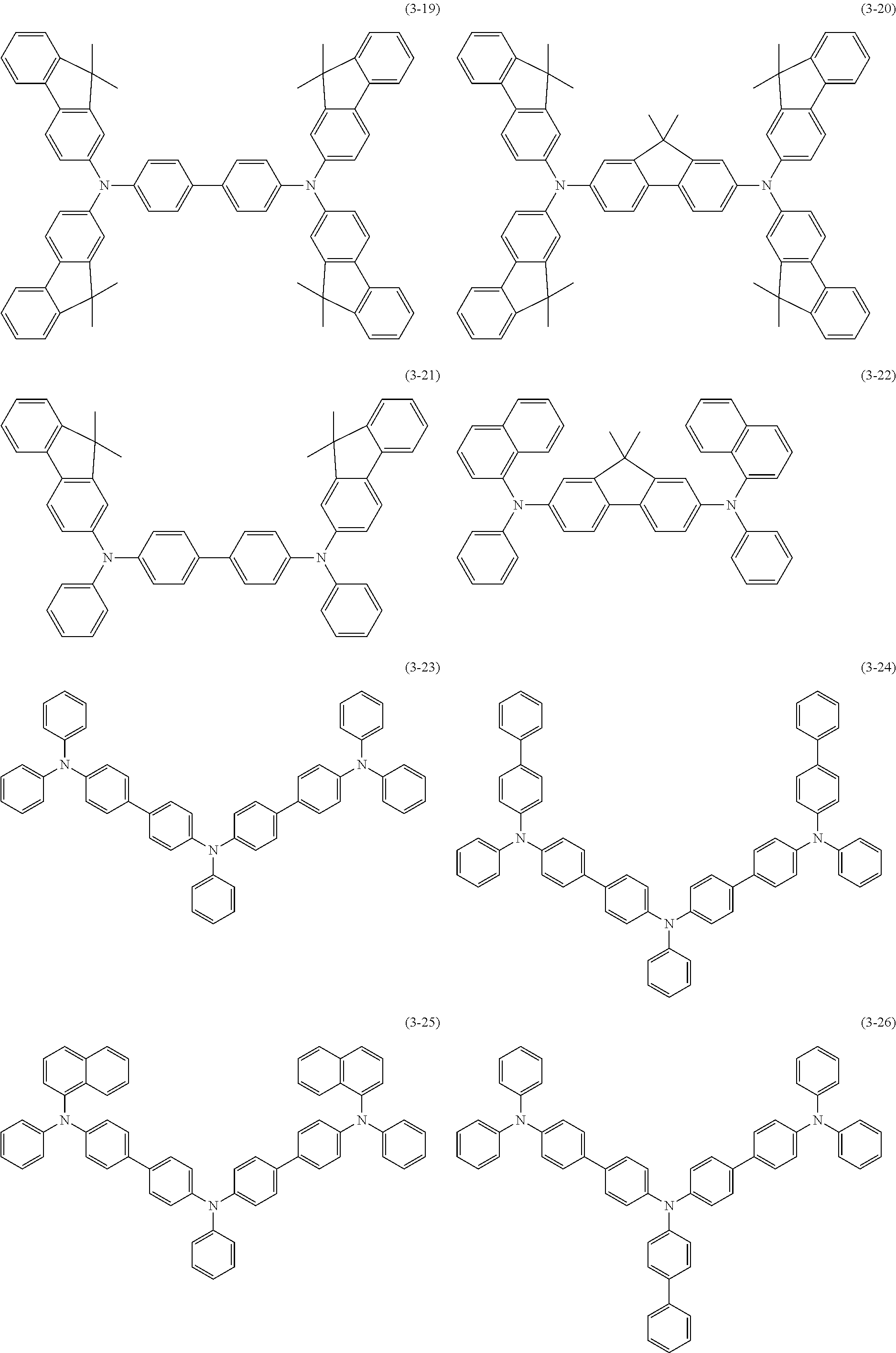

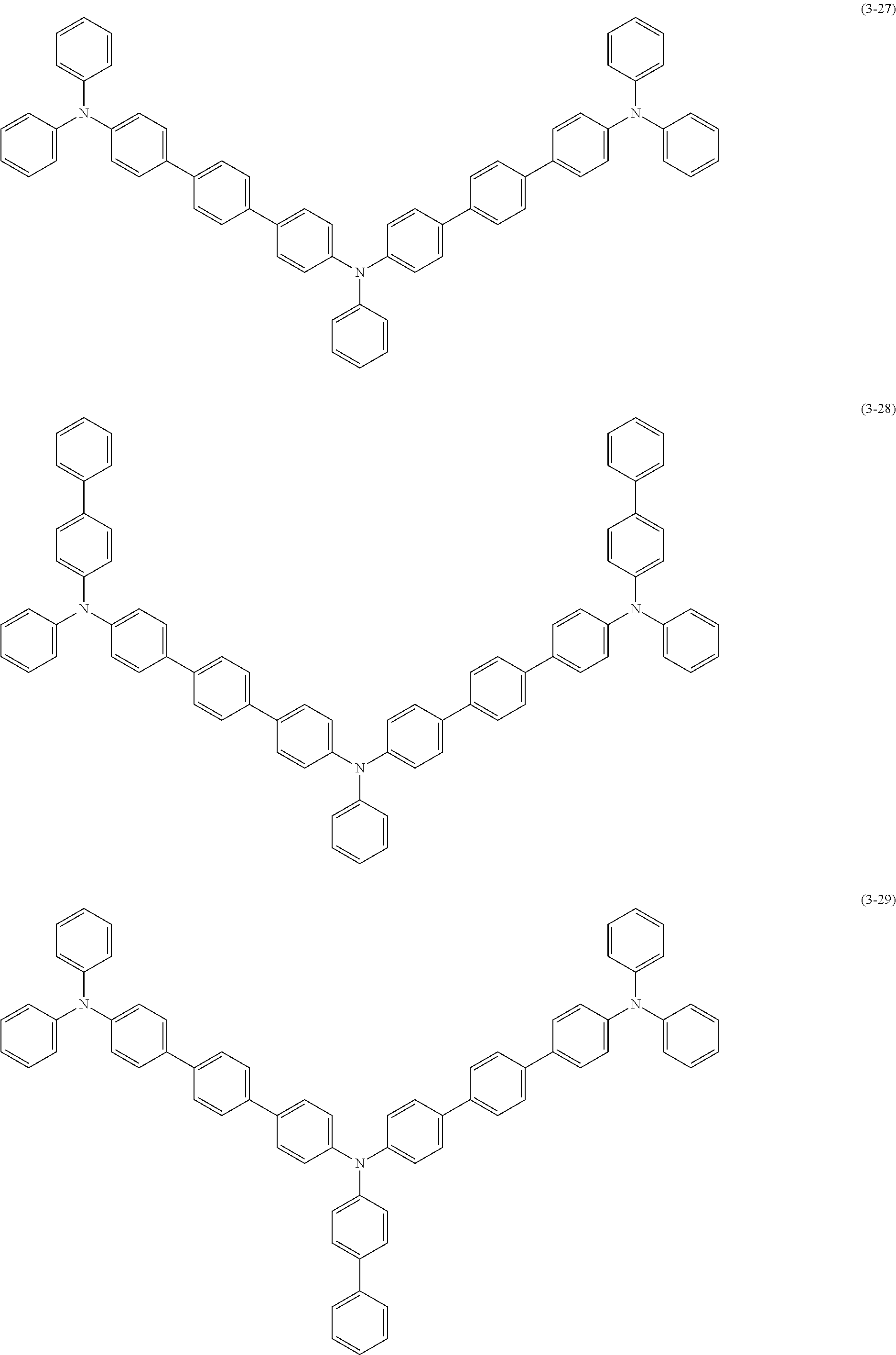 [SMILES: c1ccc(N(c2ccccc2)c2ccc(-c3ccc(-c4ccc(N(c5ccccc5)c5ccc(-c6ccc(-c7ccc(N(c8ccccc8)c8ccccc8)cc7)cc6)cc5)cc4)cc3)cc2)cc1 ; c1ccc(-c2ccc(N(c3ccccc3)c3ccc(-c4ccc(-c5ccc(N(c6ccccc6)c6ccc(-c7ccc(-c8ccc(N(c9ccccc9)c9ccc(-c%10ccccc%10)cc9)cc8)cc7)cc6)cc5)cc4)cc3)cc2)cc1 ; c1ccc(-c2ccc(N(c3ccc(-c4ccc(-c5ccc(N(c6ccccc6)c6ccccc6)cc5)cc4)cc3)c3ccc(-c4ccc(-c5ccc(N(c6ccccc6)c6ccccc6)cc5)cc4)cc3)cc2)cc1]

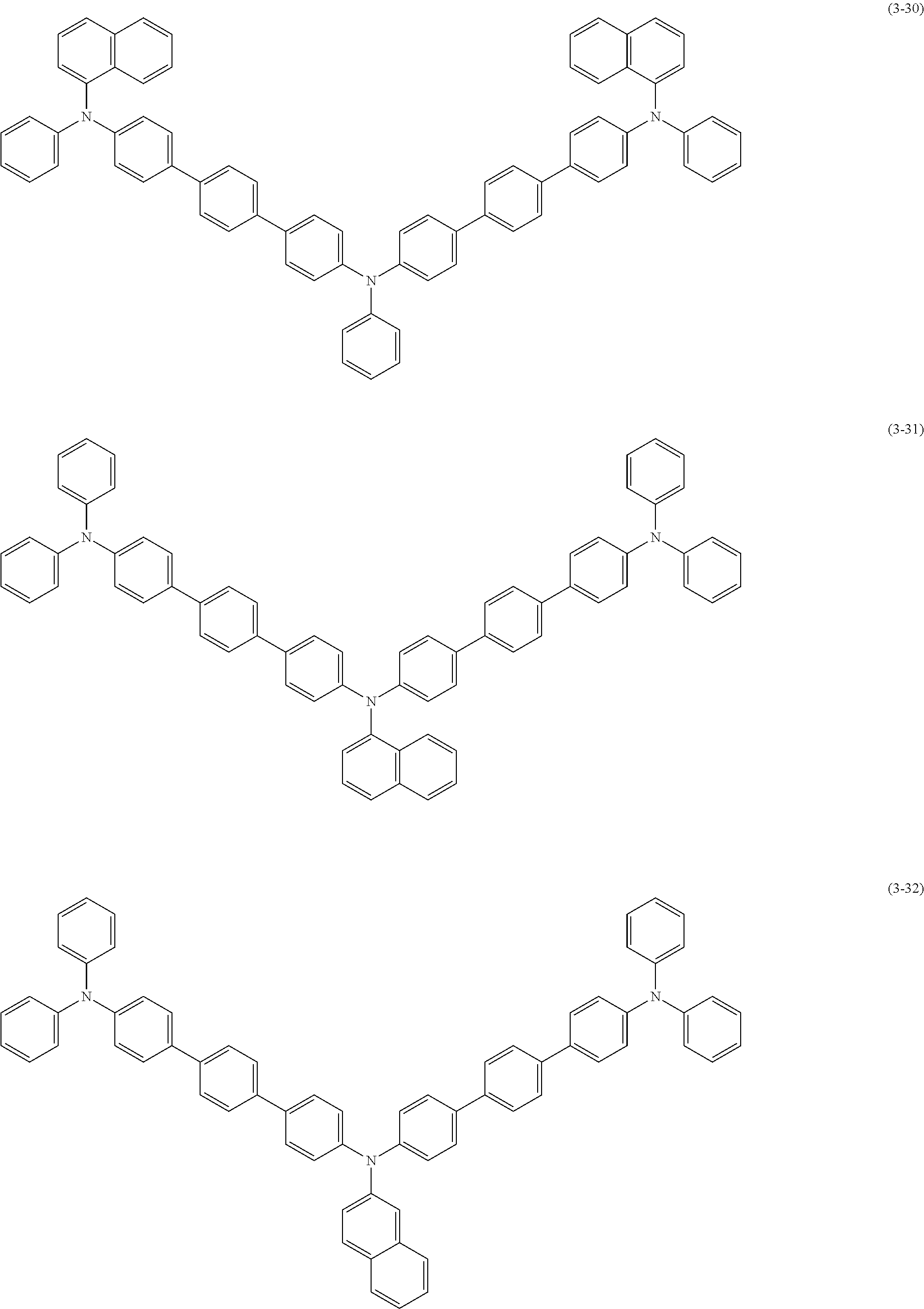 [SMILES: c1ccc(N(c2ccc(-c3ccc(-c4ccc(N(c5ccccc5)c5cccc6ccccc56)cc4)cc3)cc2)c2ccc(-c3ccc(-c4ccc(N(c5ccccc5)c5cccc6ccccc56)cc4)cc3)cc2)cc1 ; c1ccc(N(c2ccccc2)c2ccc(-c3ccc(-c4ccc(N(c5ccc(-c6ccc(-c7ccc(N(c8ccccc8)c8ccccc8)cc7)cc6)cc5)c5cccc6ccccc56)cc4)cc3)cc2)cc1 ; c1ccc(N(c2ccccc2)c2ccc(-c3ccc(-c4ccc(N(c5ccc(-c6ccc(-c7ccc(N(c8ccccc8)c8ccccc8)cc7)cc6)cc5)c5ccc6ccccc6c5)cc4)cc3)cc2)cc1]

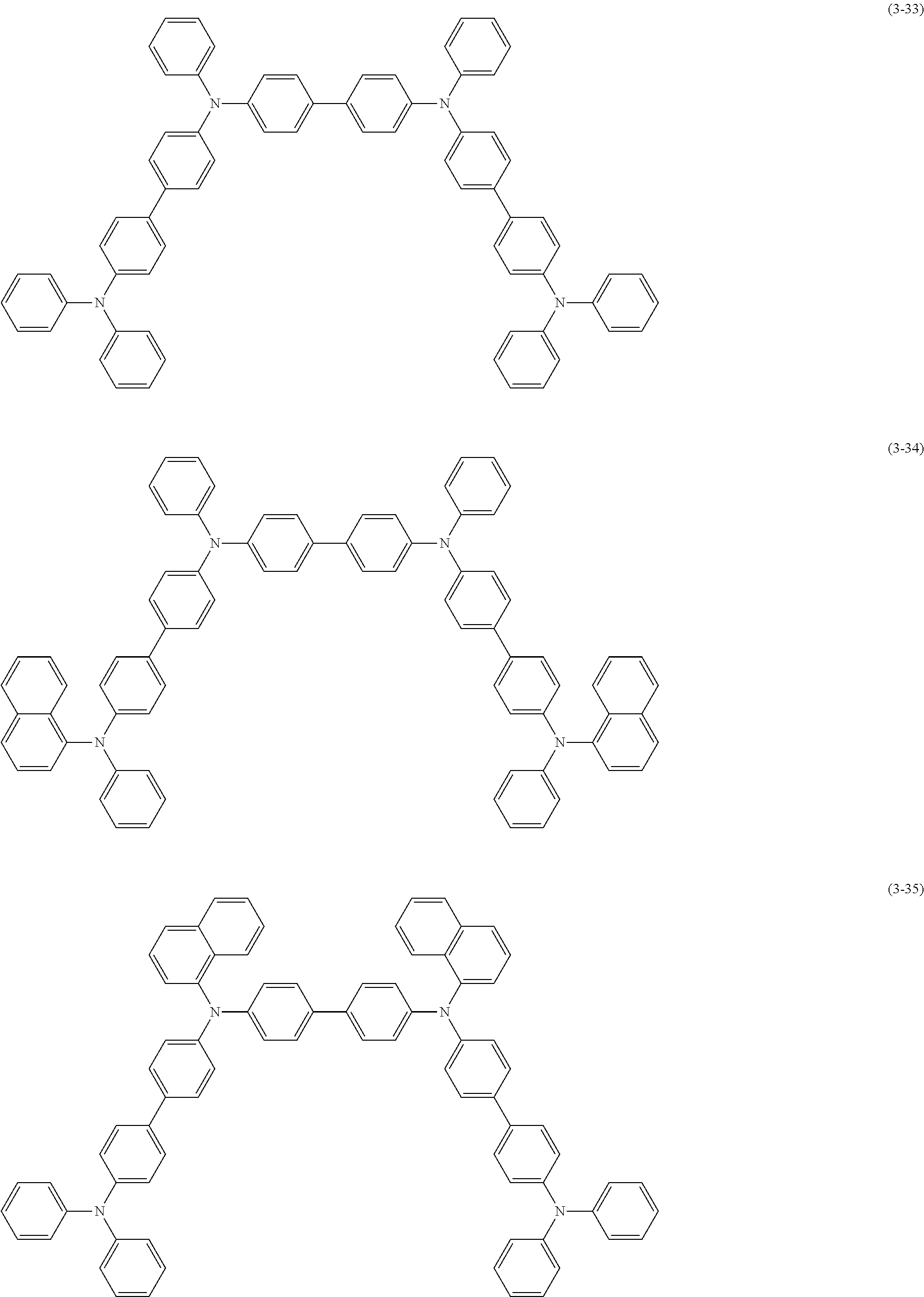 [SMILES: c1ccc(N(c2ccccc2)c2ccc(-c3ccc(N(c4ccccc4)c4ccc(-c5ccc(N(c6ccccc6)c6ccc(-c7ccc(N(c8ccccc8)c8ccccc8)cc7)cc6)cc5)cc4)cc3)cc2)cc1 ; c1ccc(N(c2ccc(-c3ccc(N(c4ccccc4)c4ccc(-c5ccc(N(c6ccccc6)c6cccc7ccccc67)cc5)cc4)cc3)cc2)c2ccc(-c3ccc(N(c4ccccc4)c4cccc5ccccc45)cc3)cc2)cc1 ; c1ccc(N(c2ccccc2)c2ccc(-c3ccc(N(c4ccc(-c5ccc(N(c6ccc(-c7ccc(N(c8ccccc8)c8ccccc8)cc7)cc6)c6cccc7ccccc67)cc5)cc4)c4cccc5ccccc45)cc3)cc2)cc1]

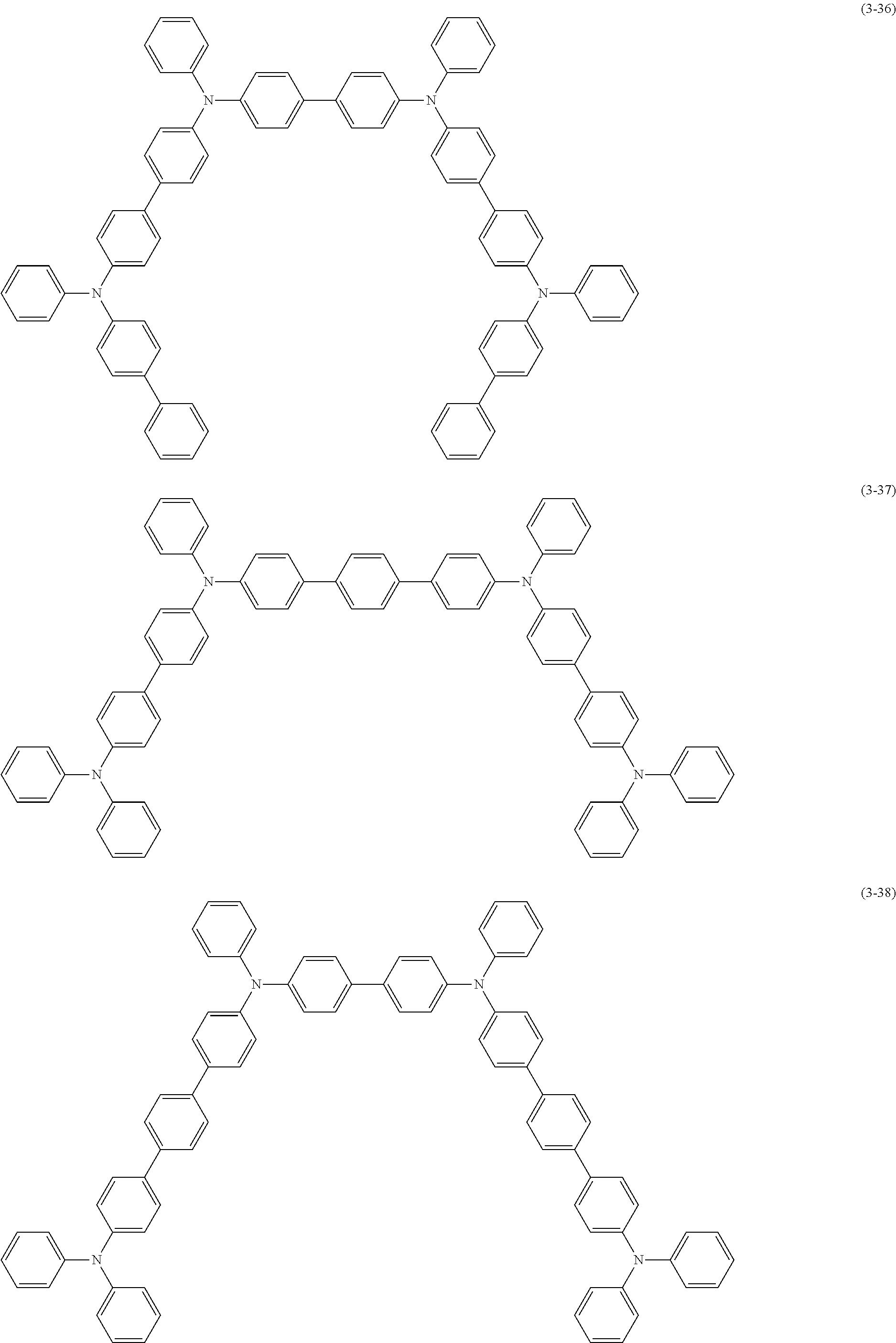

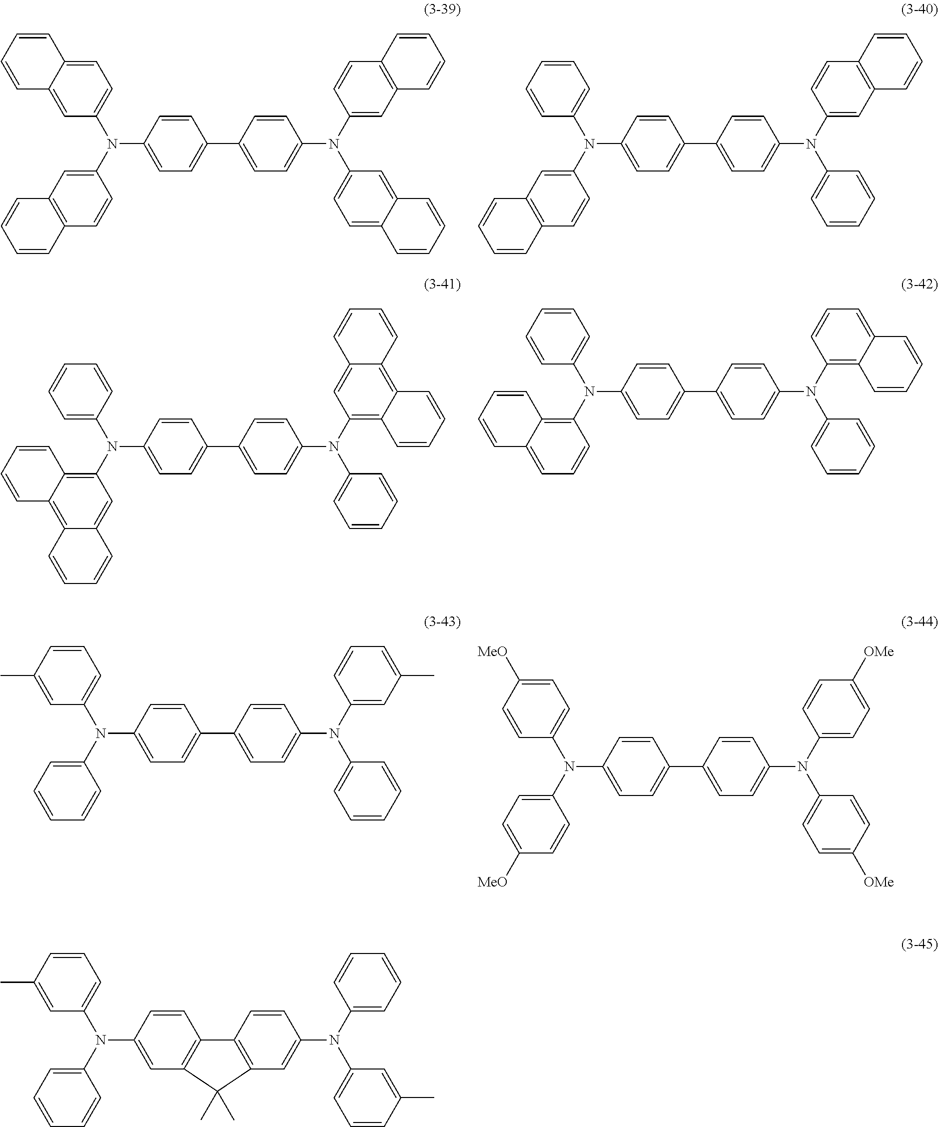

It is to be noted that, as illustrated in FIG. 8, the blue light emitting layer 14CB may be formed as a common layer. In this case, after the red light-emitting layers 14CR and the green light-emitting layers 14CG are formed, the blue light-emitting layer 14CB is formed on entire surfaces of the red light-emitting layers 14CR, the green light-emitting layers 14CG, and the hole transport layer 14B by an evaporation method. As the material of the blue light-emitting layer 14CB serving as a common layer, for example, an anthracene compound as a host material doped with a blue or green fluorescent pigment as a guest material is used. Thus, the blue light-emitting layer 14CB emits blue or green light.

Moreover, when the low-molecular material is included in the ink composition 22 forming the red light-emitting layers 14CR and the green light-emitting layers 14CG in the case where the blue light-emitting layer 14CB serves as a common layer, injection efficiency of holes and electrons from the blue light-emitting layer 14CB laminated on the red light-emitting layers 14CR and the green light-emitting layers 14CG to each of the light-emitting layers 14CR and 14CG is improvable during operation of a display unit 2. In other words, characteristics of the red organic EL devices 10R and the green organic EL devices 10G are improved.

In the case where the red light-emitting layers 14CR and the green light-emitting layers 14CG do not include the above-described low-molecular material, a difference between the energy level of the blue light-emitting layer 14CB and the energy levels of the red light-emitting layers 14CR and the green light-emitting layers 14CG is increased. In other words, hole or electron injection efficiency between the blue light-emitting layer 14CB and the red and green light-emitting layers 14CR and 14CG may be reduced, and desired characteristics may not be obtained. On the other hand, when the red light-emitting layers 14CR and the green light-emitting layers 14CG are made of the low-molecular material together with the polymer material, the difference in energy level is reduced, and the above-described injection efficiency of holes and electrons are improvable.

(Forming Electron Transport Layer 14D, Electron Injection Layer 14E, and Upper Electrode 15)

After the blue light-emitting layer 14CB are formed, the electron transport layer 14D, the electron injection layer 14E, and the upper electrode 15 are formed on entire surfaces of the red, green, and blue light-emitting layers 14CR, 14CG, and 14CB (in the display unit 1) or an entire surface of the blue light-emitting layer 14CB (in the display unit 2) by an evaporation method (steps S106, S107, and S108).

The electron transport layer 14D enhances electron transport efficiency to the red light-emitting layers 14CR, the green light-emitting layers 14CG, and the blue light-emitting layers 14CB. Examples of the material of the electron transport layer 14D include quinoline, perylene, phenanthroline, bisstyryl, pyrazine, triazole, oxazole, fullerene, oxadiazole, fluorenone, a derivative thereof, and a metal complex thereof. More specific examples include tris(8-hydroxyquinoline) aluminum (Alq3 for short), anthracene, naphthalene, phenanthrene, pyrene, perylene, butadiene, coumarin, C60, acridine, stilbene, 1,10-phenanthroline, a derivative thereof, and a metal complex thereof.

The electron injection layer 14E enhances electron injection efficiency. As the material of the electron injection layer 14E, for example, lithium oxide (Li₂O) which is an oxide of lithium (Li), cesium carbonate (Cs₂CO₃) which is a complex oxide of cesium, or a mixture of the oxide and the complex oxide may be used. Moreover, as the material of the electron injection layer 14E, a simple substance, a mixture, or an alloy of an alkali-earth metal such as calcium (Ca) or barium (Ba), an alkali metal such as lithium or cesium, a metal with a small work function such as indium (In) or magnesium (Mg) may be used.

The upper electrode 15 is disposed on an entire surface of the substrate 11 while being insulated from the lower electrode 15 by the barrier rib 13 and the organic layer 14, and functions as an electrode common to the red organic EL devices 10R, the green organic EL devices 10G, and the blue organic EL devices 10B. The upper electrode 15 is configured of, for example, a metal conductive film of aluminum, magnesium, calcium, sodium (Na), or the like. The upper electrode 15 is preferably formed of an alloy of magnesium and silver (an Mg—Ag alloy) having favorable conductivity in the case of being used as a thin film and having small light absorption. The ratio between magnesium and silver in the Mg—Ag alloy is not specifically limited, but the ratio is preferably within a range of Mg:Ag=about 20:1 to 1:1 both inclusive in film thickness ratio. Moreover, the material of the upper electrode 15 may be an alloy of aluminum and lithium (an Al—Li alloy).

The upper electrode 15 may be configured of a mixture layer including an organic light-emitting material such as an aluminum quinoline complex, a styrylamine derivative, or a phthalocyanine derivative. In this case, the upper electrode 15 may further include, as a third layer, a layer with light transmittance such as an Mg—Ag alloy.

After the upper electrode 15 is formed, a protective layer 16 made of amorphous silicon nitride with low water permeability is formed by, for example, an evaporation method or a CVD method. After the protective layer 16 is formed, a sealing substrate 17 provided with a light-shielding film and a color filter (both not illustrated) is bonded onto the protective film 16 with an adhesive layer (not illustrated) in between. Thus, the display unit 1 illustrated in FIG. 7 is completed.

In the plate printing method, after an ink coating is formed on the blanket, the blanket is brought into contact with an engraved plate, and a pattern remaining on the blanket is brought into contact with a printing substrate to be transferred from the blanket to the printing substrate. Thus, printing is performed. It is necessary for the blanket 21 to have releasability which allows the organic film (the transfer layer 22a) formed on the blanket 21 in a region in contact with the printing substrate to be completely transferred to the printing substrate when the blanket 21 is in contact with the printing substrate. A typically used blanket material with high releasability is silicone rubber containing polydimethylsiloxane as a base.

However, a soft material such as silicone rubber used for a surface of the blanket easily absorbs an ink solvent, and the ink coating formed on the blanket is easily dried. Accordingly, as described above, cobwebbing is caused at an edge of a pattern, or the ink coating is formed into a film. As a result, pattern accuracy is reduced, or it is difficult to perform patterning.

As methods of solving these issues, there are proposed a method in which a mechanism of swelling the blanket 21 in advance is added (refer to Japanese Unexamined Patent Application Publication No. 2007-90698) and a method in which a mechanism of removing a solvent is added (refer to Japanese Unexamined Patent Application Publication No. 2007-95517). However, when the process is complicated, cost is increased accordingly. Moreover, in the case where a phenomenon in which the solvent is not completely removed occurs, a back diffusion phenomenon of the solvent to an organic matter patterned on the blanket 21 occurs; therefore, the pattern is shrunk with a drying process. As a result, dimension variations occur to cause a decline in definition, or unevenness in luminance or the like of the display unit.

On the other hand, the ink composition according to the embodiment uses a solvent having a dipole moment of about 1.3 to about 3.0 both inclusive and having a π covalent bond in a molecular skeleton thereof. Polydimethylsiloxane existing on the surface of the blanket 21 has little polarity. Therefore, when a solvent having higher polarity than polydimethylsiloxane is used, absorption of the solvent into the blanket 21 is suppressed, and swelling of the blanket is suppressed. Accordingly, the transfer layer and the pattern layer are inhibited from being formed into a film on the blanket 21.

Thus, according to the embodiment, the solvent having a dipole moment of about 1.3 to about 3.0 both inclusive and having a π covalent bond in a molecular skeleton thereof is used. Therefore, printing with high-definition patterning is achievable without adding any other process, such as a process of suppressing swelling of the blanket 21 made of silicone rubber. Therefore, a display unit with high display quality is achievable.

### 3. Application Examples

### Module and Application Examples

Application examples of the display units 1 and 2 described in the above-described embodiments will be described below. The display units according to the above-described embodiments are applicable to display units of electronic apparatuses, in any fields, displaying an image signal supplied from outside or an image signal produced inside as an image or a picture, such as televisions, digital cameras, notebook personal computers, portable terminal devices such as cellular phones, and video cameras.

(Module)

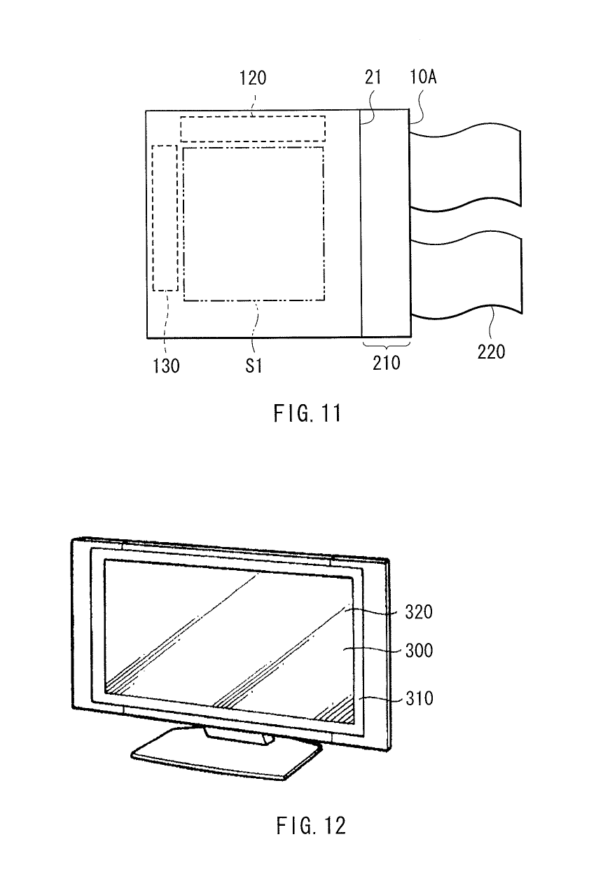

The display units 1 and 2 according to the above-described embodiments are incorporated into various electronic apparatuses such as Application Examples 1 to 5 which will be described later as a module as illustrated in FIG. 11. In the module, for example, a region 210 exposed from the protective layer 16 and the sealing substrate 17 is provided on a side of the substrate 11, and an external connection terminal (not illustrated) is formed in the exposed region 210 through extending the wiring of the signal line drive circuit 120 and the scanning line drive circuit 130. In the external connection terminal, a flexible printed circuit (FPC) 220 for signal input and output may be provided.

### Application Example 1

FIG. 12 illustrates an appearance of a television to which any one of the display units 1 and 2 according to the above-described embodiments is applied. The television includes, for example, an image display screen section 300 including a front panel 310 and a filter glass 320, and the image display screen section 300 is configured of any one of the display units according to the above-described embodiments.

### Application Example 2

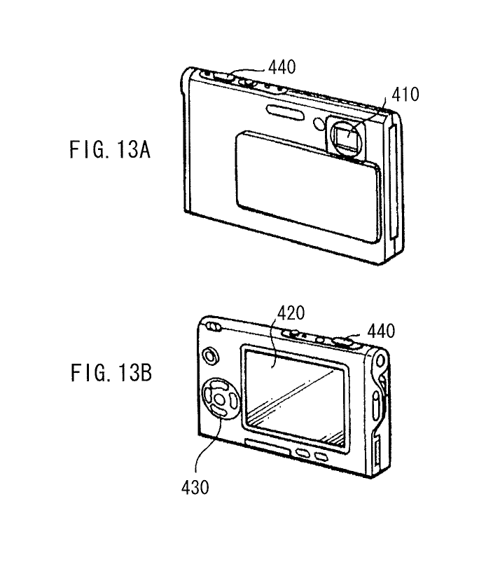

FIGS. 13A and 13B illustrate an appearance of a digital camera to which any one of the display units 1 and 2 according to the above-described embodiments is applied. The digital camera includes, for example, a light-emitting section 410 for a flash, a display section 420, a menu switch 430, and a shutter button 440, and the display section 420 is configured of any one of the display units according to the above-described embodiments.

### Application Example 3

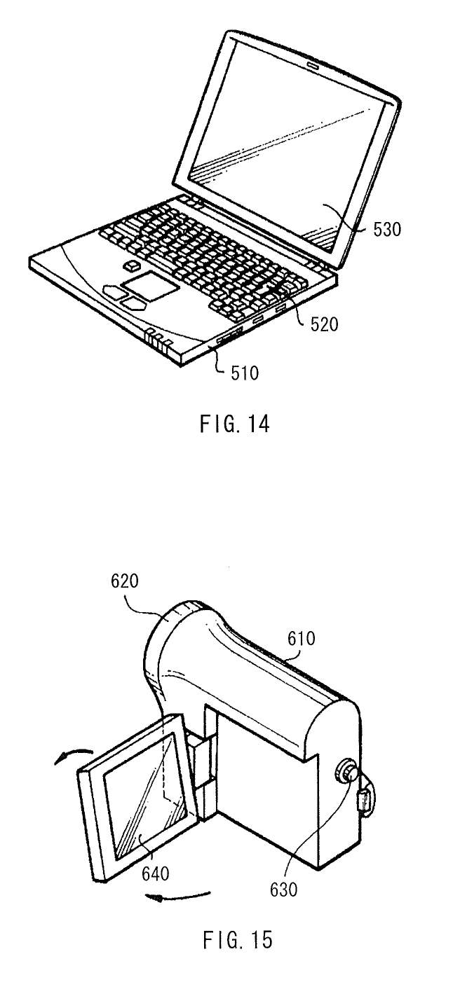

FIG. 14 illustrates an appearance of a notebook personal computer to which any one of the display units 1 and 2 according to the above-described embodiments is applied. The notebook personal computer includes, for example, a main body 510, a keyboard 520 for operation of inputting characters and the like, and a display section 530 for displaying an image, and the display section 530 is configured of any one of the display units according to the above-described embodiments.

### Application Example 4

FIG. 15 illustrates an appearance of a video camera to which any one of the display units 1 and 2 according to the above-described embodiments is applied. The video camera includes, for example, a main body 610, a lens 620 provided on a front surface of the main body 610 and for shooting an image of an object, a shooting start/stop switch 630, and a display section 640, and the display section 640 is configured of any one of the display units according to the above-described embodiments.

### Application Example 5

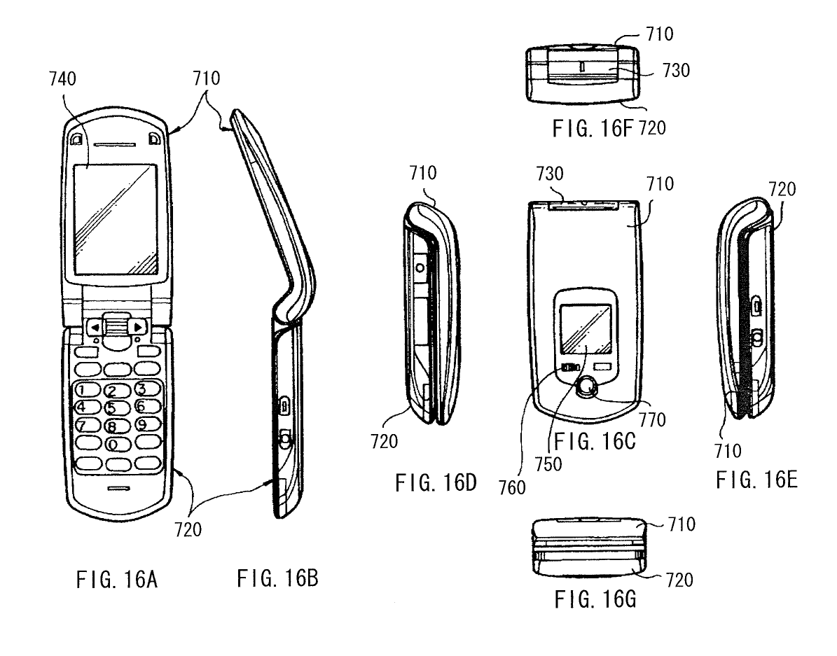

FIGS. 16A to 16G illustrate an appearance of a cellular phone to which any one of the display units 1 and 2 according to the above-described embodiments is applied. The cellular phone is formed by connecting, for example, a top-side enclosure 710 and a bottom-side enclosure 720 to each other by a connection section (hinge section) 730, and the cellular phone includes a display 740, a sub-display 750, a picture light 760, and a camera 770. The display 740 or the sub-display 750 is configured of any one of the display units according to the above-described embodiments.

Moreover, specific examples of the present application will be described below.

### 4. Examples

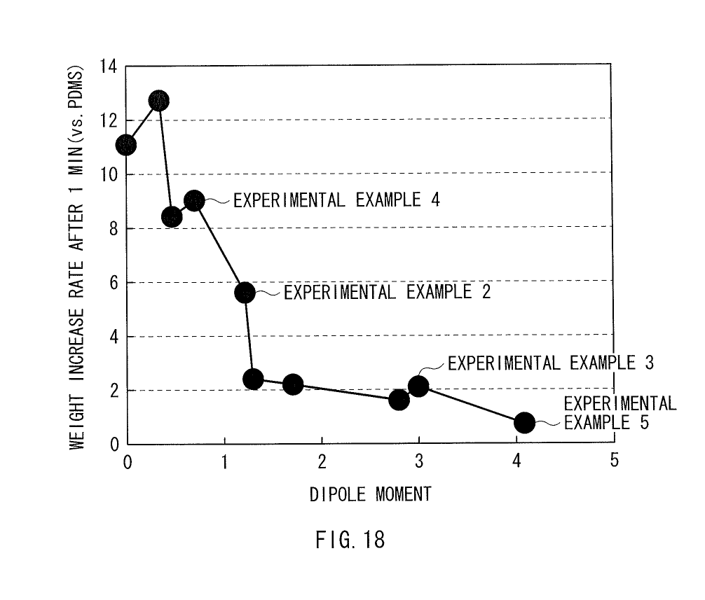

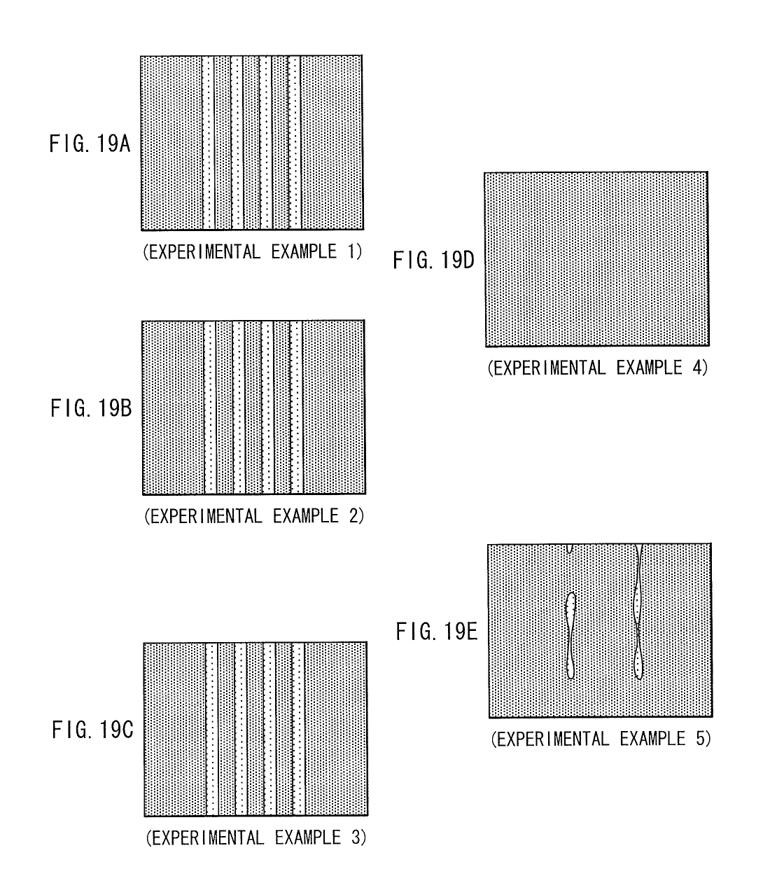

The light-emitting layer 14C of the organic EL device 10 was formed by the above-described plate printing method. Table 1 and FIG. 18 illustrate compositions, dipole moments, and weight increase rates after one minute of solvents in ink compositions of respective experimental examples. Moreover, FIGS. 19A to 19E illustrate schematic views of printing patterns in Experimental Examples 1 to 5. It is to be noted that the weight increase rate after one minute is a weight increase rate of silicone rubber after the blanket is immersed in the solvent for one minute.

TABLE 1

| | | | Weight |
|---|---|---|---|
| | | Dipole | Increase Rate |
| | Solvent Composition | Moment | (vs. PDMS) |
| Example 1 | dimethoxybenzene:octane | 1.77-2.0/0 | 4.8 |
| | (70:30) | | |
| Example 2 | phenol:octane | 1.27-1.7/0 | 4.1 |
| | (80:20) | | |
| Example 3 | acetophenone:octane | 2.81-3.96/0 | 6.3 |
| | (50:50) | | |
| Example 4 | m-xylene | 0.34 | 12.7 |
| | (100) | | |
| Example 5 | NMP:octane | 4.09/0 | 5.5 |
| | (50:50) | | |

In Experimental Example 4 (Comparative Example 1) using 100% of xylene as the solvent, xylene was absorbed into the silicone blanket to be formed into a film on the surface of the blanket. Therefore, as illustrated in FIG. 19D, patterning was not performed. To perform patterning with use of xylene, as described above, the solvent is absorbed into the blanket in advance, thereby allowing absorption of the solvent into the organic film formed on the blanket to be suppressed. However, in this case, the solvent is diffused back from the blanket to the organic film, and shrinkage or distortion of an obtained pattern may be caused together with volatilization of the solvent.

In Experimental Example 5 (Comparative Example 2) using NMP:octane (50:50) as the solvent, the ink was rejected due to a large dipole moment (a dipole moment of 4.09), and a coating was not formed accordingly. As a result, as illustrated in FIG. 19E, liquid pools were formed in parts.

On the other hand, in Experimental Examples 1 to 3 (Examples 1 to 3) using the solvent with a dipole moment within a range of about 1.3 to about 3.0 both inclusive, as can be seen from FIGS. 19A to 19C, accurate patterning was performed.

It was confirmed from these results that printing with high-definition patterning was achievable with use of the solvent with a dipole moment of about 1.3 to about 3.0 both inclusive as the solvent of the ink composition. Moreover, as can be seen from the characteristic diagram in FIG. 18, a solvent having a weight increase rate of about 1% to about 6% both inclusive in a polymer forming the blanket when the blanket is immersed in the solvent for one minute is preferable as the solvent of the ink composition.

Although the present disclosure is described referring to the first and second embodiments and the examples, the disclosure is not limited thereto, and may be variously modified. For example, in the above-described embodiments and the like, an example in which the red light emitting layers 14CR and the green light emitting layers 14CG are formed with use of the ink composition 22 is described; however, light emitting layers other than the red light emitting layers 14CR and the green light emitting layers 14CG or other organic layers 14 such as the electron hole injection layer 14A and the electron hole transport layer 14B may be formed by patterning. In particular, when the electron hole injection layer 14A is formed by patterning, a leakage current is allowed to be reduced.

Moreover, in the above-described embodiments and the like, the case where a printing pattern layer as a part of a functional layer is the light-emitting layer 14C is described as an example; however, the disclosure is not limited thereto, and any other organic layer 14, for example, one or more of the hole injection layer 14A, the hole transport layer 14B, the electron transport layer 14D, and the electron injection layer 14E may be formed as printing pattern layers by offset printing.

Further, in the above-described embodiments and the like, the configurations of the organic EL devices 10R, 10G, and 10B are specifically described; however, it is not necessary for each of the organic EL devices 10R, 10G, and 10B to include all of the layers, or each of the organic EL devices 10R, 10G, and 10B may further include other layers. In the above-described embodiments and the like, the display unit including red and green organic EL devices as organic EL devices other than the blue organic EL devices is described; however, the disclosure is not limited thereto, and the disclosure is applicable to any display units in which a functional layer is allowed to be formed by a printing method. For example, the disclosure is applicable to a display unit configured of blue organic EL devices and yellow organic EL devices.

In the above-described embodiments and the like, the active matrix display units 1 and 2 are described. However, the disclosure is applicable to a passive matrix display unit. Moreover, the configuration of a pixel drive circuit for active matrix drive is not limited to that described in the above-described embodiments, and, if necessary, a capacitor or a transistor may be further included in the pixel drive circuit. In this case, a necessary drive circuit may be included in addition to the above-described signal line drive circuit 120 and the above-described scanning line drive circuit 130 according to a modification of the pixel drive circuit.

In the above-described embodiments and the like, the case where the display units 1 and 2 are of a top emission type or a bottom emission type is described; however, the disclosure is applicable to the display units 1 and 2 of a type in which light is extracted from both top and bottom surfaces thereof.

In the above-described embodiments, the blanket is cleaned before and after a plate printing process in a process of manufacturing the display unit; however, it is not necessary to clean the blanket both before and after the plating printing process. For example, a process of cleaning the blanket 21 before the printing process may not be performed, and in the case where different blankets 21 are used in continuous printing, the cleaning process after printing may not be performed.

It is to be noted that the present application may have the following confirmations.

(1) An offset printing blanket cleaning liquid including: a solvent having a dipole moment of about 1.7 or more but less than about 4.1 and having a π covalent bond in a molecular skeleton thereof
(2) The offset printing blanket cleaning liquid according to (1), in which the solvent includes one or more kinds selected from a group consisting of 1,2-dimethoxybenzene, 1,3-dimethoxybenzene, acetophenone, cyclohexanone, 2-pentanone, 3-pentanone, 4-pentanone, N-methyl-2-pyrrolidone, and 1,3-dimethyl-2-imidazolidinone.

(3) The offset printing blanket cleaning liquid according to (1) or (2), in which the content of the solvent is within a range of about 50% to about 100% both inclusive.

(4) A method of cleaning an offset printing blanket including: immersing a blanket in a cleaning liquid including a solvent, the solvent having a dipole moment of about 1.7 or more but less than about 4.1 and having a π covalent bond in a molecular skeleton thereof.

(5) The method of cleaning an offset printing blanket according to (4), in which the blanket is immersed in the cleaning liquid while supplying the cleaning liquid.

(6) The method of cleaning an offset printing blanket according to (4) or (5), in which the blanket is formed of silicone rubber.

(7) A method of manufacturing a display unit including: forming a display device on a substrate,

in which the forming of the display device includes:

immersing a blanket in a cleaning liquid including a solvent, the solvent having a dipole moment of about 1.7 or more but less than about 4.1 and having a π covalent bond in a molecular skeleton thereof,

coating the blanket with an ink composition including an organic material to form a transfer layer,

pressing a plate with a predetermined pattern against the transfer layer to form a pattern layer on the blanket, and

transferring the pattern layer to a printing substrate.

(8) The method of manufacturing a display unit according to (7), in which the blanket is immersed in the cleaning liquid before forming the transfer layer.

(9) The method of manufacturing a display unit according to (7) or (8), in which the blanket is immersed in the cleaning liquid after the pattern layer is transferred to the printing substrate.

(10) A method of manufacturing a printed material including: forming a pattern layer on a substrate,

in which the forming of the pattern layer includes:

immersing a blanket in a cleaning liquid including a solvent, the solvent having a dipole moment of about 1.7 or more but less than about 4.1 and having a π covalent bond in a molecular skeleton thereof,

coating the blanket with an ink composition including an organic material to form a transfer layer,

pressing a plate with a predetermined pattern against the transfer layer to form a pattern layer on the blanket, and

transferring the pattern layer to a printing substrate.

(11) An ink composition including:

an organic material; and

a solvent having a dipole moment of about 1.3 to about 3.0 both inclusive and having a π covalent bond in a molecular skeleton thereof.

(12) The ink composition according to (11), in which the content of the solvent is about 50% or more.

(13) The ink composition according to (11) or (12), in which a polymer or an oligomer with a molecular weight of about 5000 or more is included as the organic material.

(14) The ink composition according to any one of (11) to (13), in which the weight of the organic material in a solution including the organic material and a solvent is within a range of about 80% to about 99.5% both inclusive.

(15) The ink composition according to (11) to (14), in which the solvent includes one or more kinds selected from a group consisting of anisole, phenetole, diphenylether, 1,2-dimethoxybenzene, 1,3-dimethoxybenzene, acetophenone, cyclohexanone, 2-pentanone, 3-pentanone, and 4-pentanone.

(16) The ink composition according to (11) to (15), in which the solvent includes one or more kinds selected from a group consisting of 1,2-dimethoxybenzene, 1,3-dimethoxybenzene, acetophenone, cyclohexanone, 2-pentanone, 3-pentanone, and 4-pentanone.

(17) A printing method including:

coating a blanket with an ink composition including an organic material and a solvent to form a transfer layer, the solvent having a dipole moment of about 1.3 to about 3.0 both inclusive and having a π covalent bond in a molecular skeleton thereof;

pressing a plate with a predetermined pattern against the transfer layer to form a pattern layer on the blanket, and

transferring the pattern layer to a printing substrate.

(18) The printing method according to (17), in which a weight increase rate of the solvent in a polymer forming the blanket when the blanket is immersed in the solvent for one minute is within a range of about 1% to about 6% both inclusive.

(19) The printing method according to (17) or (18), in which the blanket is formed of silicone rubber.

(20) A method of manufacturing a display unit including: forming a display device on a substrate,

in which the forming of the display device includes:

coating a blanket with an ink composition including an organic material and a solvent to form a transfer layer, the solvent having a dipole moment of about 1.3 to about 3.0 both inclusive and having a π covalent bond in a molecular skeleton thereof,

pressing a plate with a predetermined pattern against the transfer layer to form a pattern layer on the blanket, and

transferring the pattern layer to a printing substrate.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An offset printing blanket cleaning liquid comprising: a solvent having a dipole moment of about 1.7 or more but less than about 4.1 and having a π covalent bond in a molecular skeleton thereof.

2. The offset printing blanket cleaning liquid according to claim 1, wherein the solvent includes one or more kinds selected from a group consisting of 1,2-dimethoxybenzene, 1,3-dimethoxybenzene, acetophenone, cyclohexanone, 2-pentanone, 3-pentanone, 4-pentanone, N-methyl-2-pyrrolidone, and 1,3-dimethyl-2-imidazolidinone.

3. The offset printing blanket cleaning liquid according to claim 1, wherein the content of the solvent is within a range of about 50% to about 100% both inclusive.

4. A method of cleaning an offset printing blanket comprising: immersing a blanket in a cleaning liquid including a solvent, the solvent having a dipole moment of about 1.7 or more but less than about 4.1 and having a π covalent bond in a molecular skeleton thereof.

5. The method of cleaning an offset printing blanket according to claim 4, wherein the blanket is immersed in the cleaning liquid while supplying the cleaning liquid.

6. The method of cleaning an offset printing blanket according to claim 4, wherein the blanket is formed of silicone rubber.

7. A method of manufacturing a display unit comprising: forming a display device on a substrate,
wherein the forming of the display device includes:
immersing a blanket in a cleaning liquid including a solvent, the solvent having a dipole moment of about 1.7 or more but less than about 4.1 and having a π covalent bond in a molecular skeleton thereof,
coating the blanket with an ink composition including an organic material to form a transfer layer,
pressing a plate with a predetermined pattern against the transfer layer to form a pattern layer on the blanket, and
transferring the pattern layer to a printing substrate.

8. The method of manufacturing a display unit according to claim 7, wherein the blanket is immersed in the cleaning liquid before forming the transfer layer.

9. The method of manufacturing a display unit according to claim 7, wherein the blanket is immersed in the cleaning liquid after the pattern layer is transferred to the printing substrate.

10. A method of manufacturing a printed material comprising: forming a pattern layer on a substrate,
wherein the forming of the pattern layer includes:
immersing a blanket in a cleaning liquid including a solvent, the solvent having a dipole moment of about 1.7 or more but less than about 4.1 and having a π covalent bond in a molecular skeleton thereof,
coating the blanket with an ink composition including an organic material to form a transfer layer,
pressing a plate with a predetermined pattern against the transfer layer to form a pattern layer on the blanket, and
transferring the pattern layer to a printing substrate.

11. An ink composition comprising:
an organic material; and
a solvent having a dipole moment of about 1.3 to about 3.0 both inclusive and having a π covalent bond in a molecular skeleton thereof.

12. The ink composition according to claim 11, wherein the content of the solvent is about 50% or more.

13. The ink composition according to claim 11, wherein a polymer or an oligomer with a molecular weight of about 5000 or more is included as the organic material.

14. The ink composition according to claim 11, wherein the weight of the organic material in a solution including the organic material and the solvent is within a range of about 80% to about 99.5% both inclusive.

15. The ink composition according to claim 11, wherein the solvent includes one or more kinds selected from a group consisting of anisole, phenetole, diphenylether, 1,2-dimethoxybenzene, 1,3-dimethoxybenzene, acetophenone, cyclohexanone, 2-pentanone, 3-pentanone, and 4-pentanone.

16. The ink composition according to claim 11, wherein the solvent includes one or more kinds selected from a group consisting of 1,2-dimethoxybenzene, 1,3-dimethoxybenzene, acetophenone, cyclohexanone, 2-pentanone, 3-pentanone, and 4-pentanone.

17. A printing method comprising:
coating a blanket with an ink composition including an organic material and a solvent to form a transfer layer, the solvent having a dipole moment of about 1.3 to about 3.0 both inclusive and having a π covalent bond in a molecular skeleton thereof;
pressing a plate with a predetermined pattern against the transfer layer to form a pattern layer on the blanket, and
transferring the pattern layer to a printing substrate.

18. The printing method according to claim 17, wherein a weight increase rate of the solvent in a polymer forming the blanket when the blanket is immersed in the solvent for one minute is within a range of about 1% to about 6% both inclusive.

19. The printing method according to claim 17, wherein the blanket is formed of silicone rubber.

20. A method of manufacturing a display unit comprising: forming a display device on a substrate,
wherein the forming of the display device includes:
coating a blanket with an ink composition including an organic material and a solvent to form a transfer layer, the solvent having a dipole moment of about 1.3 to about 3.0 both inclusive and having a π covalent bond in a molecular skeleton thereof,
pressing a plate with a predetermined pattern against the transfer layer to form a pattern layer on the blanket, and
transferring the pattern layer to a printing substrate.
